(19) United States
(12) Patent Application Publication
(10) Pub. No.: US 2016/0140632 A1
(43) Pub. Date: May 19, 2016

(54) METHODS AND SYSTEMS SUPPORTING CROWD-SOURCED PROXY SHOPPING VIA AN E-COMMERCE PLATFORM

(71) Applicant: Sears Brands, L.L.C., Hoffman Estates, IL (US)

(72) Inventors: Srini Kandala, New York, NY (US); Venkata Vijaya Bhargava Punnamaraju, Schaumburg, IL (US); Bhargav Teja Manikonda, Schaumburg, IL (US); Ramesh V. Perla, South Barrington, IL (US); Raju Sagiraju, Cupertino, CA (US); Sabeesh Chandran, Streamwood, IL (US)

(21) Appl. No.: 14/940,389

(22) Filed: Nov. 13, 2015

Related U.S. Application Data
(60) Provisional application No. 62/080,031, filed on Nov. 14, 2014.

(51) Int. Cl. G06Q 30/06

(52) U.S. Cl. CPC G06Q 30/0603; G06Q 30/0623; G06Q 30/0633

(57) ABSTRACT

Certain embodiments of the disclosure relate to methods and systems that enable a consumer to electronically shop products sold by a diverse assortment of retail merchants of a shopping mall selected by the consumer, without the need for the consumer to physically travel from merchant to merchant in the shopping mall to make the purchases, using the services of a crowd-sourced, proxy shopper.

### CROSS-REFERENCE TO RELATED APPLICATIONS/INCORPORATION BY REFERENCE

The present application makes reference to, claims benefit of, and claims priority to U.S. Provisional Patent Application No. 62/080,031, filed Nov. 14, 2014, which is hereby incorporated herein by reference, in its entirety.

### FIELD

Certain embodiments of the disclosure relate to on-line shopping via electronic commerce (e-commerce) platforms. More specifically, certain embodiments of the disclosure relate to methods and systems that enable a consumer to electronically shop products sold by a diverse assortment of retail merchants of a shopping mall selected by the consumer, without the need for the consumer to physically travel from merchant to merchant in the shopping mall to make the purchases, using the services of a crowd-sourced, proxy shopper.

### BACKGROUND

Shopping at what are referred to herein as “shopping malls,” groups of merchants that are located within a common building or shopping structure, requires that the consumers physically travel to the various stores in the “mall” to purchase the items they wish to buy. Parking at various times of the year can be difficult to find, and the consumer may be required to visit several stores to find the items that they desire. Shopping in this way can involve standing in long lines at checkout counters or return/exchange counters, and crowds can make shopping difficult. The popularity of traditional shopping at “brick-and-mortar” shopping malls is rapidly being replaced by other means of purchasing products, including the use of the Internet.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method supporting crowd-sourced proxy shopping via an e-commerce platform, substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is an illustration of an exemplary computer network in which an example embodiment of the present disclosure may be practiced.

FIG. 2 is a flow diagram for an exemplary returns process, in accordance with an example embodiment of the present disclosure.

FIG. 3 is a flow diagram for an exemplary cancellations process, in accordance with an example embodiment of the present disclosure.

FIG. 4 is a flow diagram for an exemplary rejected returns process, in accordance with an example embodiment of the present disclosure.

FIG. 5 is an illustration of an exemplary local shopping mall order flow, in accordance with an example embodiment of the present disclosure.

FIG. 6 is an illustration of an exemplary local shopping mall order return flow, in accordance with an example embodiment of the present disclosure.

FIGS. 7A-7C illustrate exemplary login screens that may be displayed by a mobile consumer application on a consumer device, in accordance with an example embodiment of the present disclosure.

FIG. 8 illustrates an exemplary search screen for locating a shopping mall, which may be displayed by a mobile consumer application on a consumer device, in accordance with the present disclosure.

FIG. 9 is an illustration showing the home screen of a local shopping mall, which may be displayed by a mobile consumer application following selection of a particular shopping mall location by a consumer, in accordance with an example embodiment of the present disclosure.

FIG. 10 is an illustration of an example screen showing a list of stores in the local shopping mall selected by the consumer, in accordance with an example embodiment of the present disclosure.

FIG. 11 is an illustration of an example mobile device screen showing a picture of the store front and store hours of a shopping mall merchant selected by the consumer, in accordance with an example embodiment of the present disclosure.

FIG. 12 is an illustration of an example mobile device screen showing products offered by the shopping mall merchant selected by the consumer after selecting a “products” control, in accordance with an example embodiment of the disclosure.

FIG. 13 is an illustration of an example screen showing global search functionality where consumers can search for a product and see all products relevant to the search, aggregated by stores, in accordance with an example embodiment of the present disclosure.

FIGS. 14-15 illustrate exemplary mobile device screens showing a product description page that displays product details and available variations (e.g., size and color) from which the consumer can choose, in accordance with an example embodiment of the present disclosure.

FIG. 16 is an illustration of an example mobile device screen showing various example fulfillment options for each product, “Relay Station” pickup, locker location pickup, and home delivery, in accordance with an example embodiment of the present disclosure.

FIGS. 17-19 illustrate example mobile device screens that allow consumers to create interactive lists and add multiple products to each list, which enables consumers to plan local shopping mall trips efficiently, in accordance with an example embodiment of the present disclosure.

FIG. 20 is an illustration of an example mobile device screen showing that consumers can choose to pick up their products from a “Relay Station,” in accordance with a example embodiment of the present disclosure.

FIGS. 21-22 illustrate example mobile device screens that permit the consumer to select from various delivery locations already saved in their profile, and can choose the preferred time for home delivery, in accordance with an example embodiment of the present disclosure.

FIGS. 23-25 illustrate example mobile device screens that enable a consumer to access their order history, to differentiate between orders that are currently open, fulfilled, and for returns/exchanges orders, and that for open orders, consumers can track the runner handling their order, in accordance with an example embodiment of the present disclosure.

FIGS. 26-28 illustrate example mobile device screens that enable the consumer to track the “Runner” for open orders, that enable the “Runner” to send a notification to the consumer along with the details of a substitute product, to enable the consumer to choose to approve or decline the substitute product, or to call the “Runner” to discuss the options, in accordance with an example embodiment of the present disclosure.

FIGS. 29-31 illustrate example mobile device screens that enable the consumer to initiate returns/exchanges by accessing their Order History, and to view order details, product return policies, and to make returns and exchanges easily, in accordance with an example embodiment of the present disclosure.

FIGS. 32-34 illustrate example mobile device screens that enable the consumer to initiate returns by tapping on the product and then tapping on ‘Return’, and through which the consumer may provide the reason for the returns, in accordance with an example embodiment of the present disclosure.

FIGS. 35-37 illustrate example mobile device screens that enable consumers to enter the quantity of items being returned, and to cancel returns before dropping off the product at the “Relay Station,” or before a “Runner” is dispatched to pick up the product from the consumer's home, in accordance with an example embodiment of the present disclosure.

FIGS. 38-40 illustrate example mobile device screens that enable consumer to initiate exchanges by tapping an ‘Exchange’ button, and to choose a variation (e.g., different size or color) of the same product or exchange it for a different product, in accordance with an example embodiment of the present disclosure.

FIGS. 41-43 illustrate example mobile device screens that enable consumer to choose to exchange a product for a different product, including any product from any of the stores in the selected shopping mall, in accordance with an example embodiment of the present disclosure.

FIGS. 44-46 illustrate example mobile device screens showing further details of product exchange that enable the consumer to continue to exchange more items, or select ‘Done’ to go on to the fulfillment options, in accordance with an example embodiment of the present disclosure.

FIGS. 47-49 illustrate example mobile device screens relating to product exchange or return, showing that once the products to be returned/exchanged are selected, the consumer may tap on “Process Returns/Exchanges” to complete the process, and may choose from different fulfillment options including, for example, home pickup or “Relay Station” drop off, in accordance with an example embodiment of the present disclosure.

FIGS. 50-51 illustrate example mobile device screens that enable a consumer to select the pickup location and schedule the pickup for a preferred time, and that the consumer will receive an email confirmation once the “Runner” is on their way to pick up the product, in accordance with an example embodiment of the present disclosure.

FIG. 52 is an illustration that explains how an example embodiment of the present disclosure makes returns and exchanges easy for the consumer by bringing the fitting room to the consumer's door step.

FIG. 53 is an illustration that explains how an example embodiment of the present disclosure makes returns and exchanges frictionless, thus improving consumer experience and mall store performance.

FIG. 54 is an illustration that explains how an example embodiment of the present disclosure makes the return and exchange process convenient, and brings more customers to the shopping mall.

FIGS. 55-57 illustrate example mobile device screens that support a simple self-service sign up process for anyone to easily register as “Relay Runners” or “Runners,” in accordance with an example embodiment of the present disclosure.

FIGS. 58-59 illustrate example mobile device screens that enable a “Relay Runner” to act a proxy shopper from any of the available malls by selecting a desired shopping mall from a home screen, and to provide the “Relay Runner” with a listing of open orders sorted by the time left for fulfilling the orders, in accordance with an example embodiment of the present disclosure.

FIGS. 60-62 illustrate example mobile device screens that enable the “Relay Runner” to see a detailed description of all ordered items with store and route details, to view all products and stores in each accepted order, and to view the products on a map of the shopping mall, in accordance with an example embodiment of the present disclosure.

FIGS. 63-64 illustrate example mobile device screens that enable a “Relay Runner”, following selection of a product, to view the product details along with any special instructions, to call the consumer for more details, and to mark the item as “Picked up,” following checkout from store, upon which the product is move to the bottom of the list, in accordance with an example embodiment of the present disclosure.

FIGS. 65-67 illustrate example mobile device screens that enable a “Relay Runner” to look for a substitute product for an ordered item that is not available, to notify the consumer, to take a picture of the substitute product, to enter the product name, price, and description of the substitute product, to send the product information to the consumer, and then to purchase the substitute product, once the member approves the substitution, in accordance with an example embodiment of the present disclosure.

FIGS. 68-70 illustrate example mobile device screens showing that “Return Orders” may be shown in a list of open orders, that a time for return of the product(s) may be shown based on store “slow” time, that the products for return may be grouped together by stores into an order, and that the return policy of each store in the order may be provided to the “Relay Runner,” in accordance with an example embodiment of the present disclosure.

FIGS. 71-72 illustrate example mobile device screens showing that a returned product may have description and reason for return, and that the returned product may also have a scanned image of receipt for that order, in accordance with an example embodiment of the present disclosure.

FIG. 73 illustrates an example login screen for a “Relay Anchor” software application that may be used by a “Relay Anchor” manager of a “Relay Station,” the person that manages order fulfillment details in real time and that is responsible for delivering the order to the consumer, in accordance with an example embodiment of the present disclosure.

FIG. 74 illustrates an example display screen showing a detailed listing of open orders that are available to a “Relay Anchor” for assignment to any available “Relay Runners,” in accordance with an example embodiment of the present disclosure.

FIG. 75 illustrates an example display screen showing an individual order page listing all the product items in the order and their status, which the “Relay Anchor” can update, or speak with the consumer or “Relay Runner” at any time, in accordance with an example embodiment of the present disclosure.

FIG. 76 illustrates an example display screen showing that the “Relay Anchor” software application enables the “Relay Anchor” to contact a consumer through, for example, a phone call, a text, or an email when appropriate, in accordance with an example embodiment of the present disclosure.

FIG. 77 illustrates an example display screen showing that the “Relay Anchor” software application enables the “Relay Anchor” to upload all the receipts for an order, in which each order may have multiple receipts, in accordance with an example embodiment of the present disclosure.

FIG. 78 illustrates an example display screen showing that once all of the products in an order have been delivered to the “Relay Station,” the “Relay Anchor” may then send a pickup/delivery email to the consumer that placed the order, in accordance with an example embodiment of the present disclosure.

FIG. 79 illustrates an example display screen showing how a “Relay Anchor” can initiate returns after receiving the product from the consumer, in accordance with an example embodiment of the present disclosure.

FIG. 80 illustrates an example display screen showing how a “Relay Anchor” may reject a product return for various reasons including, for example, damaged product and missing parts/accessories, in accordance with an example embodiment of the present disclosure.

FIGS. 81-93 illustrate example mobile device screens for a “Relay Runner” software application, in accordance with an example embodiment of the present disclosure.

FIGS. 94-97 illustrate example mobile device screens for a consumer software application for the mobile device, which enables the consumer to track the “Relay Runner” that is procuring the products items in their order, in accordance with an example embodiment of the present disclosure.

FIG. 98 is an illustration of an example “Relay Station,” in accordance with an example embodiment of the present disclosure.

FIGS. 99-101 illustrate example mobile device screens of a consumer software application that enables consumers to view the store fronts of a shopping mall on a home screen carousel using, for example, a “swipe” gesture across the pictures of the carousel to view the store fronts of other stores in the shopping mall, and which enables the consumer to visit the store by selecting its store front, in accordance with an example embodiment of the present disclosure.

FIGS. 102-103 illustrate example mobile device screens of a consumer software application in which selecting the store from the carousel of FIGS. 99-101 maximizes the store front image and scales it to full screen when the consumer device is positioned for a “landscape view,” in accordance with an example embodiment of the present disclosure.

FIG. 104 is an illustration of an example mobile device screen showing how consumers may take pictures of their purchase and upload the pictures in association with the respective store for others to view, in accordance with an example embodiment of the present disclosure.

FIGS. 105A-105H are flowchart of an exemplary method of operating a system such as, for example, the computer network 100 of FIG. 1, to support crowd-sourced proxy shopping by consumers, in accordance with an example embodiment of the present disclosure.

FIGS. 106-110 illustrate example mobile device screens showing the use of “smart lists,” in accordance with an example embodiment of the present disclosure.

FIG. 111 is a block diagram illustrating a personal electronic device that may correspond to, for example, the electronic devices shown in FIG. 1, in accordance with an example embodiment of the present disclosure.

FIG. 112 is a flow diagram illustrating an example process in which a runner, seeking a product requested by a consumer, cannot locate the requested product and suggests a product substitution, in accordance with an example of the present disclosure.

FIG. 113 is a flow diagram illustrating an example process including the dynamic generation of a product entry for a product suggested by a runner as a substitute for a product requested by a consumer via a messaging (e.g., chat) session, in accordance with an example of the present disclosure.

FIG. 114 shows a flow diagram illustrating an example process including the dynamic generation of a product entry for a product suggested by a runner as a substitute for a product ordered by a user via a mobile application on the communication device of the user, in accordance with an example of the present disclosure.

FIG. 115 is an illustration of an example screen showing a list of merchant stores in the local shopping mall selected by the consumer as displayed by a mobile application on a user communication device, in accordance with an example embodiment of the present disclosure.

FIG. 116 is an illustration of an example screen showing a chat exchange between the user and a runner that has responded to a request for a chat session, in accordance with an example embodiment of the present disclosure.

FIG. 117 is an illustration of an example screen showing a chat exchange between a user and a runner as displayed by a mobile application on a user communication device, in which the runner has suggested a substitute product item for an item requested by the user, in accordance with an example embodiment of the present disclosure.

FIG. 118 is an illustration of an example screen showing a chat exchange between user and a runner as displayed by a mobile application on a runner communication device, in which the runner indicates that they have found a possible substitute product suggestion in a retail merchant, in accordance with an example embodiment of the present disclosure.

FIG. 119 is an illustration of an example screen showing a pop-up window as might be displayed by a mobile application of a runner communication device, in which the application provides options for adding a product that the runner found in a product catalog, or in a retail store, in accordance with an example embodiment of the present disclosure.

FIG. 120 is an illustration of an example screen showing the information that may be displayed by a mobile application on a communication device of a runner, for a product item for potential suggestion by the runner as a product requested by a user, in accordance with an example embodiment of the present disclosure.

### DETAILED DESCRIPTION

Certain embodiments of the disclosure relate to the operation of electronic commerce (e-commerce) platforms. More specifically, certain embodiments of the disclosure relate to methods and systems that enable a consumer to electronically shop products sold by a diverse assortment of retail merchants of a shopping mall selected by the consumer, without the need for the consumer to physically travel from merchant to merchant in the shopping mall to make the purchases, using the services of a crowd-sourced proxy shopper.

In an example embodiment according to the present disclosure, information about the products available from the retail merchants of a particular shopping mall is accessible to the consumer via a software application running on a mobile device of the consumer such as a cellphone; a smart phone; or a desktop, laptop, netbook, or handheld personal computer. Orders placed by the consumer for products sold by the various merchants of particular shopping mall of interest may be distributed to and purchased on behalf of the consumer by individuals that agree to act as “runners.” In one example embodiment of the present disclosure, each of the runners, upon agreeing to handle a particular portion or entire consumer order, physically visit the retail merchants that sell each of the items that they have agreed to procure, and then purchase the ordered items on behalf of the consumer. The items of the order, once collected for the consumer by the runner are then brought to a central location within or near the particular shopping mall, and the items of the order are assembled for delivery to the consumer, at a location chosen by the consumer via express or regular carrier, or at a pickup location designated by the consumer such as the central location in the shopping mall, or at pickup facility nearby.

An example embodiment of the present disclosure provides an innovative way for consumers to shop for products at shopping malls at or near a user-specified location, using a mobile device of the consumer. A system according to the present disclosure integrates aspects of mobile e-commerce, crowd sourcing, geo-fencing, targeted member notifications, peer-to-peer communication, real-time order tracking, and social media networks in a mobile/web application that provides a seamless and friction free consumer experience. Some example embodiments of the present disclosure permit the consumer to choose delivery of their order that includes a personable human interaction. The consumer may also request that a personal shopper make product choices/substitutions for the consumer, when requested or appropriate.

A system in accordance with the present disclosure provide consumer with an opportunity to discover all of the stores of a specific shopping mall, to browse through various product categories or search for products they are looking for, and to select different stores carrying that product and complete their purchase using their own smart phones, tablets, or personal computers without leaving their home/office. Consumers are able to track their order in real-time and choose to pick up their order at a designated location, which may be referred to herein as a “relay station,” or receive their order via delivery to their home.

An example embodiment of the present disclosure may use an optimized crowd-sourced runner model that supports the dispatch of consumer orders, real-time runner status, and peer-to-peer communication between runner(s) and consumer(s). A centralized location or “relay station” may be used that supports the management of runners, consumers, and orders from a single location, and handles item consolidation for final order dispatch to the consumer or delivery carrier. A manager or “relay anchor” handles the consolidation of the product items of an order and arranges for the delivery to the consumer that placed the order.

An example embodiment of the present invention provides the ability for a consumer to plan a visit to the shopping mall of interest by providing the consumer with the functionality to view electronic “mall fronts” that display mall hours, mall location, mall phone number, amenities, interactive maps, a list of stores at the selected shopping mall, and currently available deals, news, and events, to better allow the consumer to plan the visit to the shopping. Smart lists permit consumers to add product items to a shopping list, and find appropriate stores for each product item on the list, for a quick review.

In an example embodiment according to the present disclosure, each store within a shopping mall is provided with a dedicated “store front” that provides additional details about the store, such as, for example, the phone number and address, and a store identifier (ID). An example embodiment of the present invention enable the consumer to purchase and utilize merchant core capabilities such as, for example, in-vehicle pickup of orders, and merchant or shopping mall services that permit the consumer to, for example, quickly pick up products purchased or drop off products for return. An example embodiment of the present invention also enables consumers to arrange have the selected product items delivered to a specified address the day of purchase, and following successful completion of a transaction, the consumer may be provided with an order confirmation email containing the details of the order along with instructions for returns and refunds. An example embodiment of the present disclosure provides a one-stop shopping experience for customers of the shopping mall, and provides two of the most important commodities to consumers, saving of time and convenience in shopping activities. Consumer have at their disposal, a single-stop shopping experience for all of the stores with in a shopping mall, with the ability to access information about store level inventory, store and shopping mall promotions and deals, and a catalog of product items that are available to the consumer via same day delivery and next day delivery options.

The terms “user,” “end-user,” “customer,” and “consumer”, “member” may be used herein to refer to a potential or existing purchaser of products and/or services of a business or merchant.

The term “e-commerce”, “m-commerce” may be used herein to refer to business or commerce that is transacted electronically, as over the Internet. The term “social e-commerce” may be used herein to refer to e-commerce in which consumers interact with other consumers socially as part of e-commerce activities. Merchants or businesses may take part in social e-commerce by engaging consumers in various activities including, by way of example and not limitation, email messaging, text messaging, games, and posting or monitoring of activities and information exchanged on social networking platforms (e.g., Facebook®) and/or merchant supported social networks.

The term “social network” may be used herein to refer to a network of family, friends, colleagues, and other personal contacts, or to an online community of such individuals who use a website or other technologies to communicate with each other, share information, resources, etc. The term “social graph” may be used herein to refer to a representation of the personal relationships or connections between individuals in a population. The term “social signal” may be used herein to refer to an expression by a user of a relationship with or feeling about a person, product, or thing. In the context of the present disclosure, the terms “social signal” and “social signal information” refer to a relationship with or feeling about a product.

The terms “like,” “want,” “have” or “own,” and “recommend” may be used to refer to particular social signals that may be represented on a web page in association with a product, and may be selected by a consumer to represent their relationship with or feeling about the product.

The terms “merchant” and “sponsoring merchant/merchants.” may be used herein to refer to the owner and/or operator of a business enterprise that either operates an e-commerce promotions platform system as described herein, or enters into an agreement with another to operate or provide services of such an e-commerce promotions platform on their behalf.

The term “loyalty program” may be used herein to refer to a structured marketing effort that rewards, and therefore encourages, loyal buying behavior that is potentially beneficial to the business or firm operating or sponsoring the loyalty program. The term “member” may be used herein to refer to those consumers that have provided personal information to an operator or sponsor of a loyalty program in order to gain access to benefits provided by the loyalty program.

The term “crowdsourcing” may be may be used herein to refer to the practice of obtaining needed services, ideas, or content (e.g., information) by soliciting contributions from a large number of sources. The terms “crowd-source” and “crowd-source population” may be used herein to refer to a large number of sources from which contributions of services, ideas, or content may be solicited.

The term “follow” may be used herein to refer to a user request to be kept informed about a particular person, place, or thing.

The term “share” may be used herein to refer to a user request to communicate information about what is being viewed by a user to members of the user's family, friends, or social network.

As utilized herein, the terms “exemplary” or “example” means serving as a non-limiting example, instance, or illustration. As utilized herein, the term “e.g.” introduces a list of one or more non-limiting examples, instances, or illustrations.

Some example embodiments of the present disclosure may have an integrated social media functionality that allows consumers to communicate product, service, manufacturing, sales, and other information with others, and to search for products of interest, poll friends, family, and others, recommend products and receive product recommendations, and plan for and participate in events in their lives and the lives of others.

Additional functionalities and screenshots associated with the particular aspects of an administration tool that are related to automated, targeted polling of potential respondents as part of promotional activities are disclosed herein in reference to the accompanying Figures.

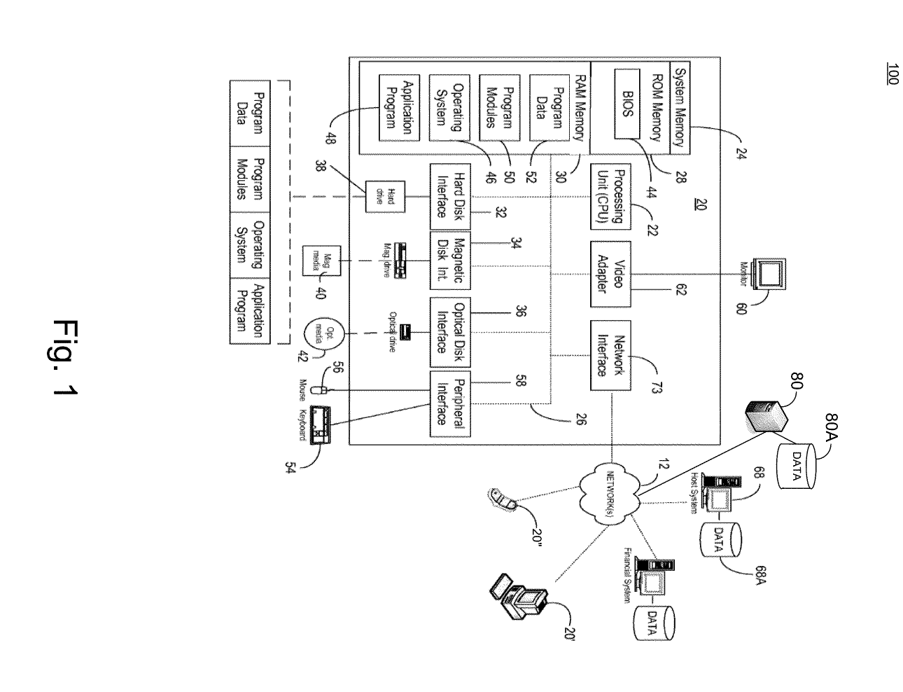

FIG. 1 is an illustration of an exemplary computer network 100 in which an example embodiment of the present disclosure may be practiced. The following discloses various example systems and methods for, by way of example and not limitation, operating an e-commerce promotions platform for administering e-commerce promotions, such as sweepstakes, contests, giveaways, and/or instant wins, including functionality to perform automatic, targeted polling of users.

Referring now to FIG. 1, a processing device 20″, illustrated in the exemplary form of a mobile communication device, a processing device 20′, illustrated in the exemplary form of a computer system, and a processing device 20 illustrated in schematic form, are shown. Each of these devices 20, 20′, 20″ are provided with executable instructions to, for example, provide a means for a customer, e.g., a user, a customer or consumer, etc., or a sales associate, a customer service agent, and/or others to access a host system 68 and, among other things, be connected to a system supporting proxy purchases for consumer, an inventory management system, a content management system, an electronic publication system, a hosted social networking site, a user profile, a store directory, and/or a sales associate. Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“FDA”), cellular telephone, tablet, e-reader, smart phone, or the like. Furthermore, while described and illustrated in the context of a single processing device 20, 20′, 20″, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer-executable instructions comprising an operating system 46, one or more applications programs 48 (such as a Web browser), other program modules 50, and/or program data 52. Still further, computer-executable instructions may be downloaded to one or more of the computing devices as needed, for example via a network connection. Such computer-executable instructions may also support the submission of product orders and communication with and the management of individuals acting as consumer proxies to fulfill orders from the various merchants in a shopping mall, using various elements of the computer network 100 such as, for example, the processing devices 20, 20′, 20,″ shown in FIG. 1.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices are typically connected to the processing unit 22 by means of an interface 58 which, in turn, is coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system 68 having associated data repository 68A. In this regard, while the host system 68 has been illustrated in the exemplary form of a computer, the host system 68 may, like processing device 20, be any type of device having processing capabilities. Again, the host system 68 need not be implemented as a single device but may be implemented in a manner such that the tasks performed by the host system 68 are distributed amongst a plurality of processing devices/databases located at different geographical locations and linked through a communication network. Additionally, the host system 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, media content providers, document storage systems, etc.

For performing tasks as needed, the host system 68 may include many or all of the elements described above relative to the processing devices 20, 20′, 20.″ In addition, the host system 68 would generally include executable instructions for, among other things, accepting and processing orders of product items for a consumer, and distribution of those product orders to a group of individuals acting as proxies for the consumers placing the orders; identifying and recommending product items, coordinating storage and retrieval of documents; maintaining social network storage of a shopping list; receiving a location of a customer or other individuals via a mobile device; and maintaining maps and layouts of buildings and geographic areas. The host system 68 may include executable instructions for calculating directions or routes within buildings and geographic areas; searching, retrieving, and analyzing web-based content; managing operating rules and communication with user devices used by participants, for receiving a request for a service call center connection from either a customer or a sales associate. The host system 68 may also include executable instructions to perform routing of a received request via a distributed mobile video call center; providing a service call infrastructure for providing the requestor with a distributed customer service experience, and for an e-commerce promotions platform for administering e-commerce promotions, such as sweepstakes, contests, giveaways, and/or instant wins.

Communications between the processing devices 20, 20′, 20″ and the host system 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory computer-readable memory storage device(s) of the host system 68 and processing devices 20, 20′ and 20″.

In addition to the above, the exemplary computer network 100 of FIG. 1 may include, or be configured to interface with a number of different systems providing information or services that enable the operation of an example embodiment of the present disclosure. For example, the elements of the computer network 100 may interface with one or more systems that provide a “store level data feed.” That is, a computer such as, for example, the host system 68 of computer network 100 may support, or may interface with a system that provides access to store-level catalogs for merchants of the shopping malls for which crowd-sourced proxy shopping is to be made available. Such store-level catalogs may include inventory and availability, product images, pricing, and other product or merchant information content. Such information may be provided by a third party service provider such as, for example, Retailigence, located at 2400 Broadway, Suite 220, Redwood City, Calif. 94063, using an application programming interface (API) is integrated with the application software running on the elements of the computer network 100 of FIG. 1.

An example embodiment of the present disclosure may interface with systems of the merchants of the shopping malls being served. For example, elements of a computer network such as the computer network 100 (e.g., host system 68) may interface with systems of the merchants, to allow access to product catalogs, inventory information, the ability to reserve products for runner pickup, receive transaction information, and provide payment for products purchased for the consumer. For example, a consumer may view product items from a catalog provided by a system of the present disclosure, and may added the item to their shopping cart. A system of the present disclosure may reserve the item, and may map the product item against a dummy item in via a portal of the merchant from which the product item is being ordered. The system of the present disclosure may process checkout and may complete the purchase transaction, and may then send an email order confirmation email to consumer. A system such as the computer network 100 of FIG. 1 may also interface with delivery services, to provide delivery of the purchased products to the consumer. A system of the present disclosure may transmit order details to computer systems of delivery services and carriers to arrange for or reserve delivery capacity, and to receive confirmation of delivery of the consumer order.

A system in accordance with the present disclosure may comprise functionality embodied in three innovative software applications for use on mobile electronic communication devices such as, by way of example and not limitation, smart phones, handheld electronic tablets, or handheld personal computers (PCs), which may be referred to herein as “mobile applications,” or “mobile apps.” The three mobile software applications will be referred to herein by the terms “Relay” app, “Relay Runner” app, and “Relay Station” app. In accordance with an example embodiment of the present disclosure, these apps may run on a service-oriented architecture with client-server model sourcing and tracking real time inventory, order management, order fulfillment, and customer service aspects.

In accordance with the present disclosure, a consumer may use the “Relay” app on their mobile device to identify (e.g., browse or search) shopping malls in the vicinity of a particular location such as, for example, a given Zip code. The consumer may be presented with a list of the shopping malls that fall within search criteria provided by the consumer. When the consumer selects a specific “shopping mall” from the list of “shopping malls,” they may be taken to an image of a “store front” of the selected shopping mall, which may provide the shopping mall hours of operation, information about amenities, location maps, and a list of all the stores associated with that shopping mall. It should be noted that while the listed “shopping malls” may, in fact, be traditional shopping malls, they may also be a collection of stores previously chosen and named as a “shopping mall” by the consumer, where the identified stores may be in the vicinity of a location selected by the consumer.

An example embodiment according to the present disclosure enables the consumer to select a specific store in the shopping mall, to browse the specific store menu (catalog), and to search for a specific product item across all of the stores in the selected shopping mall. In accordance with the present disclosure, the consumer may add any product item(s) available from any store in the selected shopping mall to their “shopping cart” or “order,” choose to either ‘Pick Up’ their order, or choose to have their order delivered, and complete the purchase transaction. On successful completion of the purchase transaction, the consumer receives an Order Confirmation email that provides the details of the order along with instructions on how to return or exchange the product items in their order. The “Relay” app enables the consumer to track the fulfillment of the order in real time using a ‘Follow or Track the runner’ option, and can plan the pick up or delivery of the order, accordingly.

An example embodiment of the present disclosure uses crowd-sourced proxy shopper or crowd-sourced “Runners” to purchase the product items ordered by the consumer from the stores of the merchants in the shopping mall. The “Runners” may be pre-verified and vetted individuals who meet certain security, reliability, and quality standards. The “Runners,” when available to help fill orders at the shopping mall, “login” to the system of the present disclosure, using the “Relay Runner” app, and ‘check in’ to indicate to the system, their availability to fulfill consumer orders.

In an example embodiment according to the present disclosure, when a consumer places an order using the “Relay” app on their mobile device, the submitted order is dispatched by the system of the present disclosure to a crowd-sourced “Runner” nearest the shopping mall selected by the consumer that placed the order. To participate as a “Runner,” an individual may agree to certain conditions, including a “service level agreement” specifying the speed with which the “Runner” will complete the shopping tasks assigned to him/her (e.g., a 5 minute SLA). When a ‘Runner’ accepts the order, the consumer that placed the order is notified so that the consumer may ‘follow the runner’ to get real-time order completion details. The “Runner” handles the purchase of product items of the order, and delivers the purchased product items at a specified drop-off location or “Relay Station,” for consolidation and later pickup by, or delivery to, the consumer. The “Runner” may communicate directly with the consumer that placed an order they are currently handling using, for example, a “chat” functionality of the “Runner” app, if any special attention is needed from the consumer.

The “Runner” app supports an integrated “chat” application having text and photo communication capabilities between the “Runner” and the consumer, for an optimal customer experience. If products requested by the consumer that placed an order are found to be unavailable, the “Runner” may locate an alternate source of the requested product or an alternate product, and may capture and send to the system, for example, a photo, price, and description for communication to the consumer for their validation or approval. The “Runner” scans and uploads the receipt for the product items purchased for an order directly from the “Runner” app, once the purchase of the product items or a suitable substitute is completed. The receipts uploaded by each “Runner” are stored by the system of the present disclosure, for later retrieval and future reference, to manage product refunds, exchanges, and order cancellations.

In an example embodiment in accordance with the present disclosure, product items for orders are consolidated at a designated shopping mall consolidation area, and a manager referred to herein as a “Mall Anchor” (a.k.a., “Relay Anchor”) reviews, picks, packs, and triggers a “Ready for pick up” or “Delivery on the way” message (e.g., via email, the Relay app, or other suitable means) to alert the consumer. Information about the consumer order including, by way of example and not limitation, product item details, status of each product item, the “Runner” that is handling the purchase of each product item of an order, and whether the product item has been dropped off at the consolidation location, are all available to the “Mall Anchor.” The “Mall Anchor” also has the ability to directly communicate with the “Runner” and the consumer, to aid in managing the orders using, for example, the Runner app or Relay app, respectively. In a representation embodiment of the present disclosure, the “Mall Anchor” may have the administrative authority to validate and trigger any cancellations, returns, or refunds for the consumer.

In an example embodiment of the present disclosure, the consolidation area may also be the area where the consumer drops off a product item to be returned. Once a product item is marked as cancelled or returned, a refund request may be triggered along with the proof of return or cancellation to the consumer.

In an example embodiment according to the present invention, the “Relay Anchor” (e.g., “Mall Anchor”) may be the key integrator that supports various functions and manages the “Relay Station.” The “Relay Anchor” uses the “Relay Station” app to manage the orders, consumer and “Runner” communication, and “Relay Station” pickup functions for consumers. In an embodiment of the present disclosure, the “Relay Anchor” consolidates product items for a specific order, scans and uploads receipts, picks and packs product items of an order for pickup or delivery, and keeps the order ready once a “Runner” drops off purchase items for an order. The “Relay Anchor” also manages returns for consumers at the “Relay Station.” The software applications described above (e.g., Relay app, Runner app, and Relay Station app) may communicate via a computer network such as, for example, a suitably configured computer system in the computer network 100 of FIG. 1. Such a computer system may be specifically configured to communicate with the Relay app running on the device of the consumer, the Runner app running on the device of the runner, and the Relay Station app running on the device of the Mall Anchor, as well as have the ability to access the information that identifies the stores in the shopping malls available for consumer selection, as well as the information identifying each of the products available at each of the stores of each shopping mall.

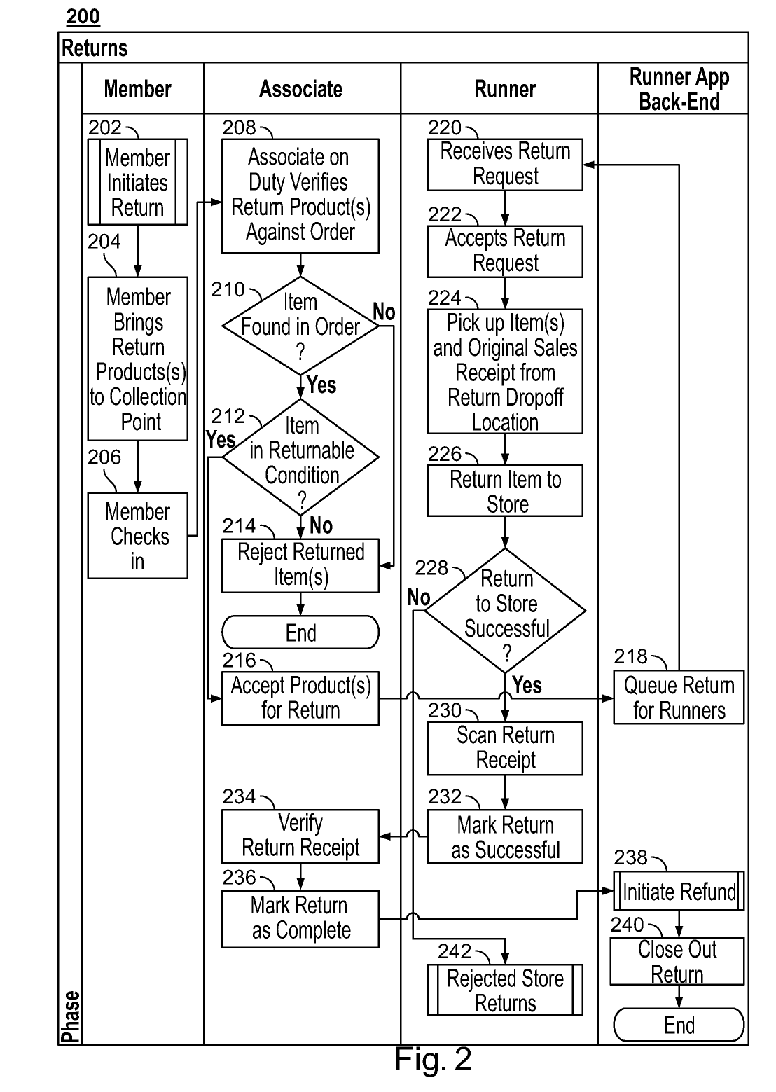

FIG. 2 is a flow diagram 200 for an exemplary returns process, in accordance with an example embodiment the present disclosure. The actions identified in the flowchart 200 of FIG. 2 may be performed by an appropriately configured computer system, such as the Relay platform 80 of FIG. 1. The flowchart of FIG. 2 begins at block 202, where a consumer initiates a request to return one or more products. The products may, for example, have been previously purchase using the system of the present disclosure, or may have been purchased by the consumer at “brick-and-mortar location of the merchant(s), on line, or via other means. The consumer may initiate the return using, for example, the Relay app described herein. Next, at block 204, the consumer may bring the products to be returned to a collection point such as, for example, the location of the Relay Anchor (e.g., Relay Station). In some example embodiments, the consumer may request that the products to be returned be retrieved from the home or office of the consumer by a runner. The consumer then, at block 206, “checks-in” or establishes their identity with the system via the Relay app or the Mall Anchor at the collection point. The “Relay Anchor” then, at block 208, verifies the product(s) being returned against those previously purchased by the consumer, checking that each returned product is found in an order of the consumer (block 210), and if present in the order, verifying that the returned product item is in returnable condition (block 212). If product item(s) are not in returnable condition, or are not found in an order purchased by the consumer, the product item(s) are rejected (block 214). The return process of FIG. 2 then ends with respect to those rejected product items. If, however, products items presented for return are found on an order for the consumer (block 210), and are in condition for return (block 212), the products are accepted for return (block 216), and the items are scheduled (e.g., queued) for return to their respective stores by one or more runners (block 218).

When returned product item(s) have been accepted and scheduled (e.g., queued) for return, the system then communicates a return request to the Runner app of currently available runners, which is then received by the runners (block 220). One or more runners of those currently available then accept the return request (block 222), and pick up, from the collection point, the product item(s) to be returned along with any corresponding sales receipt(s) for the returned products (block 224). The runner(s) then return the product item(s) to the respective stores (block 226) to complete the return. If the return of the product(s) was successful (block 228), the runner uses the Runner app on their device to scan the return receipt (block 230), to mark the return as successful (block 232). That information is then communicated to the Relay Station app on the device of the Mall Anchor, who then verifies the received return receipt (block 234), marks the return of the returned product item(s) as complete (block 236). The system then initiates a refund to the consumer (block 232) and closes out the return as completed (block 240). The example return process of FIG. 2 for the product returns for the current return request is then finished.

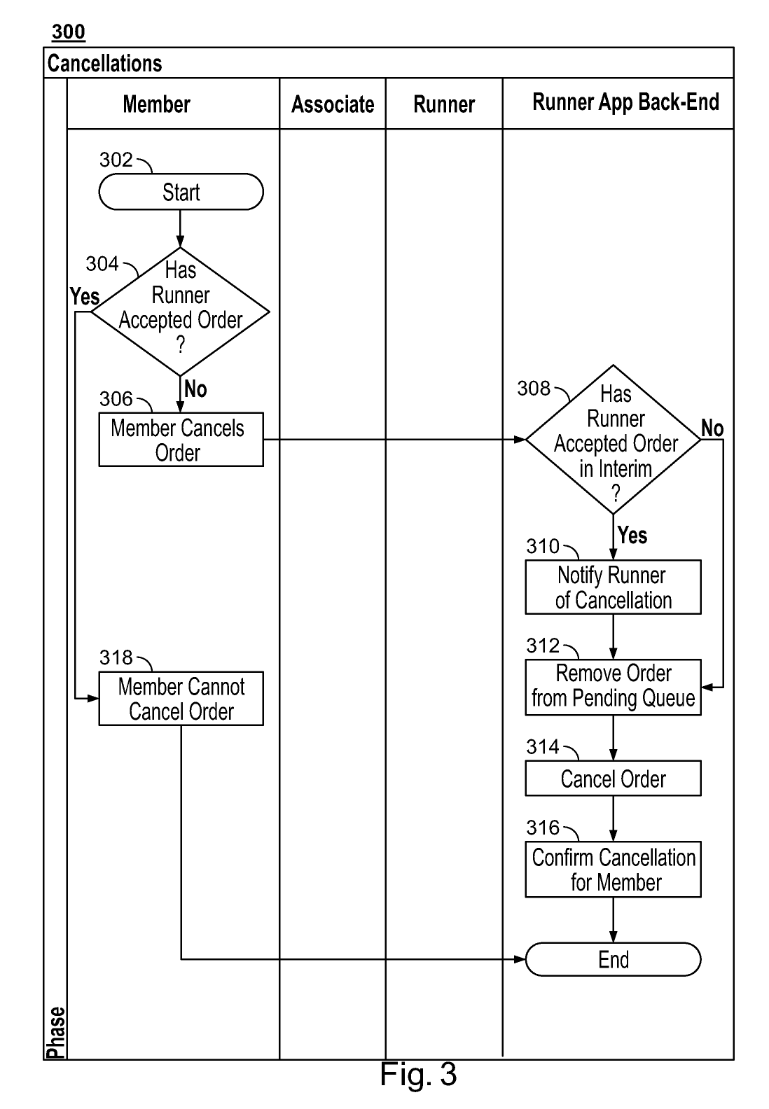

FIG. 3 is a flow diagram 300 for an exemplary cancellations process, in accordance with an example embodiment of the present disclosure. The actions identified in the flowchart 300 of FIG. 3 may be performed by an appropriately configured computer system, such as the Relay platform 80 of FIG. 1. The flowchart of FIG. 3 begins at block 302, where a consumer has initiated a request to cancel a previously placed order for one or more products. Initially, a check is made to determine whether a runner has already accepted the order placed by the consumer (block 304). This may be done by the Relay platform 80 by checking whether any runners are associated with or linked in memory to the order that the consumer wishes to cancel. If it is determined that a runner has already accepted the order, the consumer order may be considered to be non-cancelable, the consumer may be notified that the order cannot be cancelled (block 318), and the processing of the consumer request to cancel the order is complete. If, however, it is determined that a runner has not yet accepted the order of the consumer, the consumer is permitted to cancel the order (block 306). A further check is then performed to determine whether a runner has accepted the order following the acceptance of the cancellation (block 308). If a runner has accepted the order following system acceptance of the request to cancel the order, the runner is notified by the system of the cancellation of the order they just accepted (block 310), and the order is removed from a queue containing pending orders (block 312). The order is then officially cancelled (block 314), and confirmation of the cancellation of the order is communicated to the consumer (block 316). The order cancellation process of FIG. 3 is now complete. If, however, a runner has not accepted an order following system acceptance of the consumer request to cancel the order (block 308), the order is then officially cancelled (block 314), and confirmation of the cancellation of the order is communicated to the consumer (block 316). The order cancellation process of FIG. 3 is now complete.

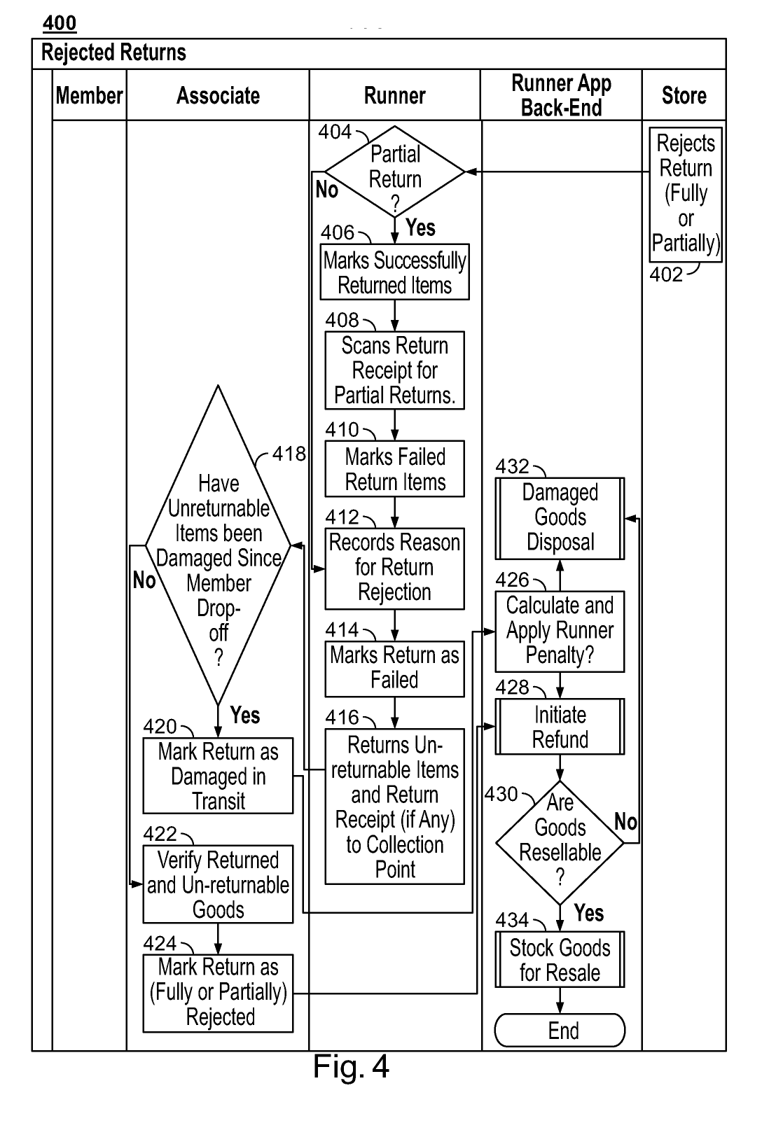

FIG. 4 is a flow diagram 400 for an exemplary rejected returns process, in accordance with an example embodiment of the present disclosure. The actions identified in the flowchart 400 of FIG. 4 may be performed by an appropriately configured computer system, such as the Relay platform 80 of FIG. 1. The flowchart of FIG. 4 begins at block 402, when a merchant rejects some or all of the products that a consumer has requested be returned. This may occur due to damage to the product item(s) to be returned, or because delay by the consumer is beyond the return period for the product item(s). Initially, the runner determines whether the merchant is rejecting the return of all product items in the request, or only rejecting a subset of the product items (block 404). If all of the product items are rejected for return (block 404), processing continues at block 412, discussed below. However, if only a part of the product items to be returned are rejected for return, the runner uses the Runner app to mark the product return request to indicate the product items that were successfully returned (block 406), and also uses the Runner app to scan the return receipt showing the product(s) successfully returned (block 408). In addition, the runner indicates (e.g., “marks”) using the Runner app, the items that were rejected as not returnable (block 410), and indicates the reason(s) why the rejected product(s) were not accepted for return (412). The runner then returns the unreturnable product items and the return receipt(s) to the collection point (e.g., Relay Station/Anchor Station), if any product items are unreturnable (block 416). The Relay Anchor then assesses whether the unreturnable items have been damaged since they were received from the consumer (block 418), and if so, marks the returned items as ‘damaged in transit’ (block 420). The system may then, depending on the degree of damage, calculate and apply a penalty to the runner responsible for the handling the return of the product item(s) (block 426). Damaged product item(s) may then either immediately be sent for damaged goods disposal (block 432) without a refund to the consumer, or the system may initiate a refund to the consumer (block 428), including notification of the consumer of the ending refund. If, however, the unreturnable product item(s) are in acceptable condition (block 418), the returned and unreturnable product item(s) are verified (block 422), and a record of the requested return is marked as fully or partially rejected, based on the above (block 424). A refund to the consumer for the returned item(s) is then initiated (block 428), and the consumer is notified of the pending refund. Following initiation of a refund to the consumer, a determination may be made whether the returned product item(s) are able to be resold (block 430), and those product that are able to be resold are stocked for resale (block 434), and the processing of the product items returned by the consumer ends. If the returned product item(s) are not able to be resold, the returned but unable to be resold product item(s) may be disposed of (block 432), and the processing of the returned products ends.

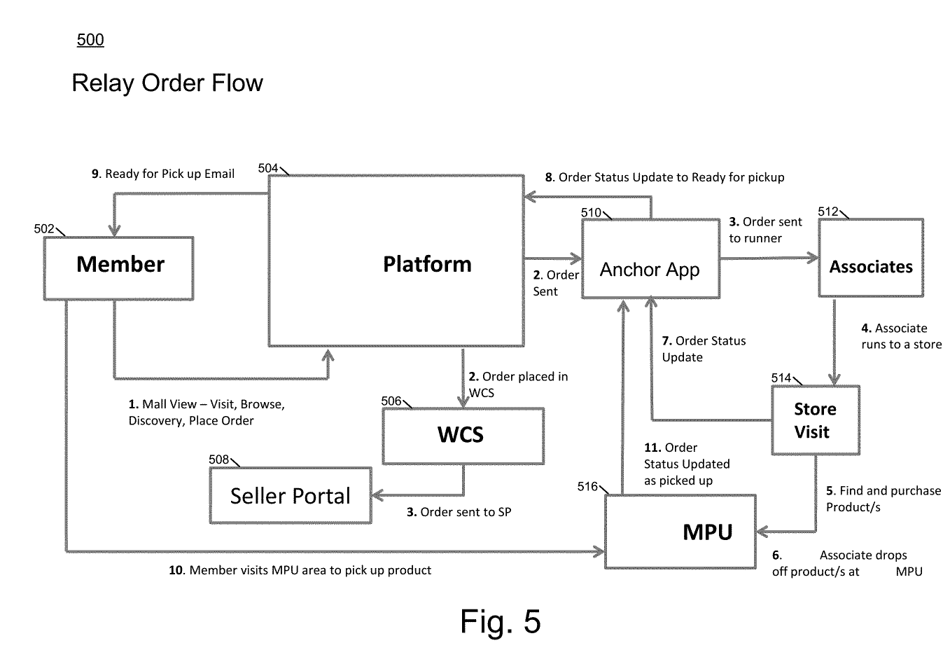

FIG. 5 is an illustration of a high-level view of a local shopping mall order flow 500, in accordance with an example embodiment of the present disclosure. As illustrated in FIG. 5, a member (e.g., user) 502 may use a communication device and a mobile application to visit an online mall view and visit one or more merchants accessible there, browse the products available from the merchant online stores, and place an order of product items from the various merchants. The order is then sent by the mobile application on the user communication device to the system platform 504. The system platform of FIG. 5 then sends the order to an e-commerce engine (WCS) 506, that may provide support for catalog, order management, returns, refund management, and payments processing, and to a mobile application of an individual acting as a “Relay Anchor” managing a collection point or “Relay Station” at which user orders may be assembled for delivery or pickup. Portions of the user order may be sent to the seller portal 508, for fulfillment by a particular seller of an ordered product, while portions of the user order may also be sent to a runner (e.g., an “Associate”) 512 that may accept responsibility for procuring the items of the user order from one or more merchants 514. The products of the user order purchased by the runner may then dropped off by the runner at a merchandise pick up (MPU) location 516, and the mobile application (e.g., “Anchor app”) of the “Relay Anchor” 510 is then updated on the status of the user order. The mobile application of the “Relay Anchor” 510 may then send an update of the order status to the platform 504 indicating that the user order is ready for pickup, and the platform 504 may then send a message (e.g., an email or text) to the member (e.g., user) 502 that their order is ready to be picked up. The member (e.g., user) may then visit the merchandise pickup location to pick up the products of their order. When the user picks up their order at the merchandise pickup location, the mobile application of the “Relay Anchor” 510 is updated to show that pickup of the user order is complete.

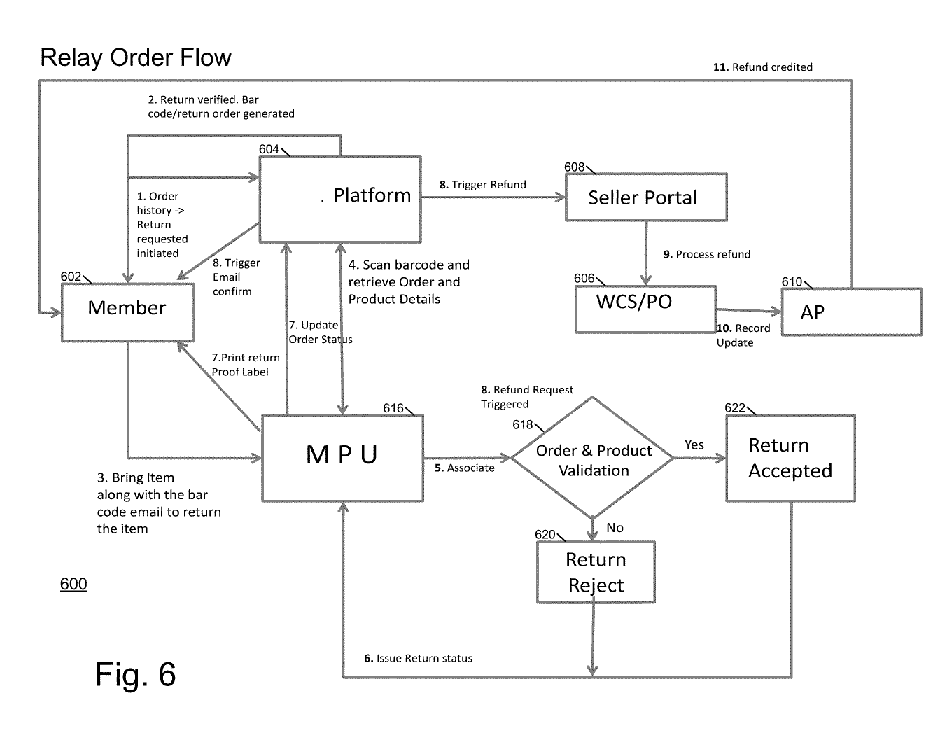

FIG. 6 is an illustration of an exemplary high-level view of a local shopping mall order return flow 600, in accordance with an example embodiment of the present disclosure. As illustrated in FIG. 6, a member (e.g., user) 602 may use a communication device and a mobile application to visit an online mall view and visit one or more merchants accessible there, in order to request a return of one or more items purchased from the various merchant(s). The request to return the product items is then sent by the mobile application on the user communication device to the system platform 604. At some later point in time, the member (e.g., user) brings the product items to be returned to a merchandise pick up (MPU) location 616, and the bar codes on the product items or labels are scanned and sent to the system platform 604 for use in retrieving user order and product details. The returned product items are reviewed by an individual (e.g., an Associate”) at the MPU 616. The acceptance 622 or rejection 620 status of the product items returned by the user is issued at the MPU location 616, and the status of the corresponding user order at the system platform 604 is updated to reflect the return status, and a proof of return label may be printed for the member at the point of return (e.g., the MPU). The system platform 604 of FIG. 6 then triggers the sending of a return confirmation message (e.g., an email or text) to the member (e.g., user), and sends a trigger for a refund for the return product items to a portal for the seller of the returned item(s) 608. The refund is then processed by, for example, an e-commerce engine that handles, among other things, the refunds for return goods, and the refund is then credited to the member (e.g., user). The processing of the refund for returned product item(s) is then complete.

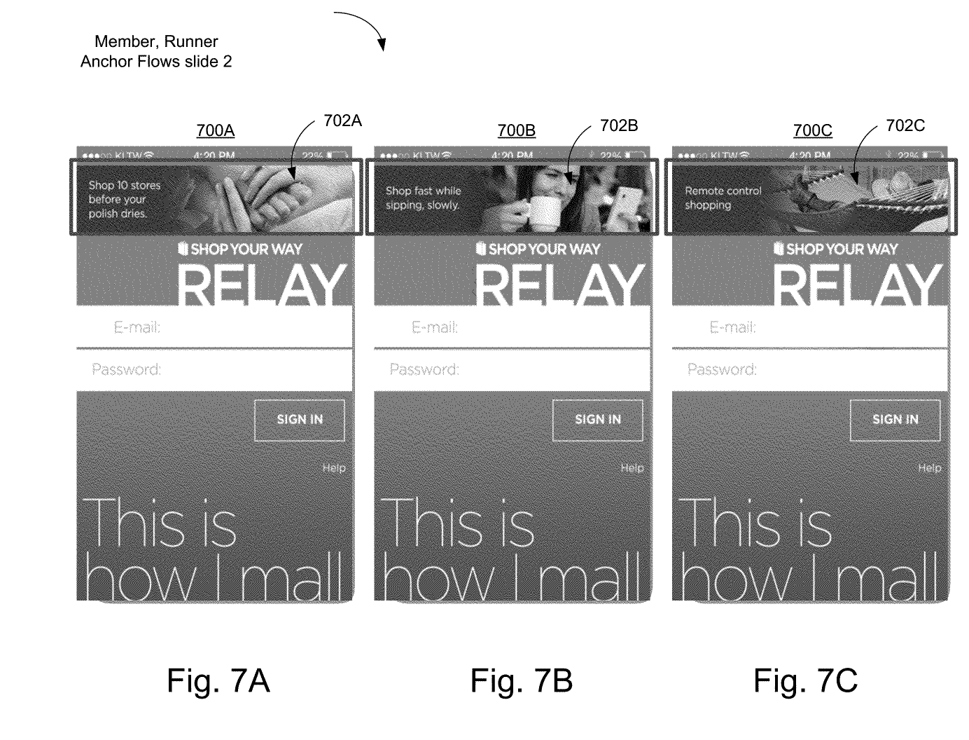

FIGS. 7A-7C illustrate respective exemplary login screens 700A, 700B, 700C that may be displayed by a mobile consumer application on a consumer device, in accordance with an example embodiment of the present disclosure. In the example illustrated in FIGS. 7A, 7B and 7C, the consumer user may login to the mobile application (e.g., Relay app) using an email address and a password, although other forms of user identification may be employed. Banners 702A, 702B, 702C are used to inform the consumer of benefits received by using the mobile application and proxy shopping service of the present example. The banners 702A, 702B, 702C may, for example, rotate through images related to a set of the benefits most liked by consumers, or those chosen by the merchant to most effectively advertise and best inform the consumer. Other information may also be displayed that may catch the eye of the consumer during login using the example login screens 700A, 700B, 700C of FIGS. 7A, 7B, 7C.

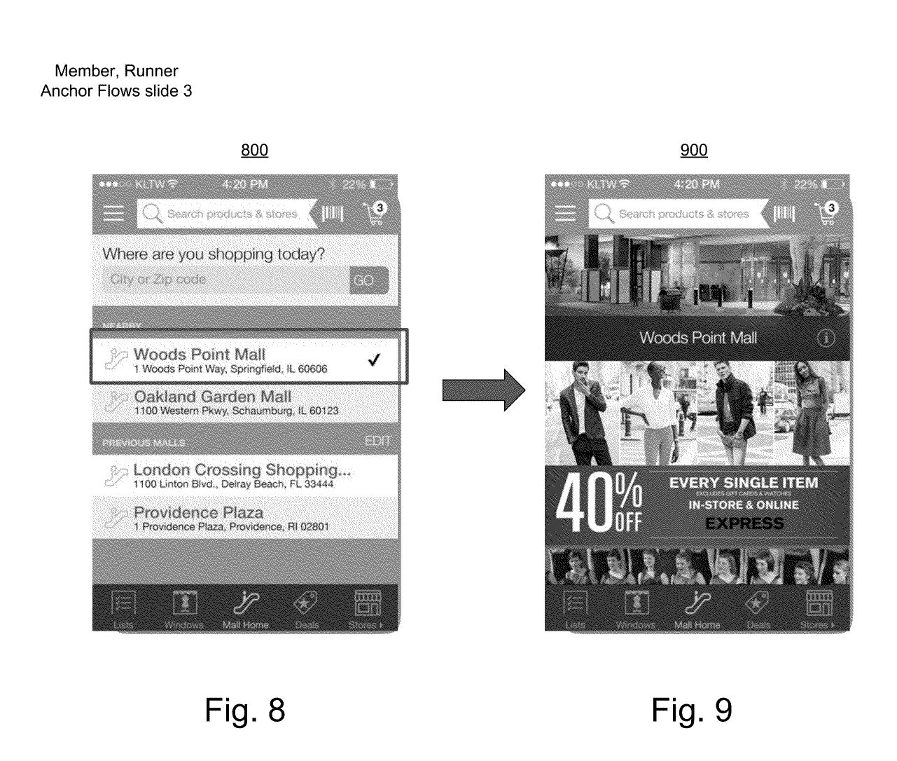

FIG. 8 illustrates an exemplary search screen 800 for locating a shopping mall, which may be displayed by a mobile consumer application on a consumer device, in accordance with the present disclosure. As shown in FIG. 8, a user may search for one or both of products and stores, and may localize the search by providing a city or ZIP code. The mobile application, which may correspond to the Relay app described herein, produce a list of nearby shopping malls or locations, as well as a list of shopping malls or location previously searched for or visited. The user may select an entry for one of the listed shopping malls or locations to be redirected or connected to information about the selected shopping mall, including photo images of one or both of the shopping mall and the store fronts for a number of the merchants at the selected shopping mall or location.

FIG. 9 is an illustration showing the home screen 900 of a local shopping mall, which may be displayed by a mobile consumer application following selection of a particular shopping mall location by a consumer, in accordance with an example embodiment of the present disclosure. The example illustration of FIG. 9 shows photo images and other information for the shopping mall or location selected by the user from the listing of FIG. 8, such as, for example, one or both of the shopping mall and the store fronts for a number of the merchants at the selected shopping mall or location.

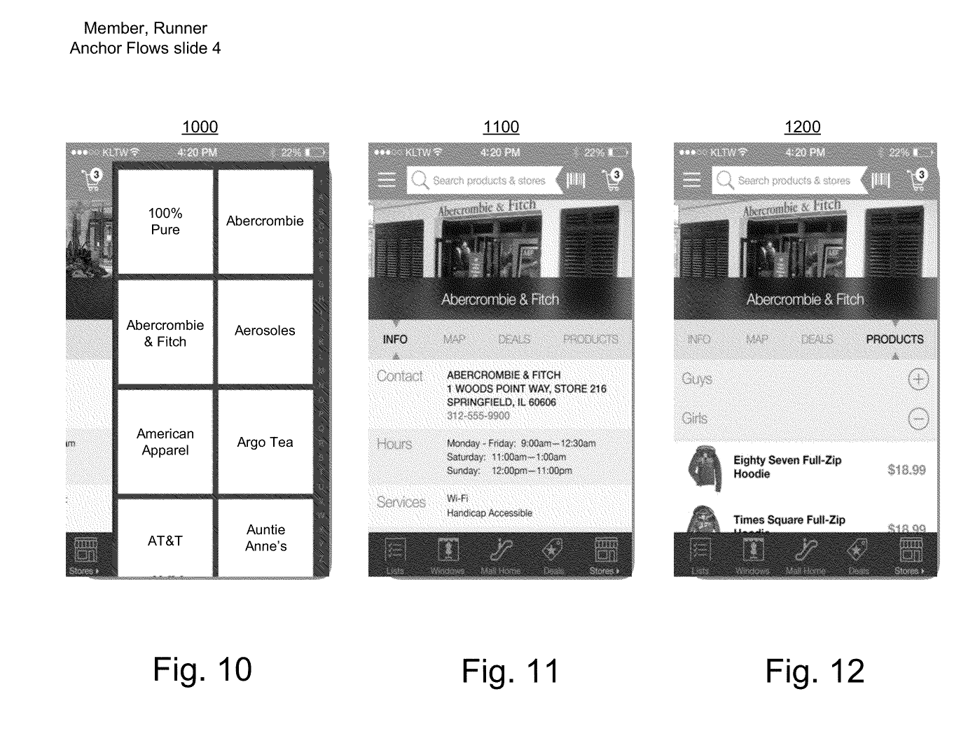

FIG. 10 is an illustration of an example screen 1000 showing a list of merchant stores in the local shopping mall selected by the consumer, in accordance with an example embodiment of the present disclosure. The example screen 1000 may be displayed on the screen of a user device by a mobile application such as, for example, the “Relay app” described herein. Although textual identifiers of the merchants are shown in the example of FIG. 10, graphics or photographic images may also be used to represent the merchants.

FIG. 11 is an illustration of an example mobile device screen 1100 showing a picture of the store front and store hours of a shopping mall merchant selected by the consumer from the listing of merchant stores shown in FIG. 10, in accordance with an example embodiment of the present disclosure. The example illustrated in FIG. 11 shows the contact information and location, hours of operation, and services available at the location selected by the user. Tab controls are provided to allow the user to select “INFO” such as the merchant information shown in FIG. 11, in addition to “MAP” information such as directions to and inside of the location of the selected merchant, current product promotional information and deals offered by the selected merchant, and information about products offered by the selected merchant.

FIG. 12 is an illustration of an example mobile device screen 1200 showing products offered by the shopping mall merchant selected by the consumer after selecting a “PRODUCTS” control, in accordance with an example embodiment of the disclosure. The user may search for specific products carried by the selected merchant, as well as add them to a shopping cart that may be used to shop across all of the merchant stores for the selected shopping mall or location.

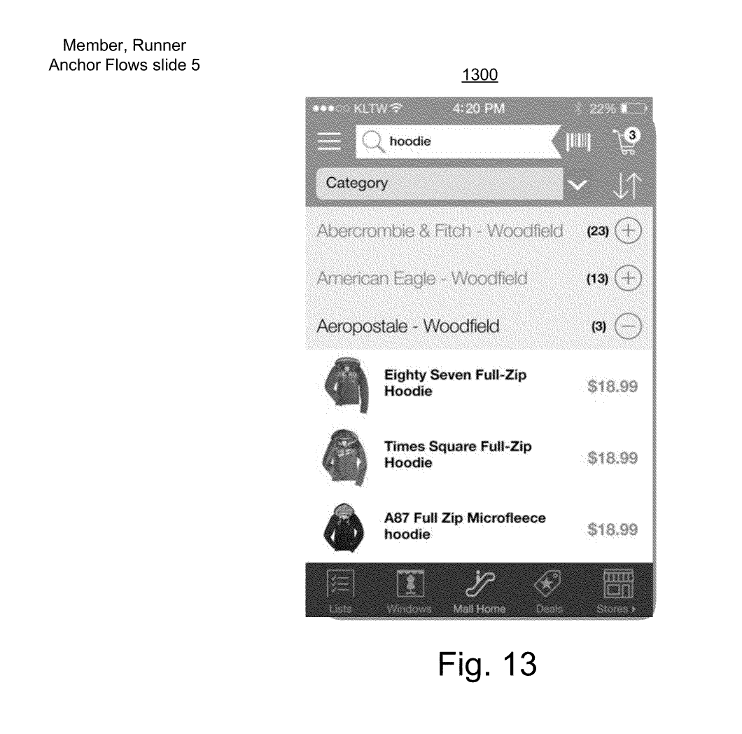

FIG. 13 is an illustration of an example screen 1300 showing global search functionality where consumers can search for a product and see all products relevant to the search, aggregated by stores, and identified by merchant, in accordance with an example embodiment of the present disclosure.

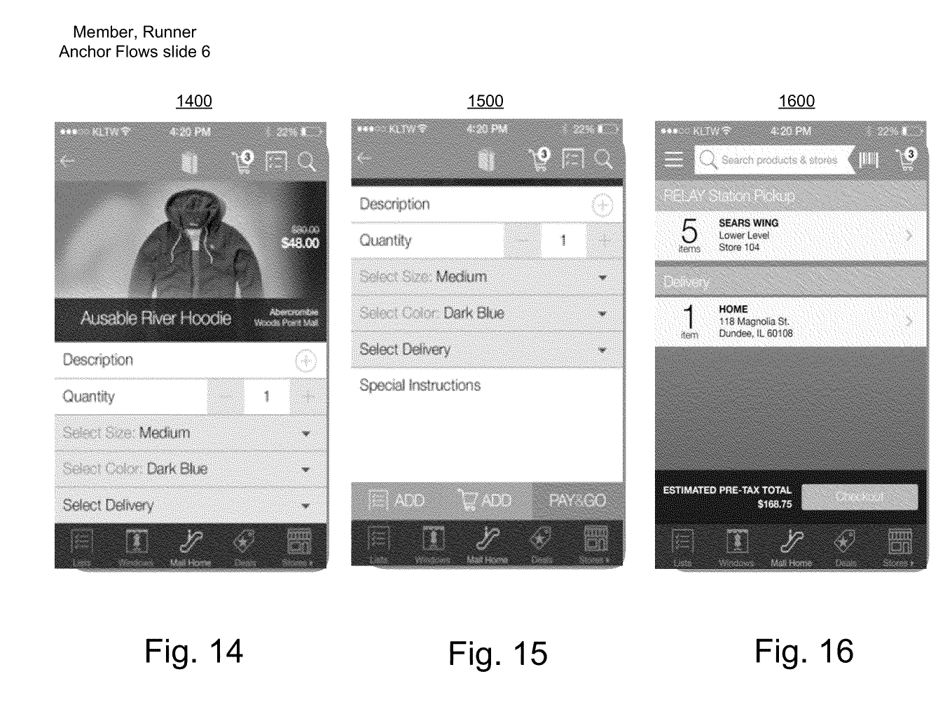

FIGS. 14-15 illustrate respective exemplary mobile device screens 1400, 1500 showing product description pages that display product details and available variations (e.g., size and color) from which the consumer can choose, in accordance with an example embodiment of the present disclosure.

FIG. 16 is an illustration of an example mobile device screen 1600 showing various example fulfillment options for a product, “Relay Station” pickup, locker location pickup, and delivery, in accordance with an example embodiment of the present disclosure.

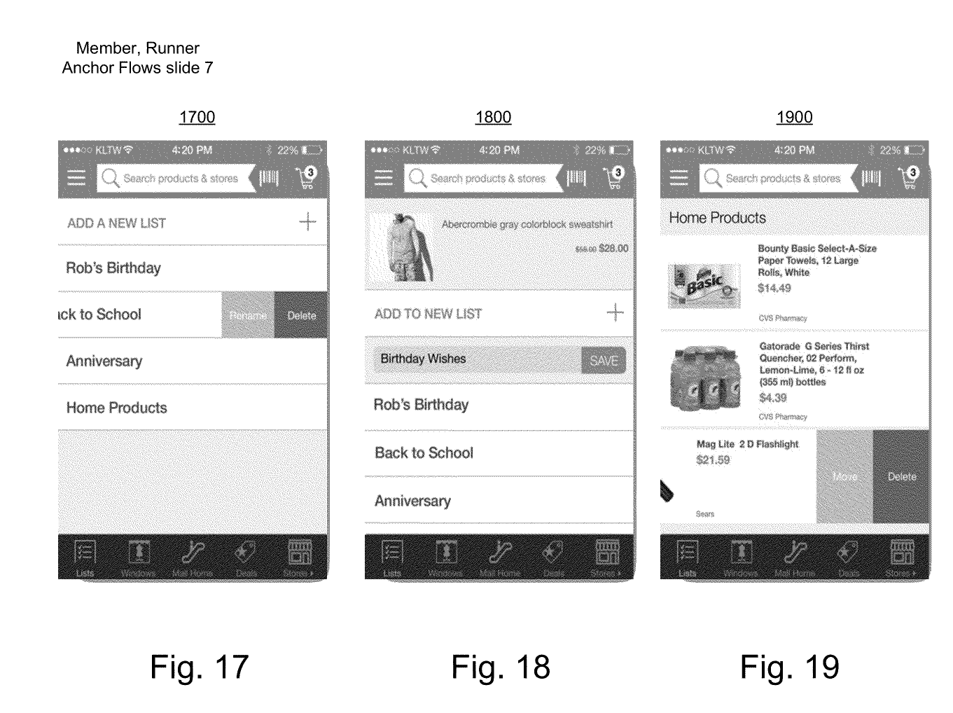

FIGS. 17-19 illustrate respective example mobile device screens 1700, 1800, 1900 that allow consumers to create various interactive lists and add multiple products to each list, to enable consumers to plan local shopping mall trips efficiently, in accordance with an example embodiment of the present disclosure.

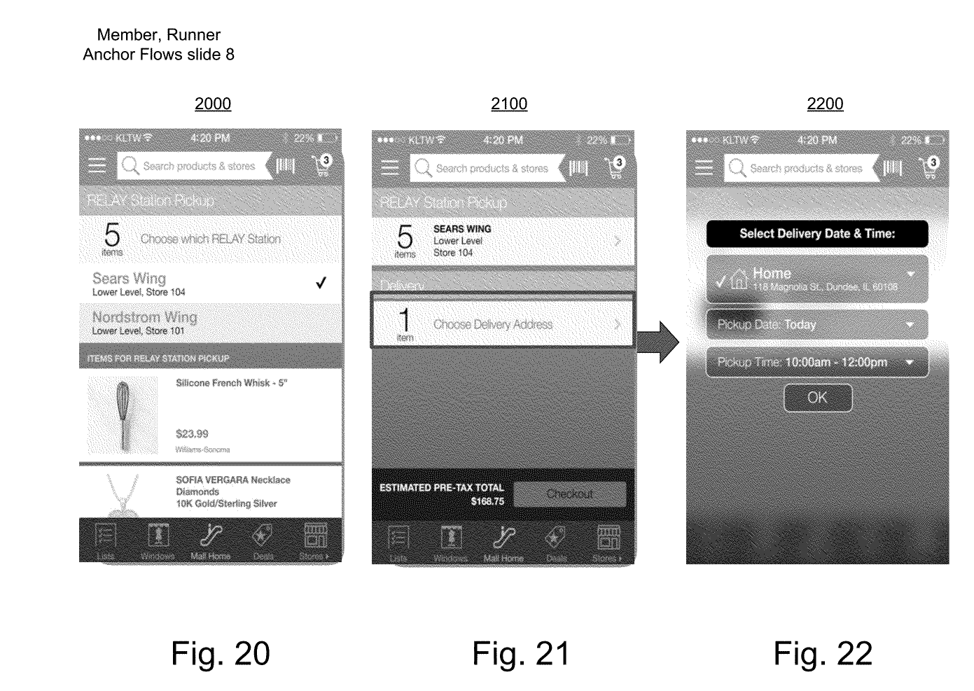

FIG. 20 is an illustration of an example mobile device screen 2000 showing that consumers can choose to pick up their products at various locations of a “Relay Station,” in accordance with an example embodiment of the present disclosure.

FIGS. 21-22 illustrate example mobile device screens 2100, 2200 that permit the consumer to select from various delivery locations already saved in their profile, and can choose the preferred time for home delivery, in accordance with an example embodiment of the present disclosure.

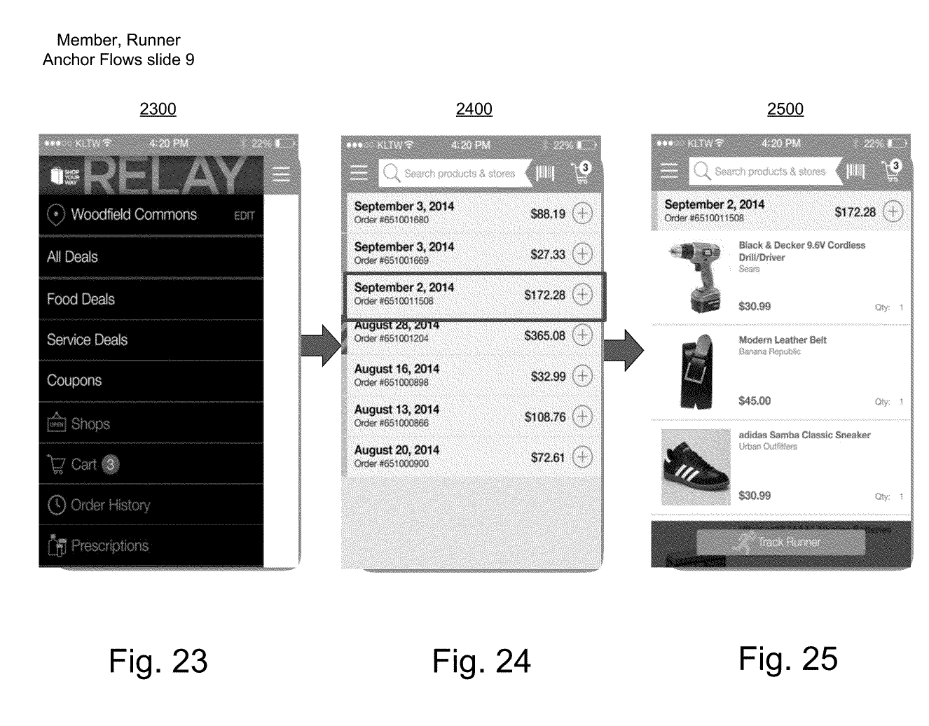

FIGS. 23-25 illustrate example mobile device screens 2300, 2400, 2500 that enable a consumer to access their order history, to differentiate between orders that are currently open, fulfilled, and for returns/exchanges orders, and that for open orders, consumers can track the runner handling their order, in accordance with an example embodiment of the present disclosure.

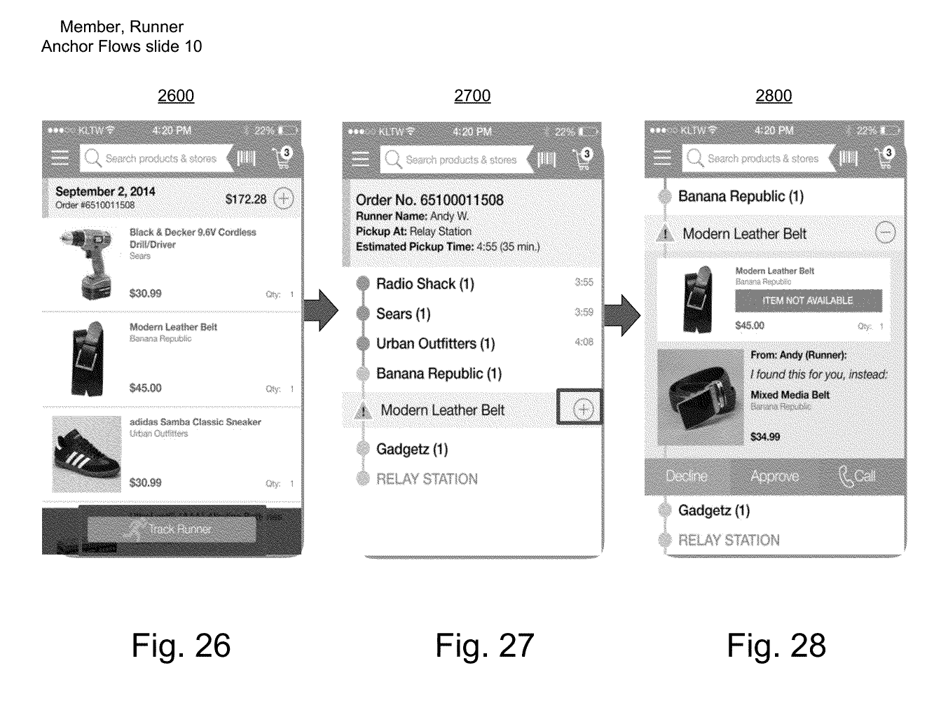

FIGS. 26-28 illustrate example mobile device screens 2600, 2700, 2800 that enable the consumer to track the “Runner” for open orders, that enable the “Runner” to send a notification to the consumer along with the details of a substitute product to enable the consumer to choose to approve or decline the substitute product, or to communicate with (e.g., call) the “Runner” to discuss the product options, in accordance with an example embodiment of the present disclosure.

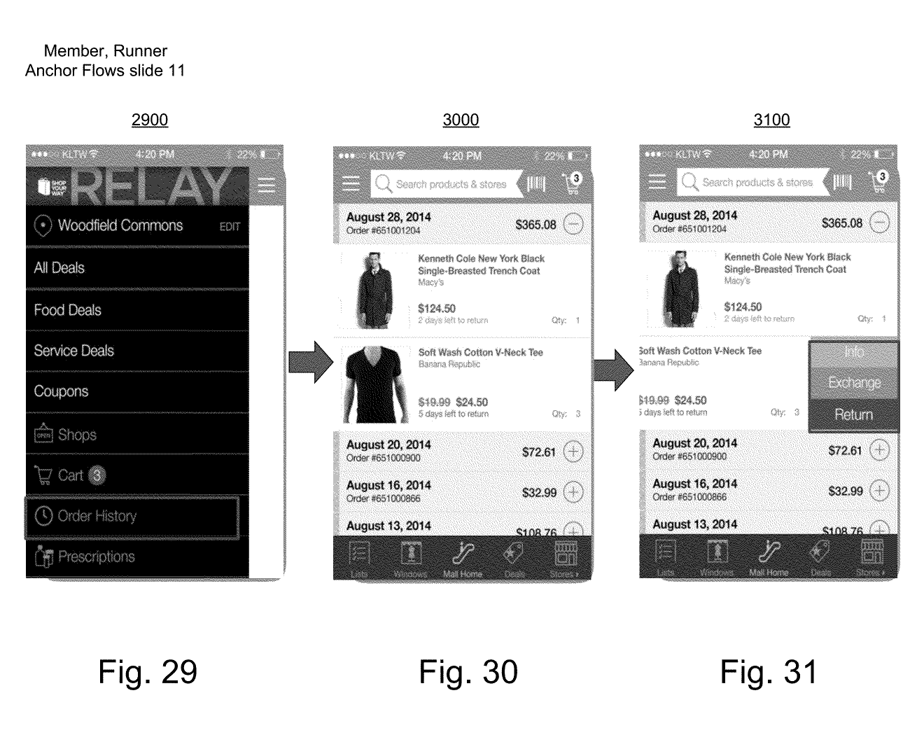

FIGS. 29-31 illustrate example mobile device screens 2900, 3000, 3100 that enable the consumer to initiate returns/exchanges by accessing their Order History, and to view order details, product return policies, and to request returns and exchanges easily, in accordance with an example embodiment of the present disclosure.

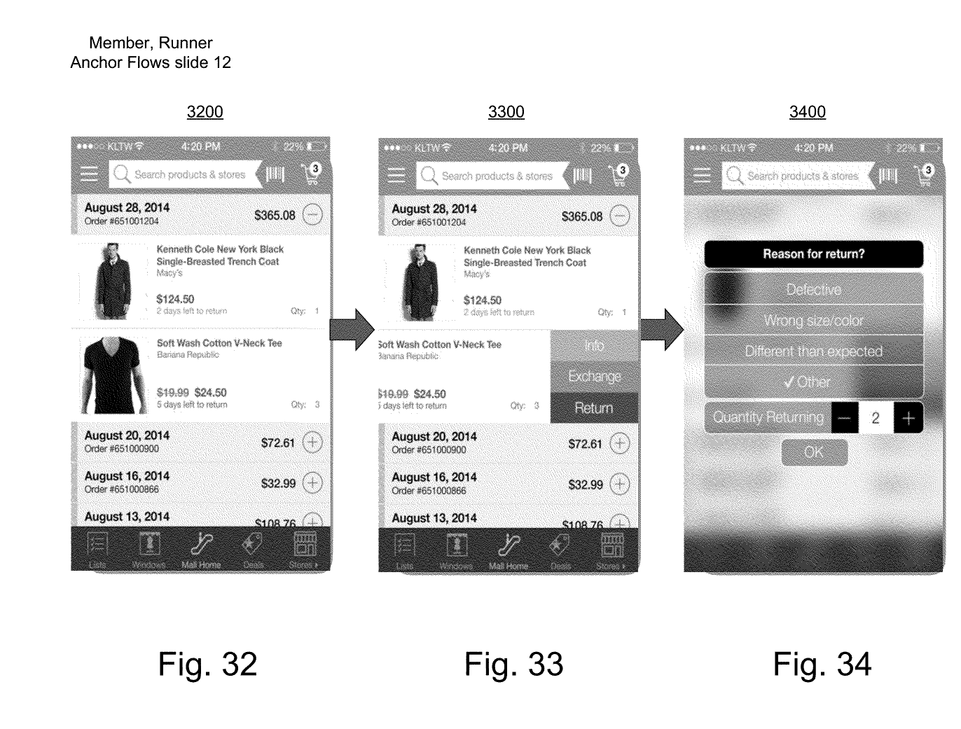

FIGS. 32-34 illustrate example mobile device screens 3200, 3300, 3400 that enable the consumer to initiate returns by tapping on the displayed product of an order, and then tapping on ‘Return’, and through which the consumer may provide the reason for the returns, in accordance with an example embodiment of the present disclosure.

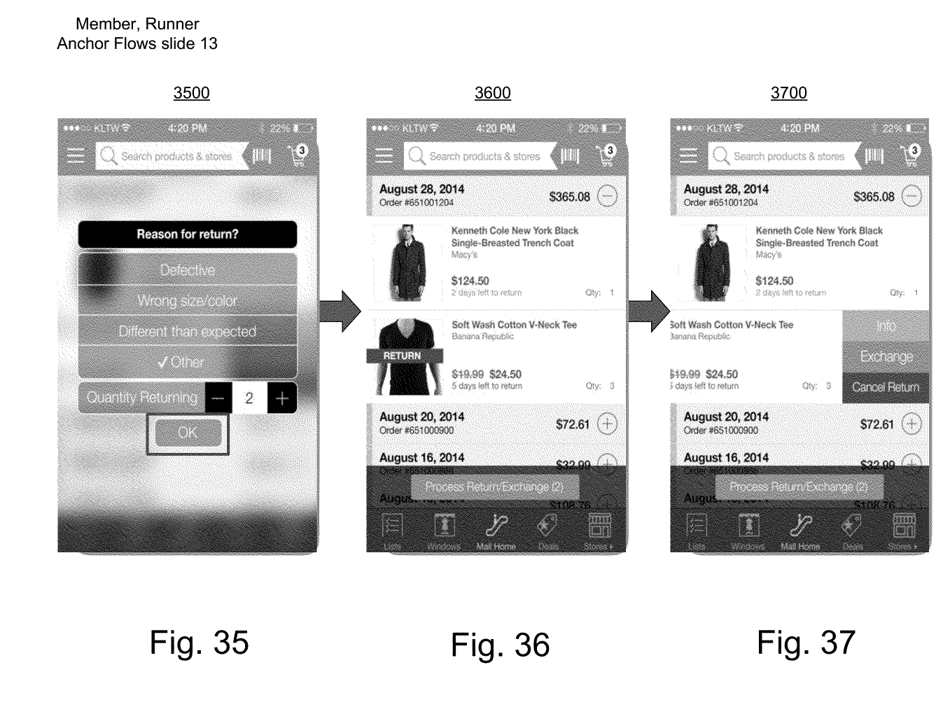

FIGS. 35-37 illustrate example mobile device screens 3500, 3600, 3700 that enable consumers to enter the quantity of items being returned, and to cancel returns before dropping off the product at the “Relay Station,” or before a “Runner” is dispatched to pick up the product from the consumer's home, in accordance with an example embodiment of the present disclosure.

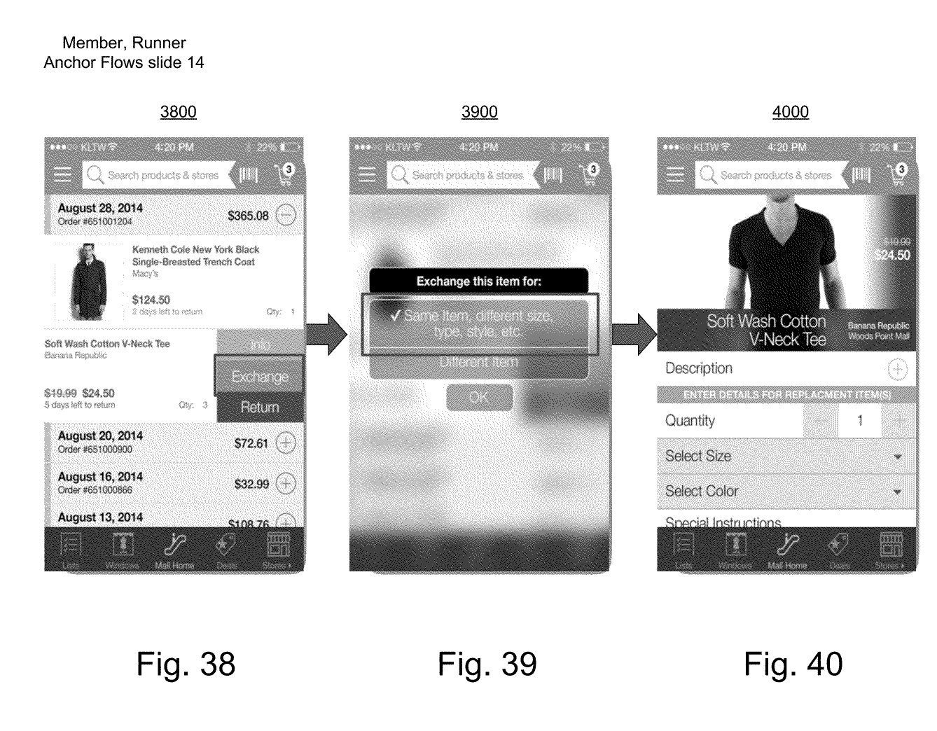

FIGS. 38-40 illustrate example mobile device screens 3800, 3900, 4000 that enable consumer to initiate exchanges by tapping an ‘Exchange’ button, and to choose a variation (e.g., different size or color) of the same product or exchange it for a different product, in accordance with an example embodiment of the present disclosure.

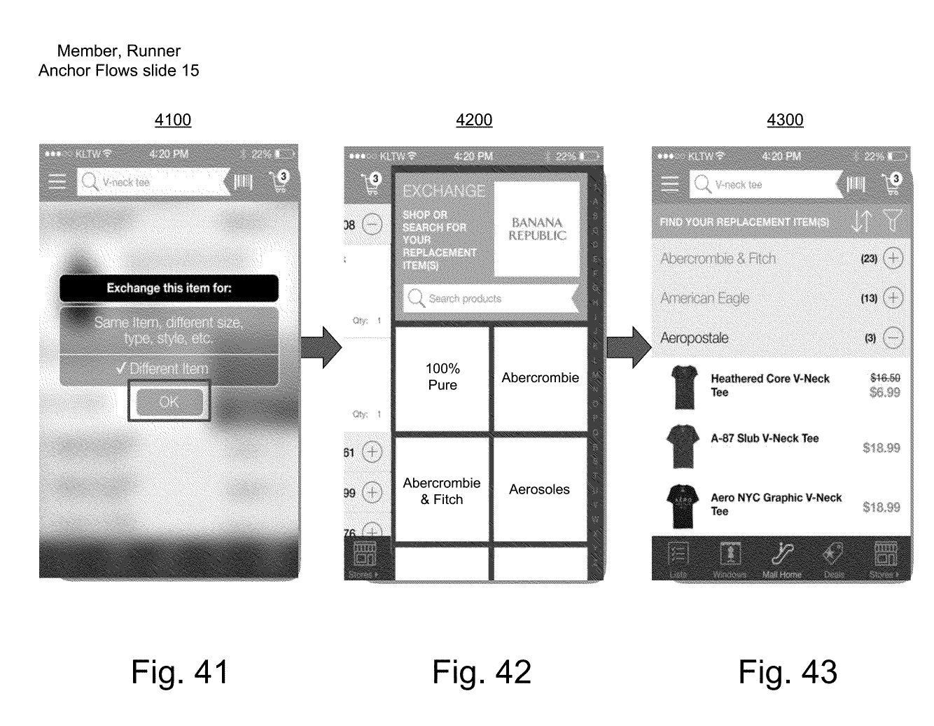

FIGS. 41-43 illustrate example mobile device screens 4100, 4200, 4300 that enable consumer to choose to exchange a product for a different product, including any product from any of the stores in the selected shopping mall, in accordance with an example embodiment of the present disclosure.

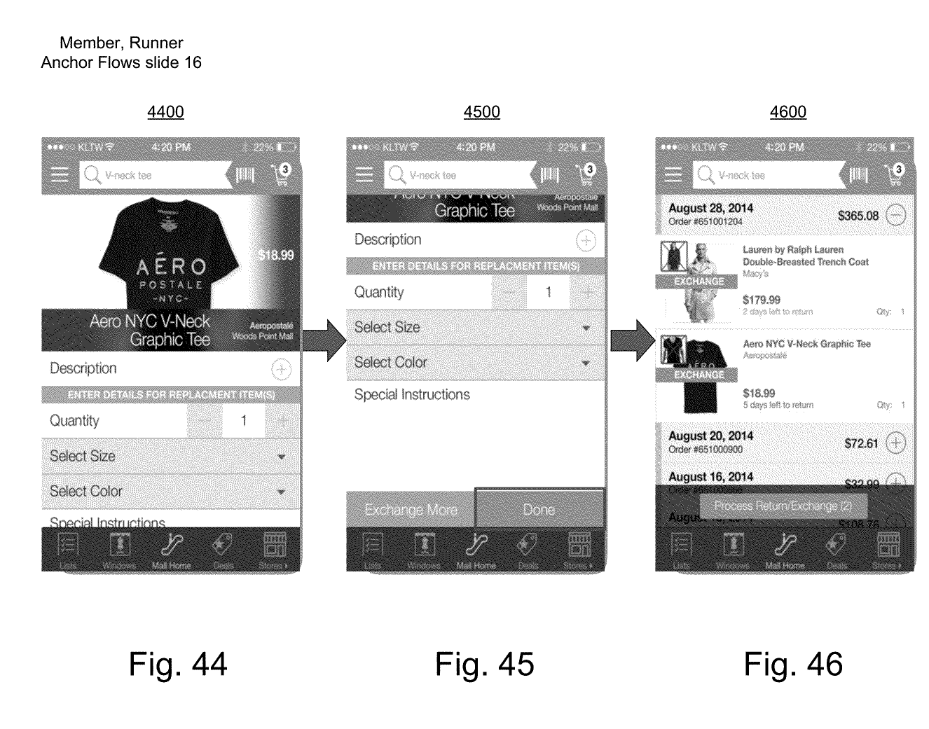

FIGS. 44-46 illustrate example mobile device screens 4400, 4500, 4600 showing further details of product exchange that enable the consumer to continue to exchange more items, or select ‘Done’ to go on to the fulfillment options, in accordance with an example embodiment of the present disclosure.

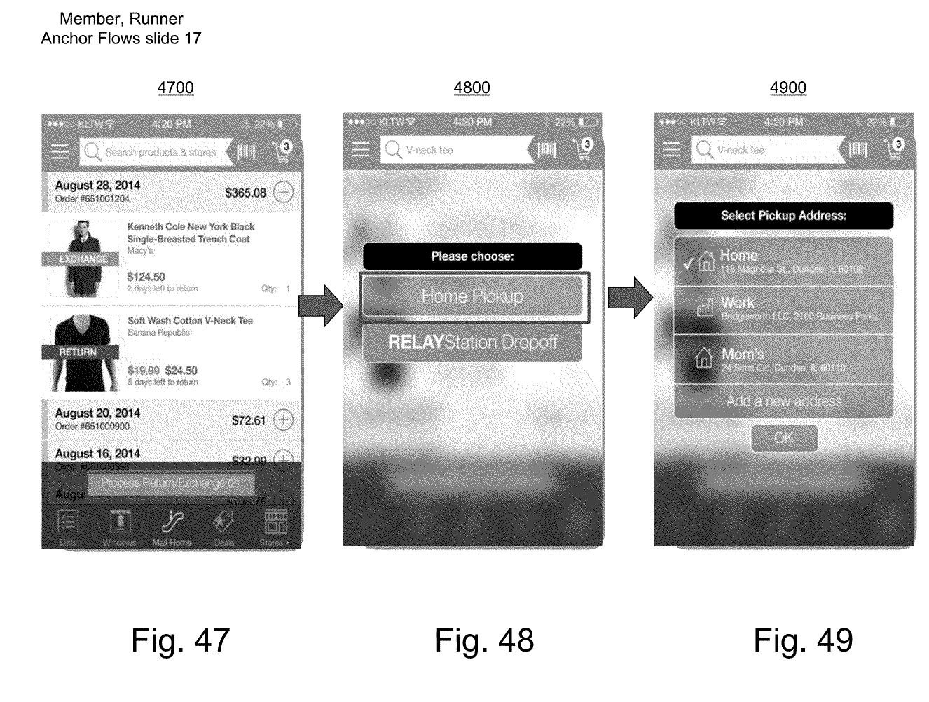

FIGS. 47-49 illustrate example mobile device screens 4700, 4800, 4900 relating to product exchange or return, showing that once the products to be returned/exchanged are selected, the consumer may tap on “Process Returns/Exchanges” to complete the process, and may choose from different fulfillment options including, for example, home pickup or “Relay Station” drop off, in accordance with an example embodiment of the present disclosure.

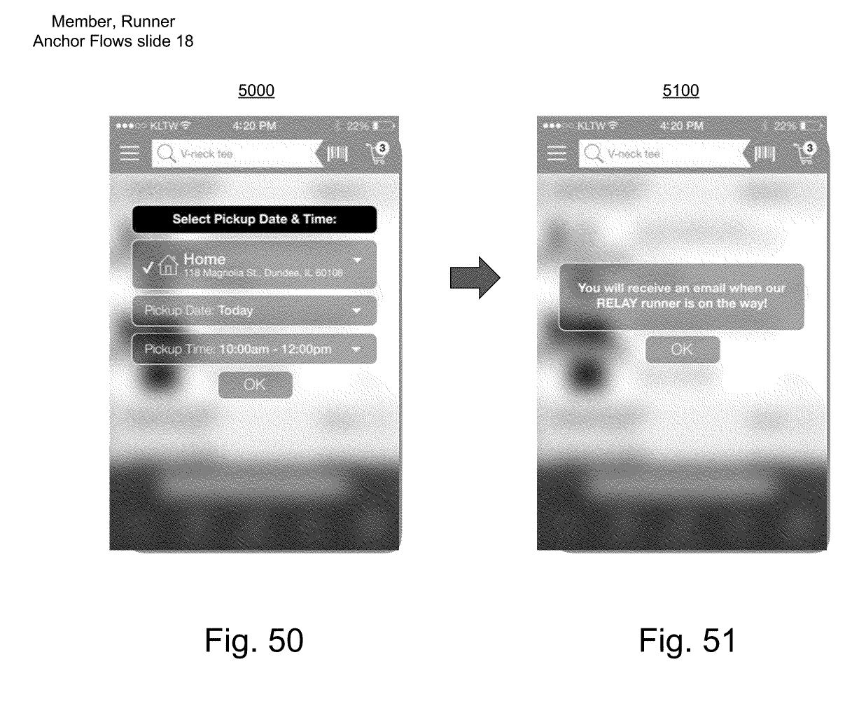

FIGS. 50-51 illustrate example mobile device screens 5000, 5100 that enable a consumer to select the pickup location and schedule the pickup for a preferred time, and that the consumer will receive an email confirmation once the “Runner” is on their way to pick up the product, in accordance with an example embodiment of the present disclosure.

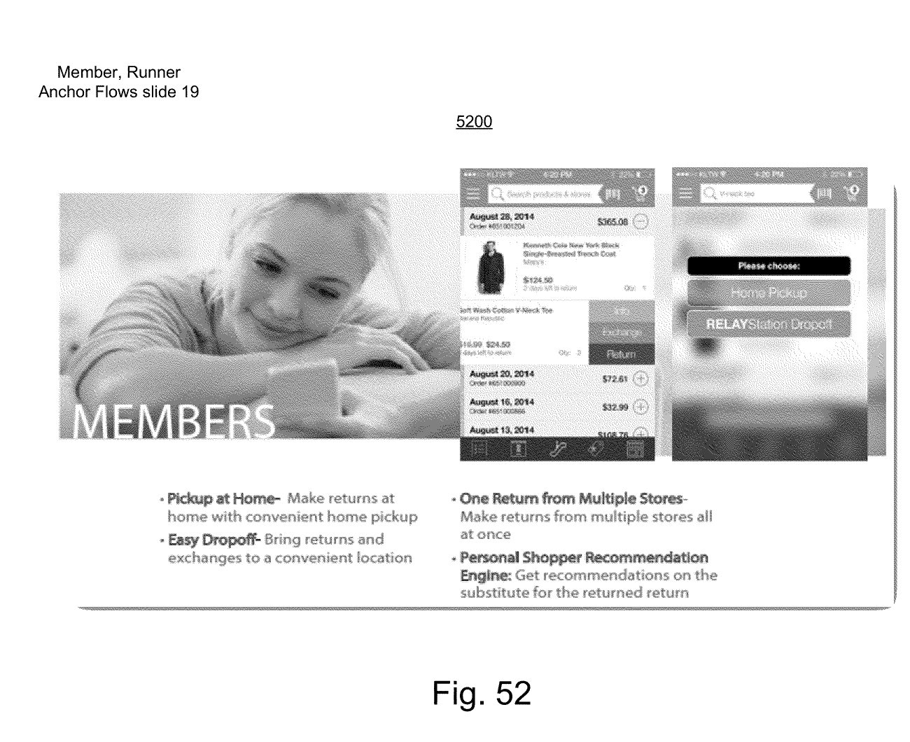

FIG. 52 is an illustration 5200 that explains how an example embodiment of the present disclosure makes returns and exchanges easy for the consumer by bringing the fitting room to the consumer's door step.

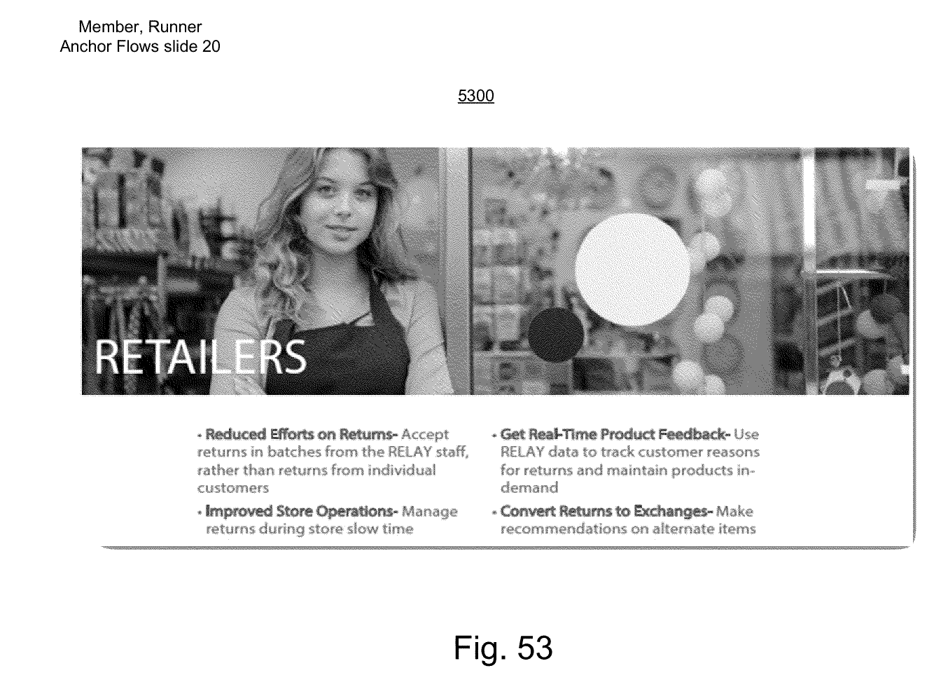

FIG. 53 is an illustration 5300 that explains how an example embodiment of the present disclosure makes returns and exchanges frictionless, thus improving consumer experience and mall store performance.

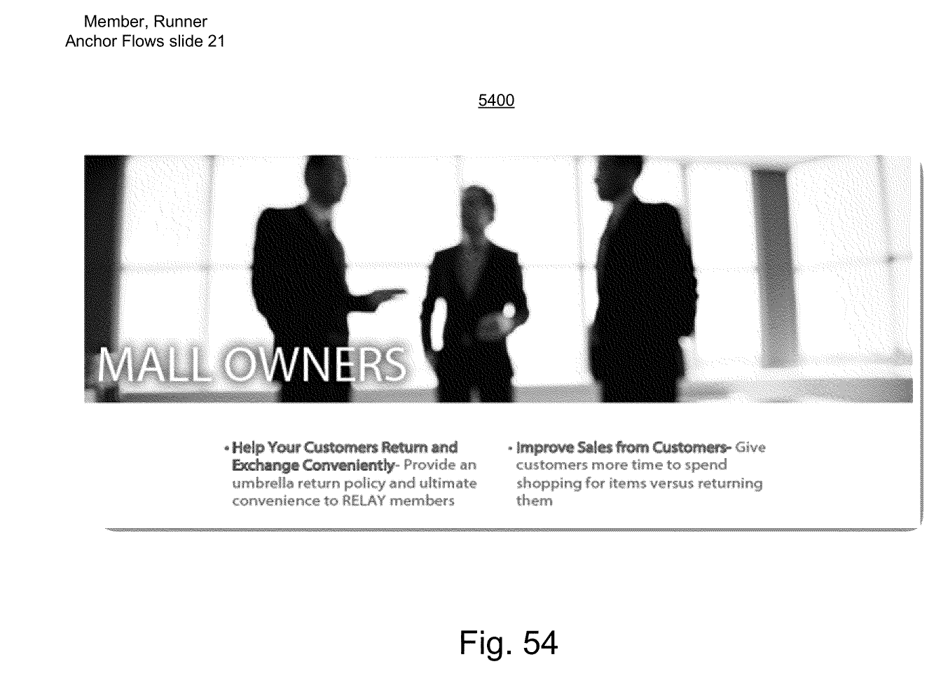

FIG. 54 is an illustration 5400 that explains how an example embodiment of the present disclosure makes the return and exchange process convenient, and brings more customers to the shopping mall.

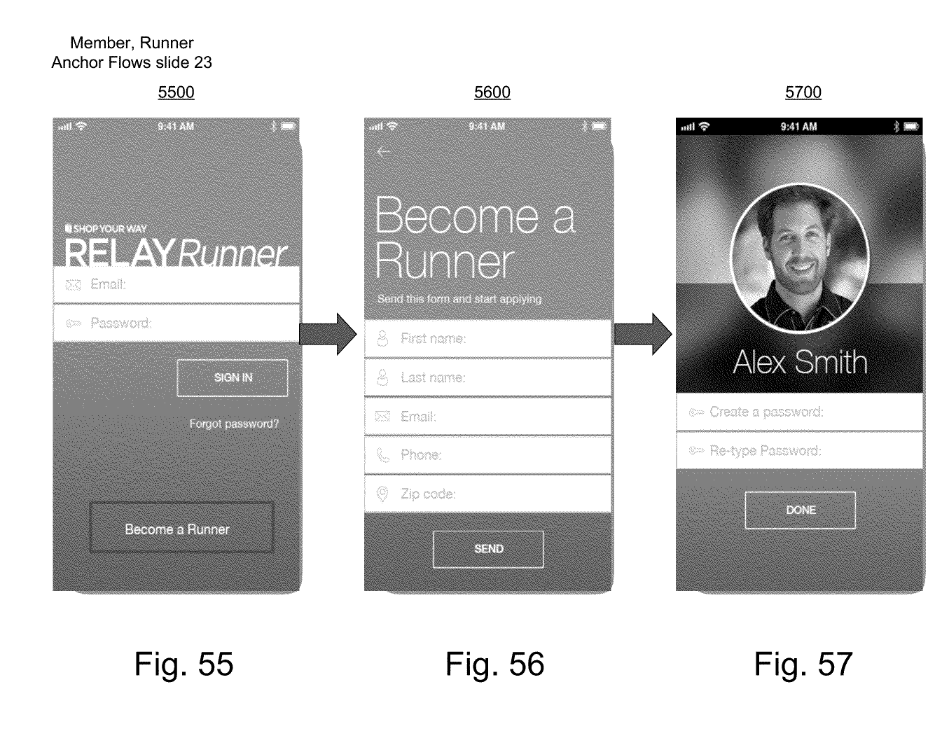

FIGS. 55-57 illustrate example mobile device screens 5500, 5600, 5700 that support a simple self-service sign up process for anyone to easily register as “Relay Runners” or “Runners,” in accordance with an example embodiment of the present disclosure.

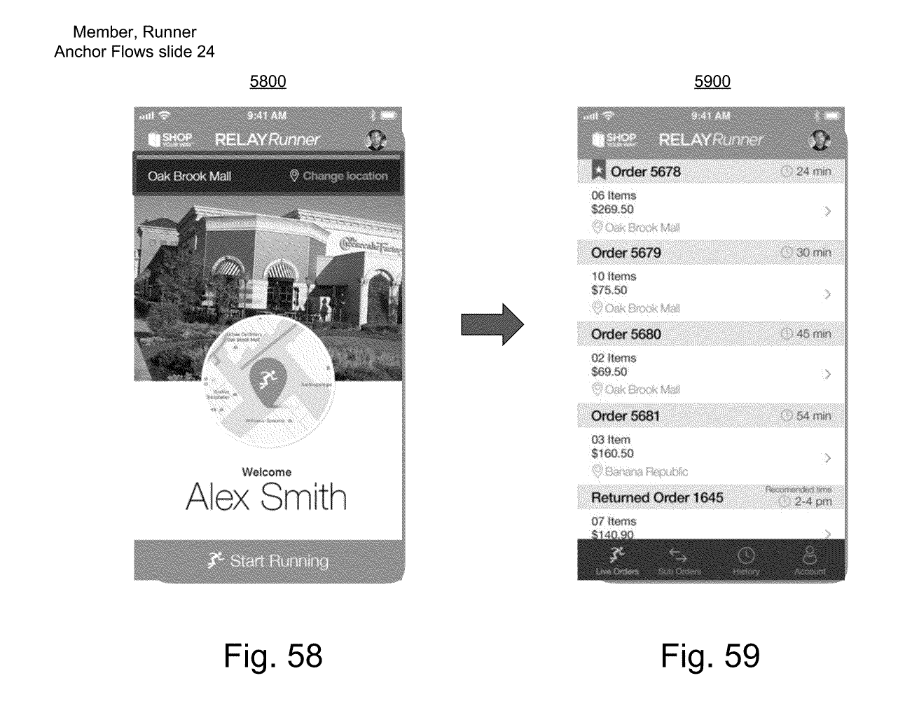

FIGS. 58-59 illustrate example mobile device screens 5800, 5900 that enable a “Relay Runner” to act a proxy shopper from any of the available malls by selecting a desired shopping mall from a home screen, and to provide the “Relay Runner” with a listing of open orders sorted by the time left for fulfilling the orders, in accordance with an example embodiment of the present disclosure.

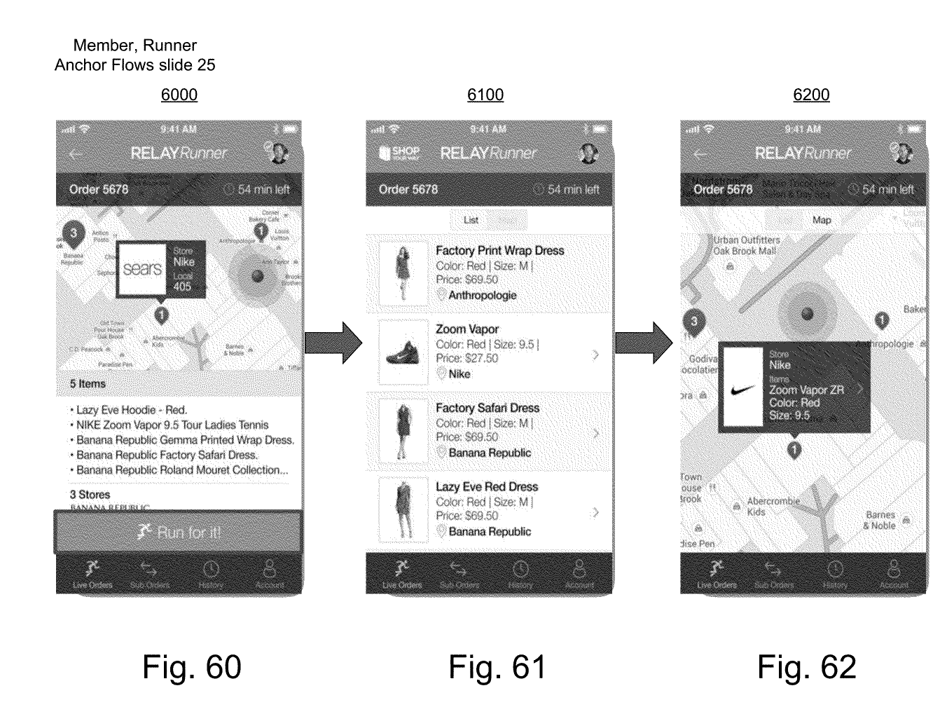

FIGS. 60-62 illustrate example mobile device screens 6000, 6100, 6200 that enable the “Relay Runner” to see a detailed description of all ordered items with store and route details, to view all products and stores in each accepted order, and to view the products on a map of the shopping mall, in accordance with an example embodiment of the present disclosure.

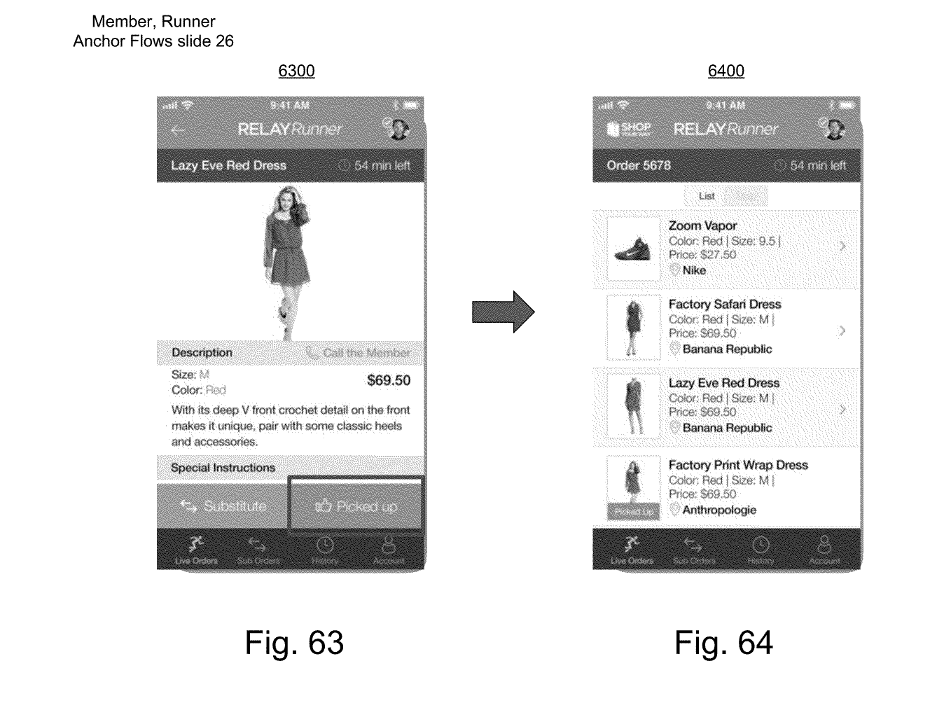

FIGS. 63-64 illustrate example mobile device screens 6300, 6400 that enable a “Relay Runner”, following selection of a product, to view the product details along with any special instructions, to call the consumer for more details, and to mark the item as “Picked up,” following checkout from store, upon which the product is move to the bottom of the list, in accordance with an example embodiment of the present disclosure.

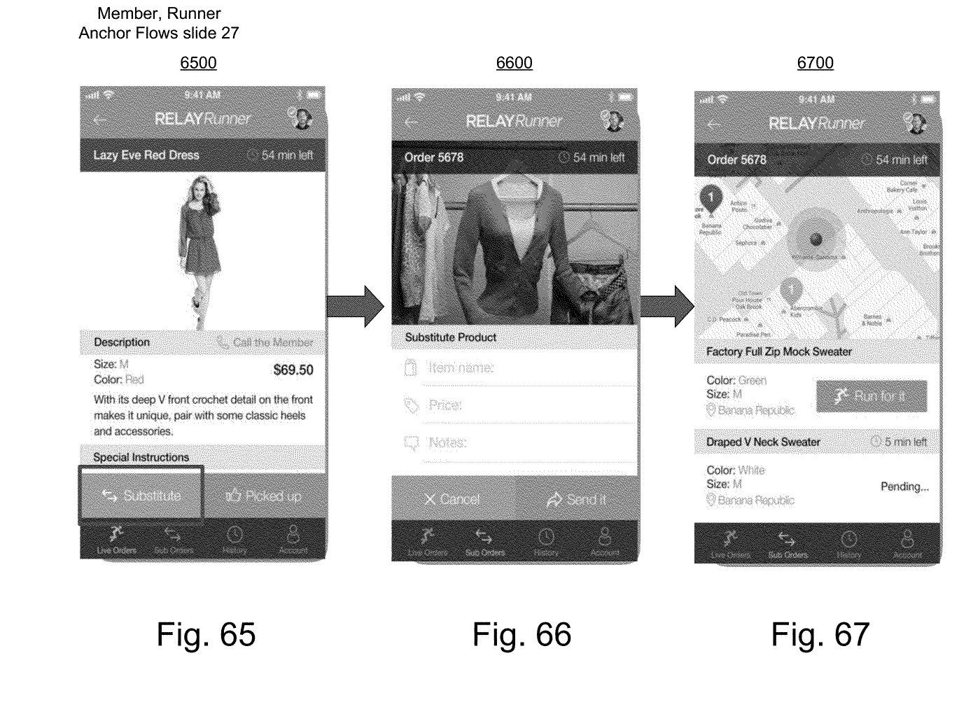

FIGS. 65-67 illustrate example mobile device screens 6500, 6600, 6700 that enable a “Relay Runner” to look for a substitute product for an ordered item that is not available, to notify the consumer, to take a picture of the substitute product, to enter the product name, price, and description of the substitute product, to send the product information to the consumer, and then to purchase the substitute product, once the member approves the substitution, in accordance with an example embodiment of the present disclosure.

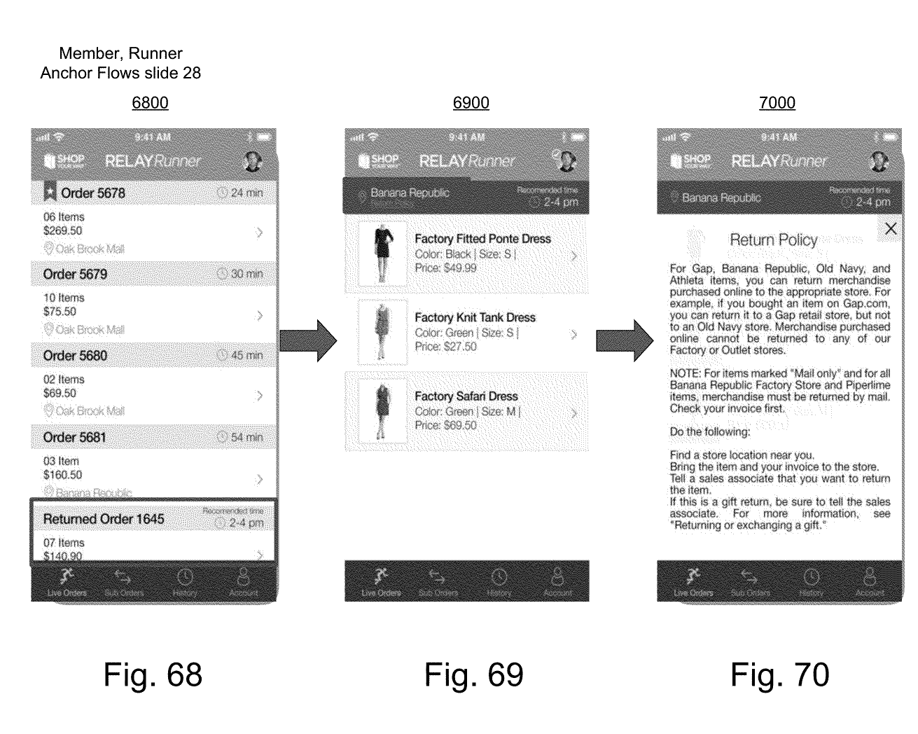

FIGS. 68-70 illustrate example mobile device screens 6800, 6900, 7000, showing that “Return Orders” may be shown in a list of open orders, that a time for return of the product(s) may be shown based on store “slow” time, that the products for return may be grouped together by stores into an order, and that the return policy of each store in the order may be provided to the “Relay Runner,” in accordance with an example embodiment of the present disclosure.

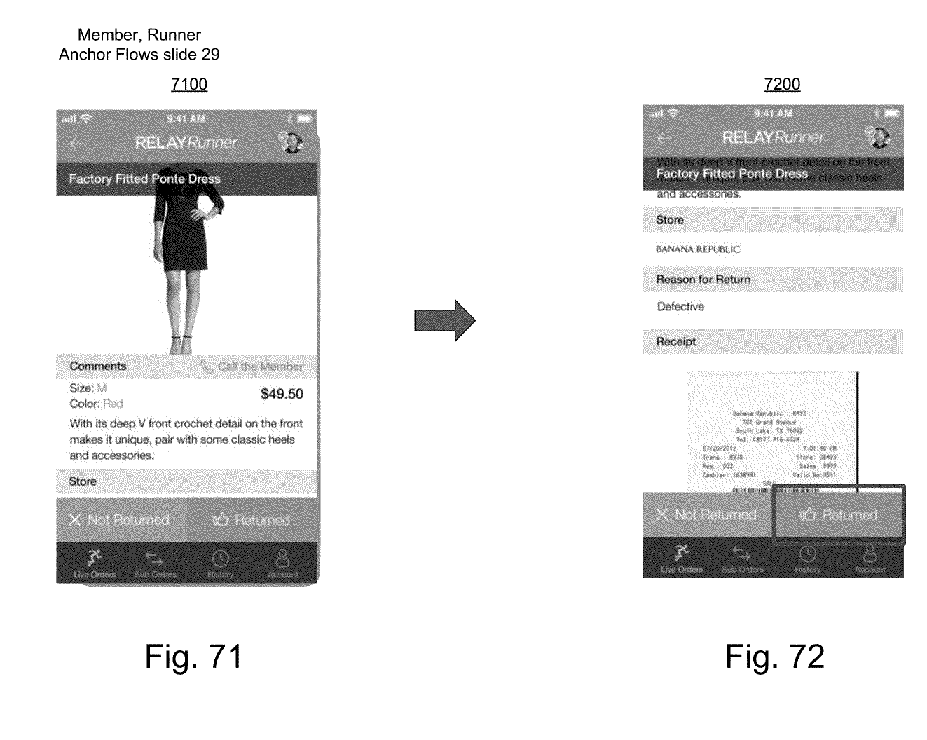

FIGS. 71-72 illustrate example mobile device screens 7100, 7200 showing that a returned product may have description and reason for return, and that the returned product may also have a scanned image of receipt for that order, in accordance with an example embodiment of the present disclosure.

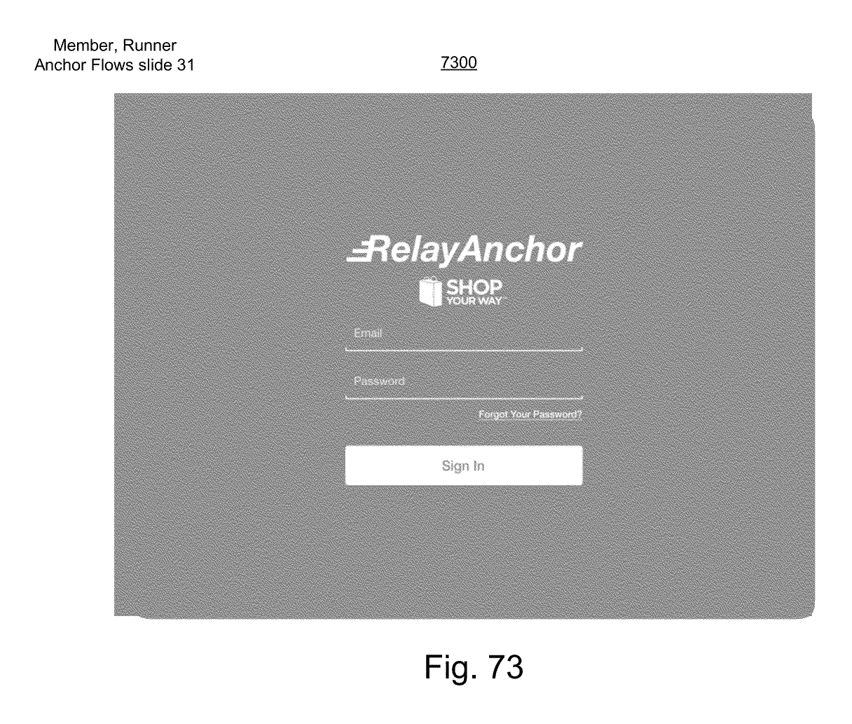

FIG. 73 illustrates an example login screen 7300 for a “Relay Anchor” software application that may be used by a “Relay Anchor” manager of a “Relay Station,” the person that manages order fulfillment details in real time and that is responsible for delivering the order to the consumer, in accordance with an example embodiment of the present disclosure.

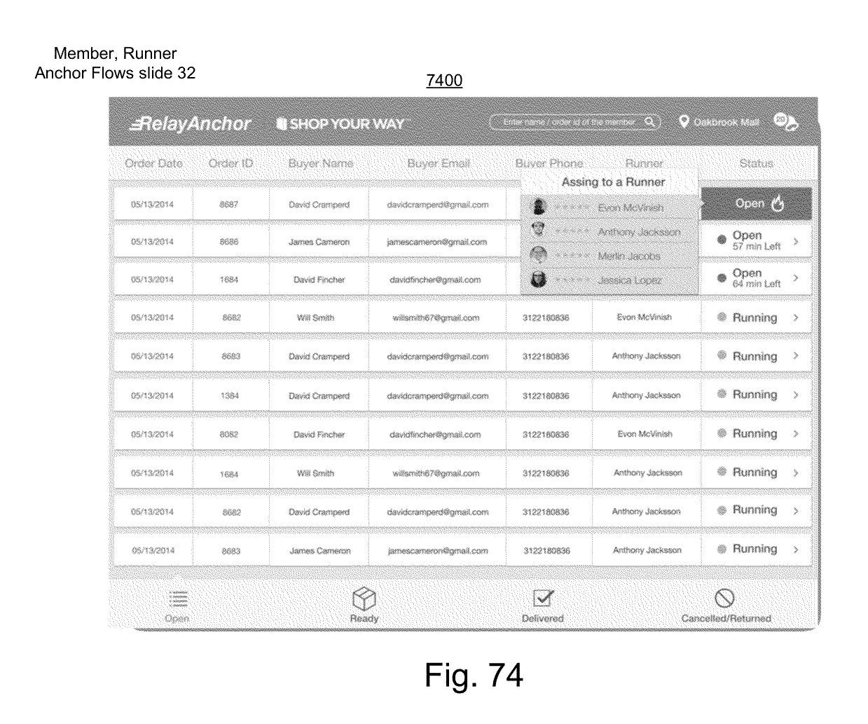

FIG. 74 illustrates an example display screen 7400 showing a detailed listing of open orders that are available to a “Relay Anchor” for assignment to any available “Relay Runners,” in accordance with an example embodiment of the present disclosure.

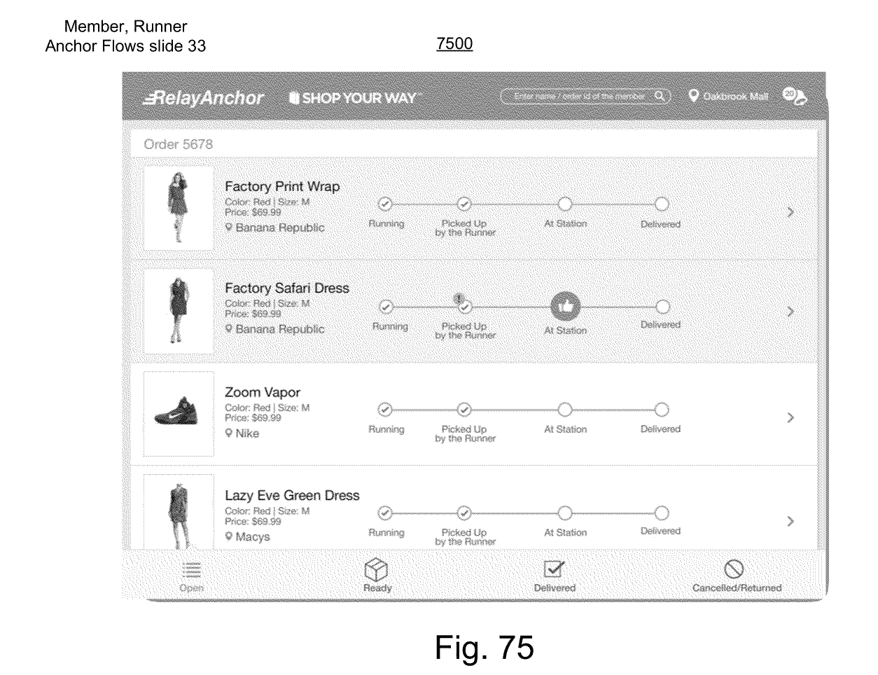

FIG. 75 illustrates an example display screen 7500 showing an individual order page listing all the product items in the order and their status, which the “Relay Anchor” can update, or speak with the consumer or “Relay Runner” at any time, in accordance with an example embodiment of the present disclosure.

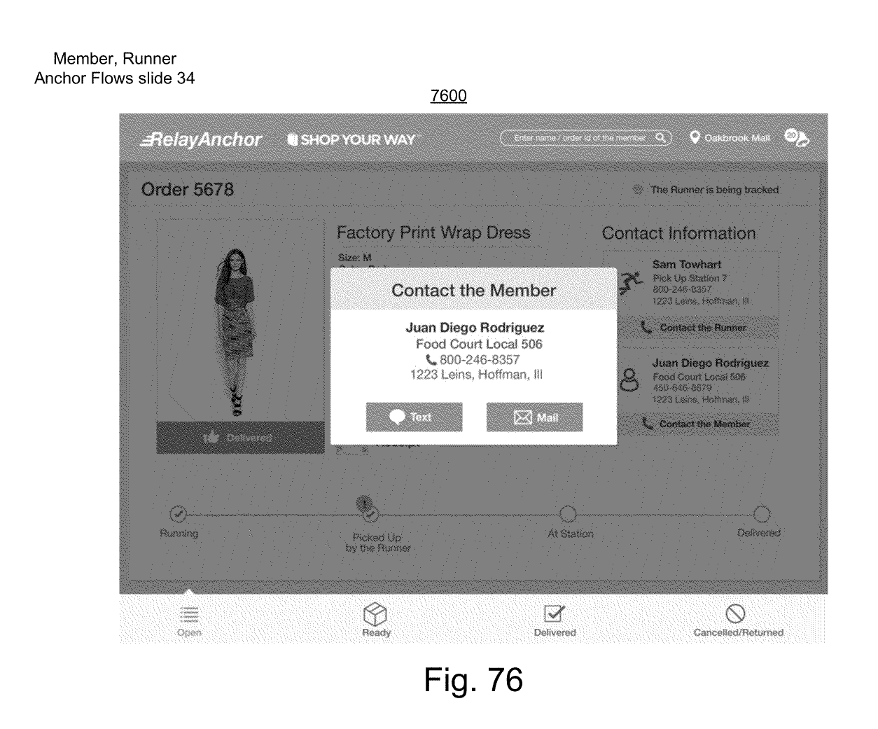

FIG. 76 illustrates an example display screen 7600 showing that the “Relay Anchor” software application enables the “Relay Anchor” to contact a consumer through, for example, a phone call, a text, or an email when appropriate, in accordance with an example embodiment of the present disclosure.

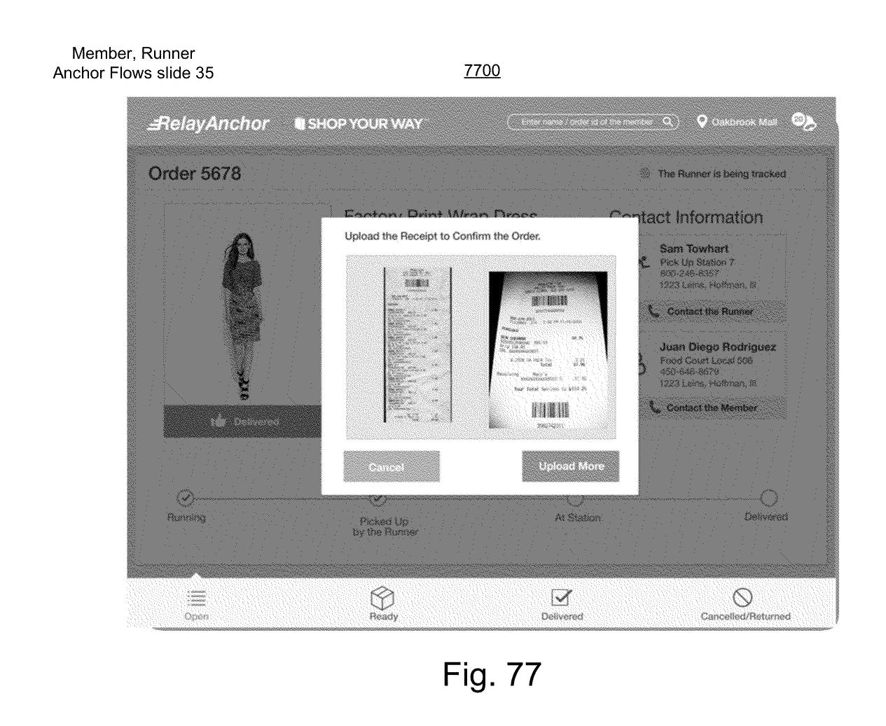

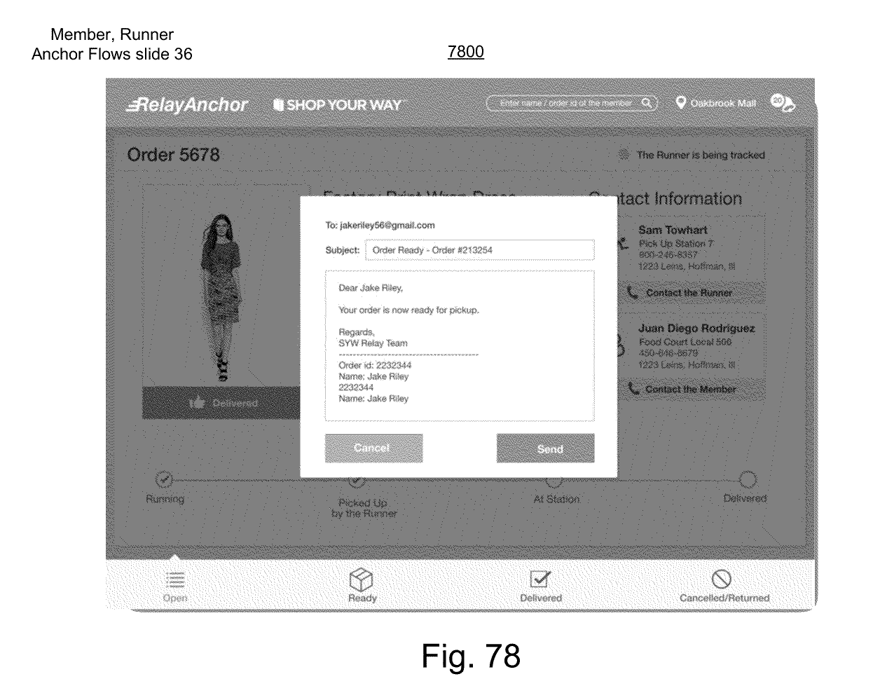

FIG. 77 illustrates an example display screen 7700 showing that the “Relay Anchor” software application enables the “Relay Anchor” to upload all the receipts for an order, in which each order may have multiple receipts, in accordance with an example embodiment of the present disclosure.

FIG. 78 illustrates an example display screen 7800 showing that once all of the products in an order have been delivered to the “Relay Station,” the “Relay Anchor” may then send a pickup/delivery email to the consumer that placed the order, in accordance with an example embodiment of the present disclosure.

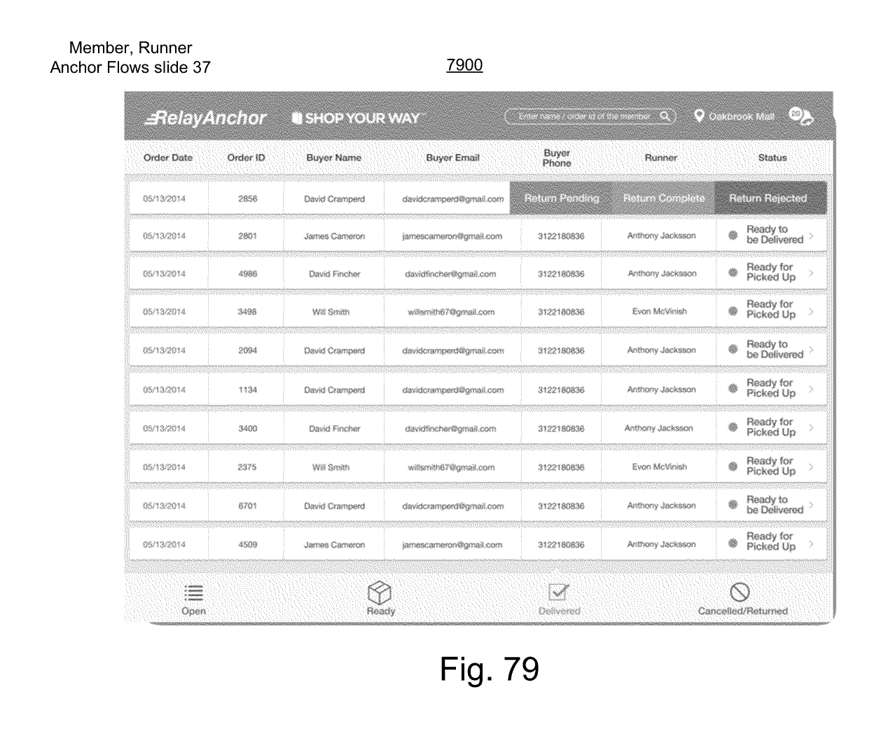

FIG. 79 illustrates an example display screen 7900 showing how a “Relay Anchor” can initiate returns after receiving the product from the consumer, in accordance with an example embodiment of the present disclosure.

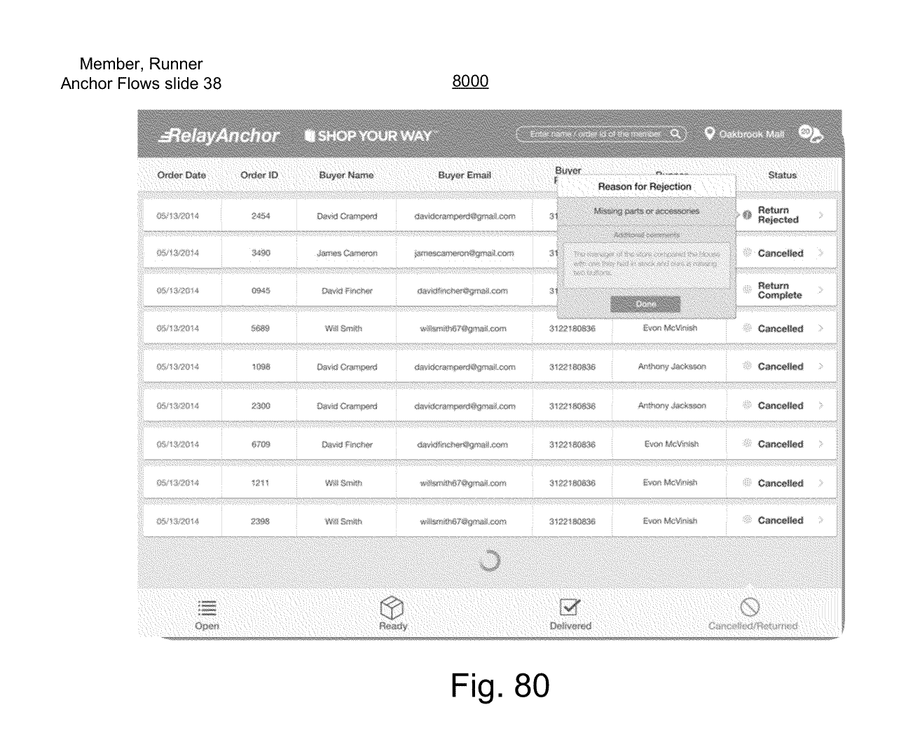

FIG. 80 illustrates an example display screen 8000 showing how a “Relay Anchor” may reject a product return for various reasons including, for example, damaged product and missing parts/accessories, in accordance with an example embodiment of the present disclosure.

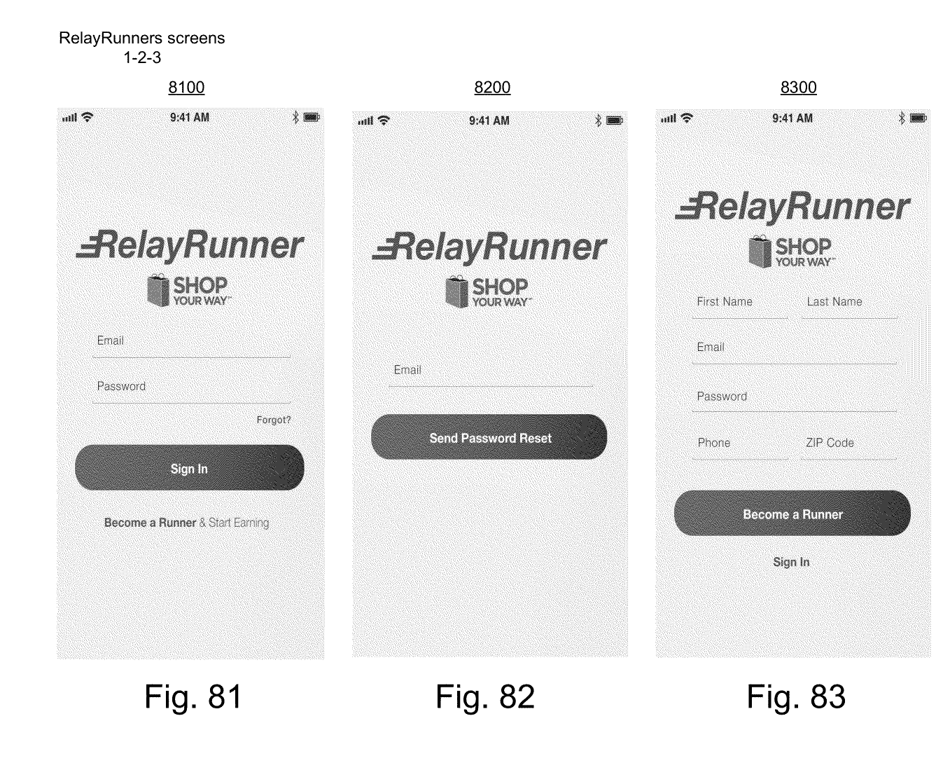

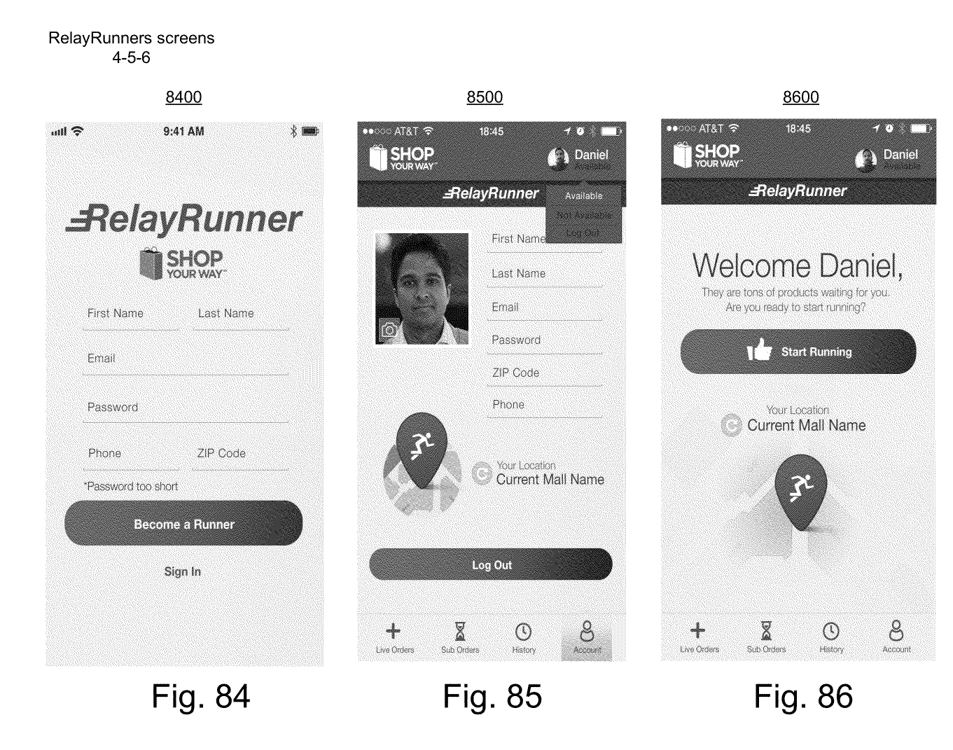

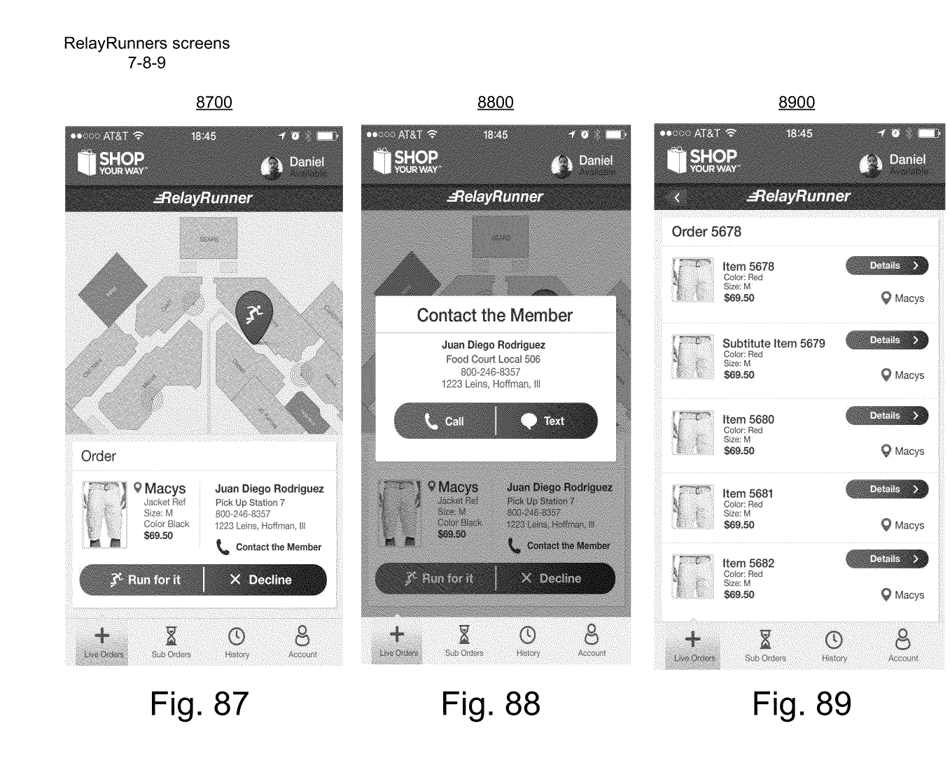

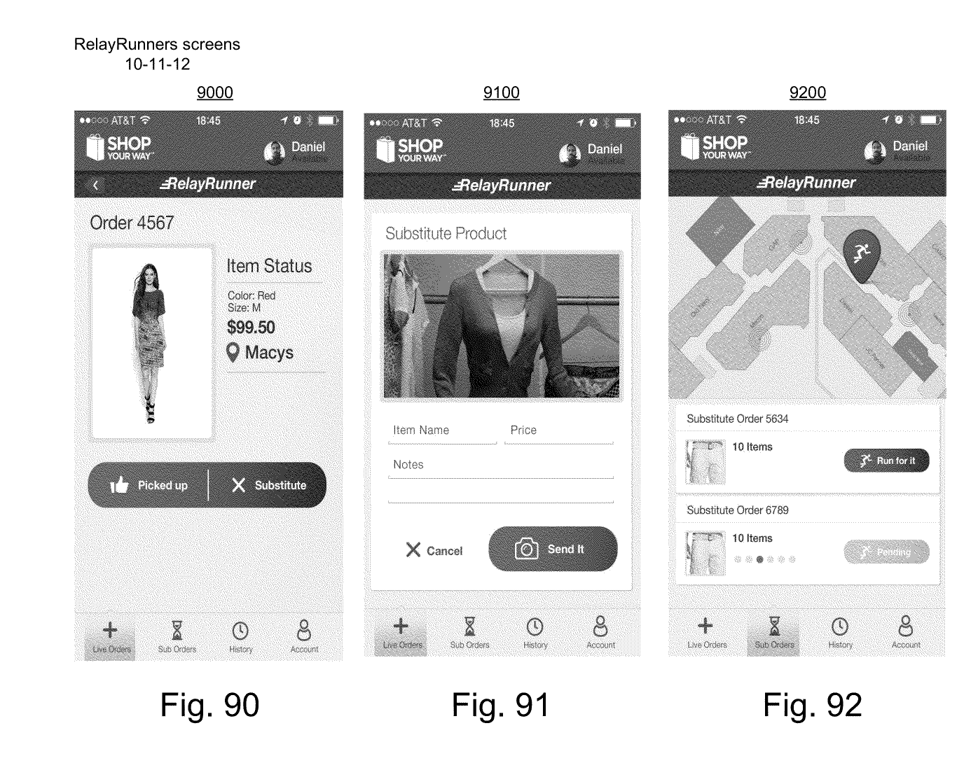

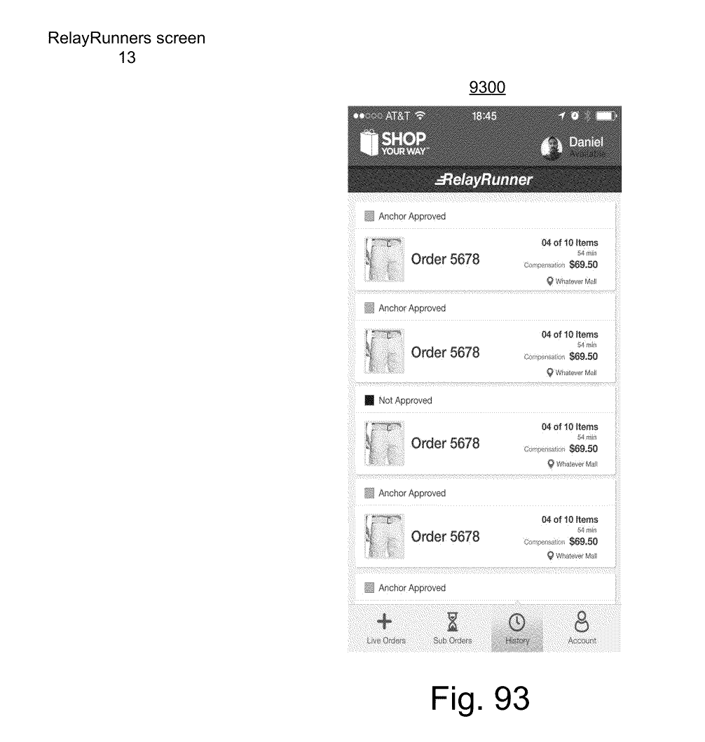

FIGS. 81-93 illustrate example mobile device screens 8100 to 9300 for a “Relay Runner” software application, in accordance with an example embodiment of the present disclosure.

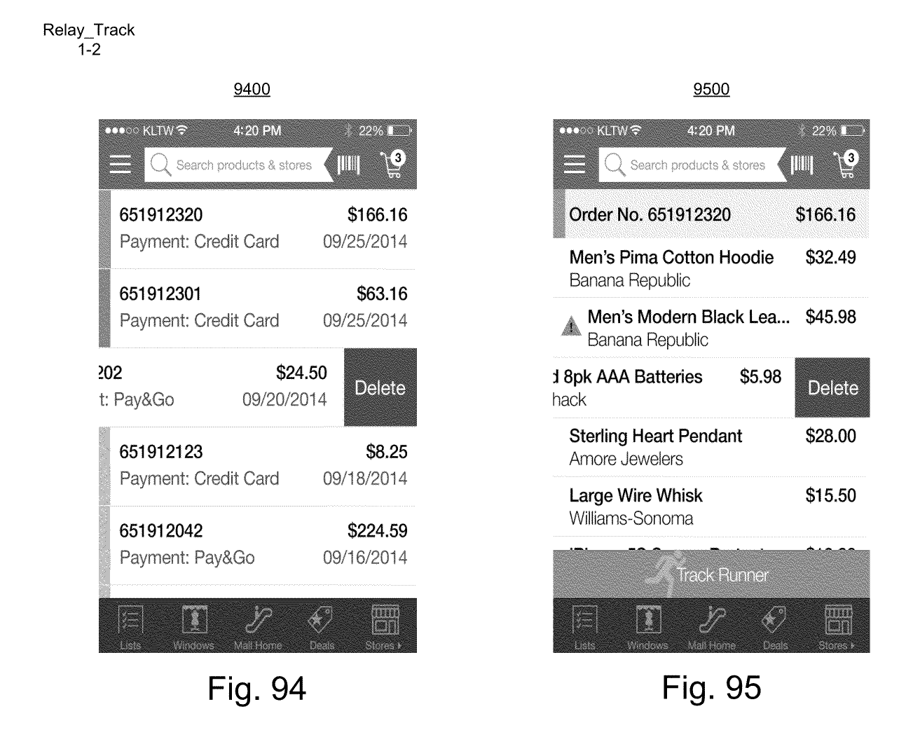

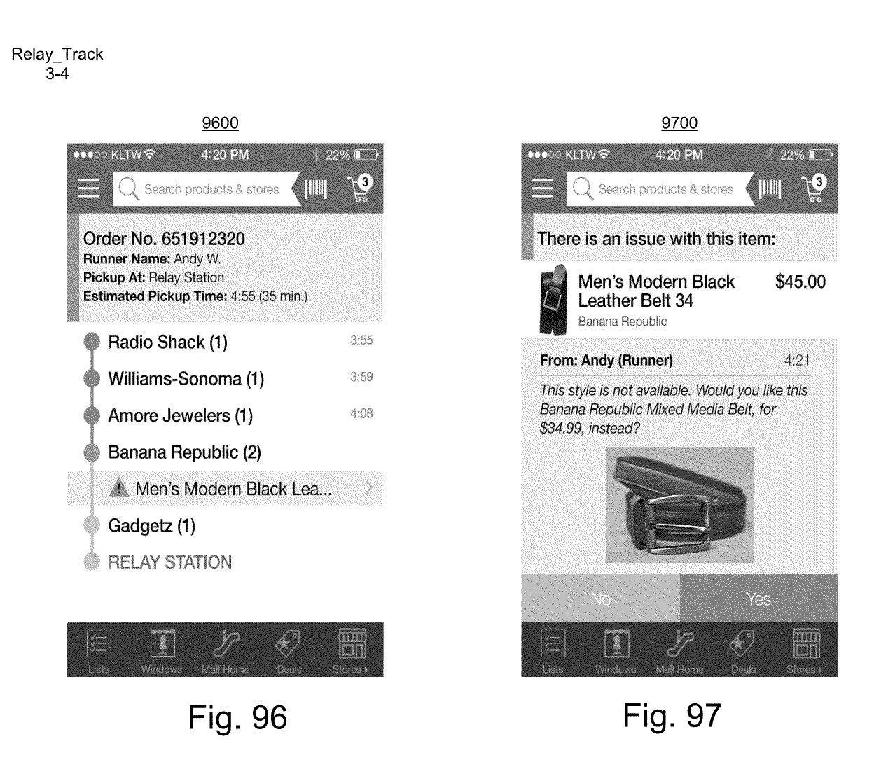

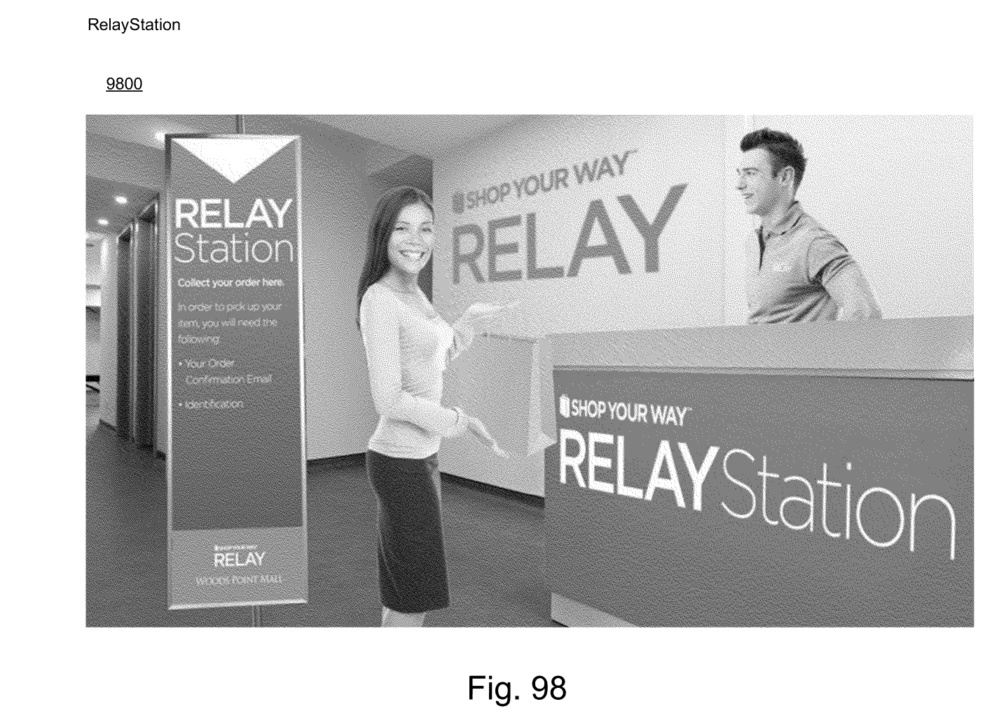

FIGS. 94-97 illustrate example mobile device screens 9400 to 9700 for a consumer software application for the mobile device, which enables the consumer to track the “Relay Runner” that is procuring the products items in their order, in accordance with an example embodiment of the present disclosure.

FIG. 98 is an illustration 9800 of an example “Relay Station,” in accordance with an example embodiment of the present disclosure.

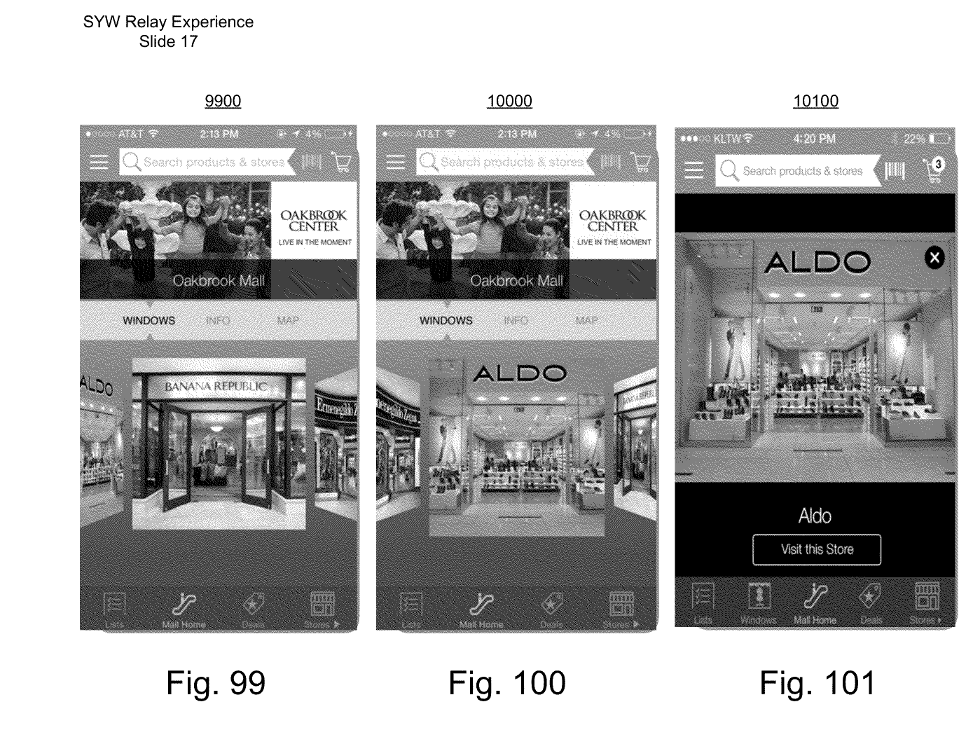

FIGS. 99-101 illustrate example mobile device screens 9900, 10000, 10100 of a consumer software application that enables consumers to view the store fronts of a shopping mall on a home screen carousel using, for example, a “swipe” gesture across the pictures of the carousel to view the store fronts of other stores in the shopping mall, and which enables the consumer to visit the store by selecting its store front, in accordance with an example embodiment of the present disclosure.

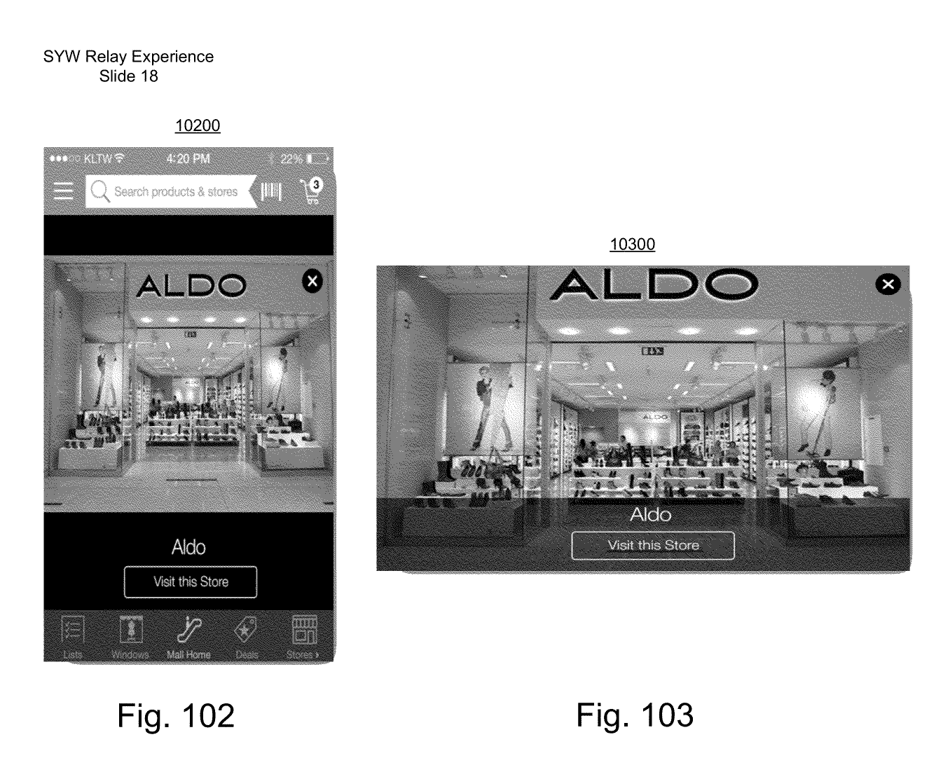

FIGS. 102-103 illustrate example mobile device screens 10200, 10300 of a consumer software application in which selecting the store from the carousel of FIGS. 99-101 maximizes the store front image and scales it to full screen when the consumer device is positioned for a “landscape view,” in accordance with an example embodiment of the present disclosure.

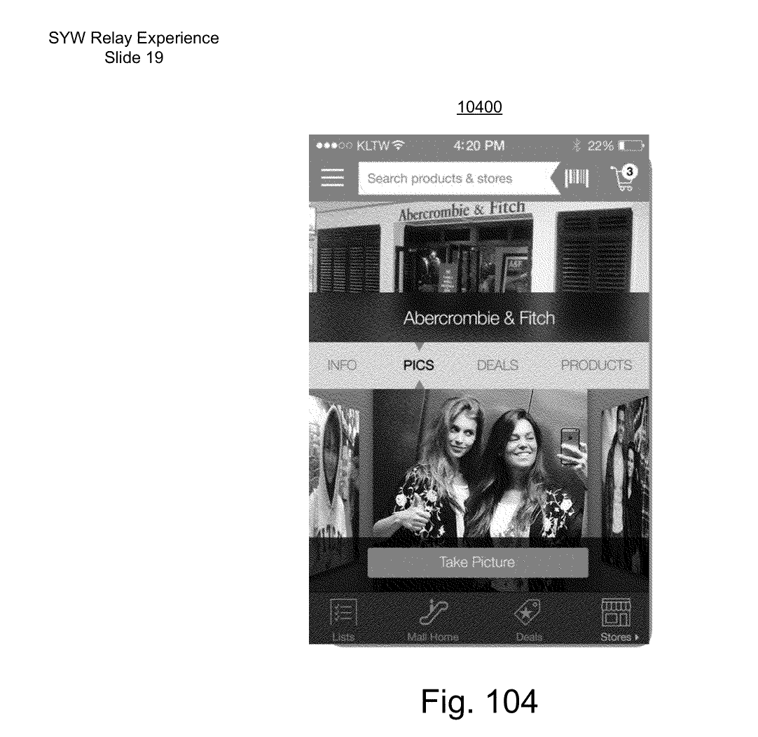

FIG. 104 is an illustration of an example mobile device screen 10400 showing how consumers may take pictures of their purchase and upload the pictures in association with the respective store for others to view, in accordance with an example embodiment of the present disclosure.

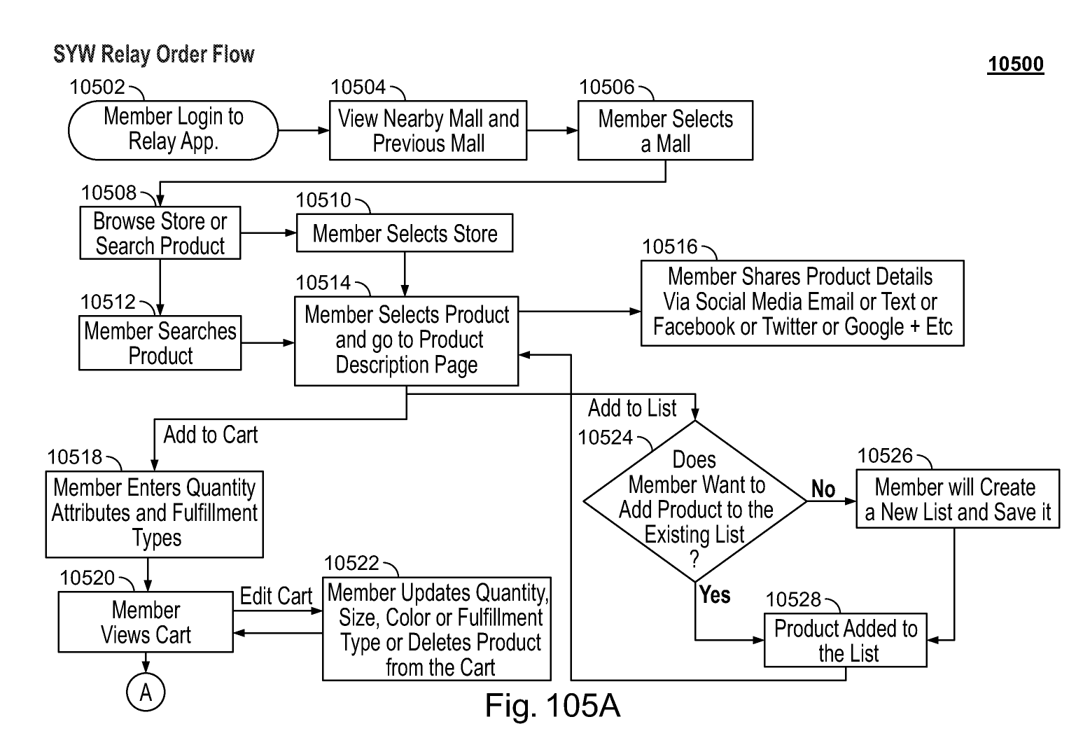

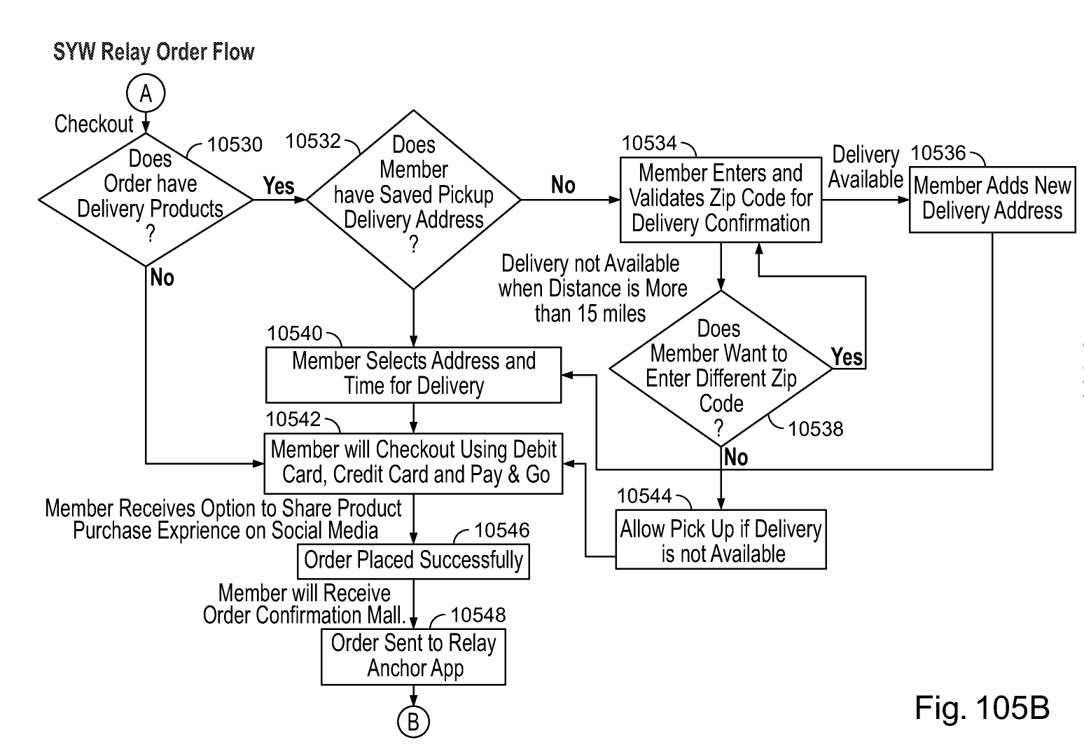

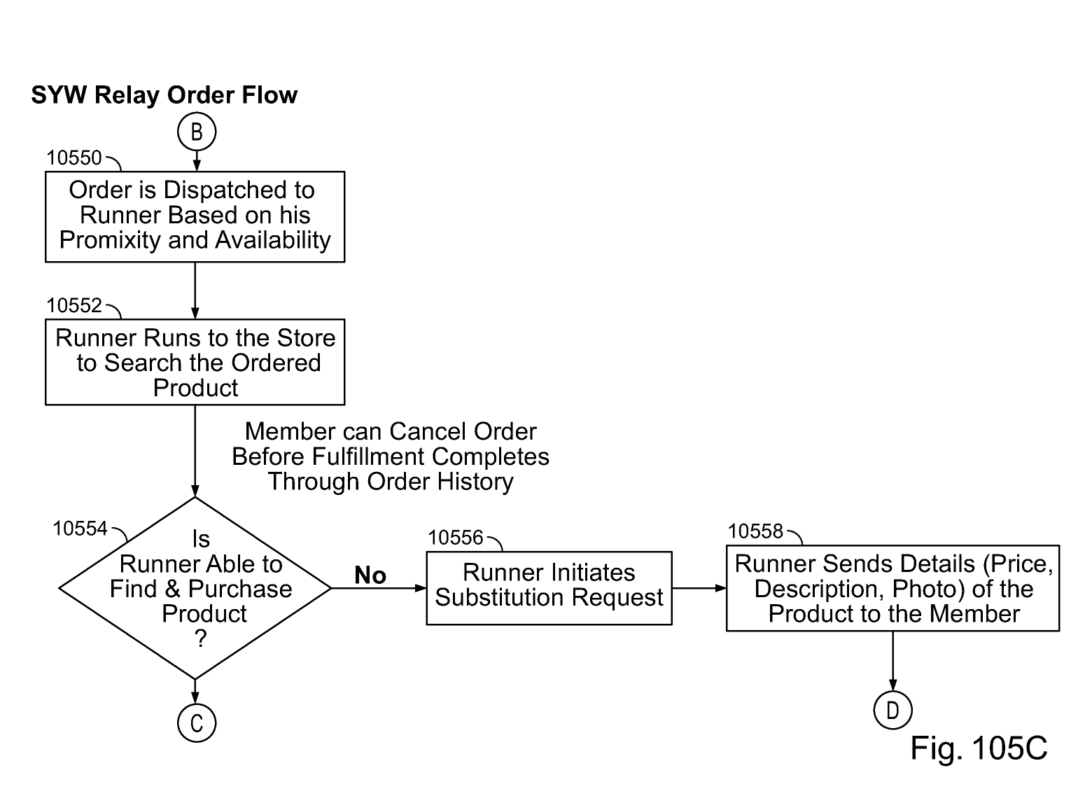

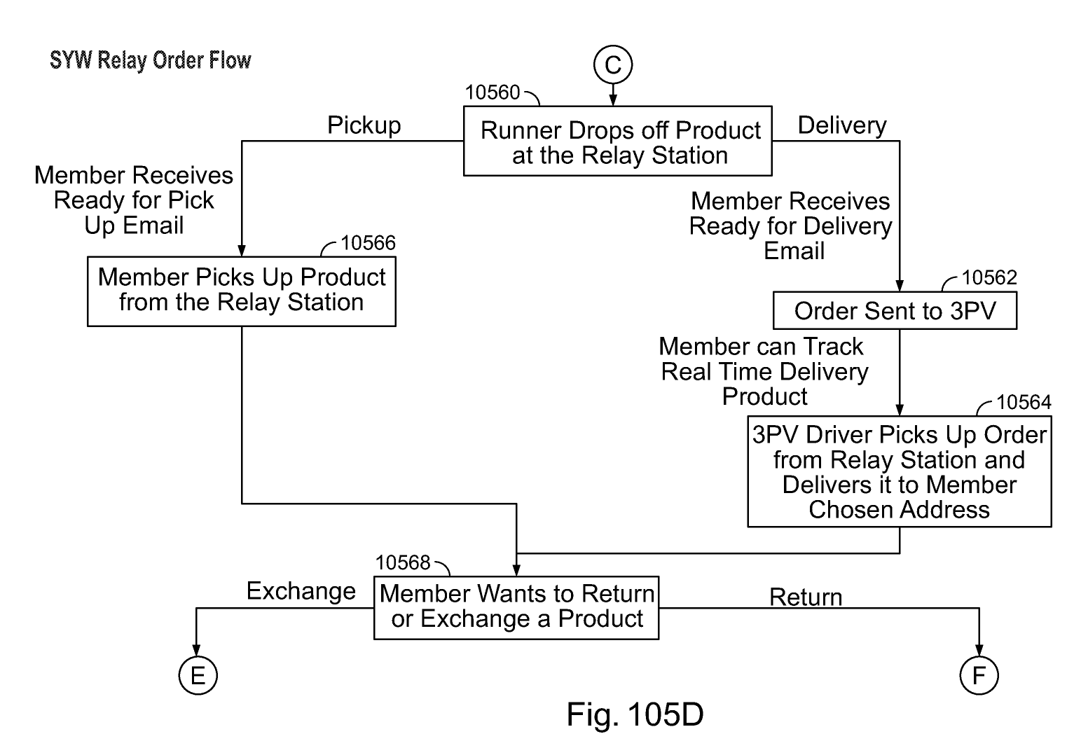

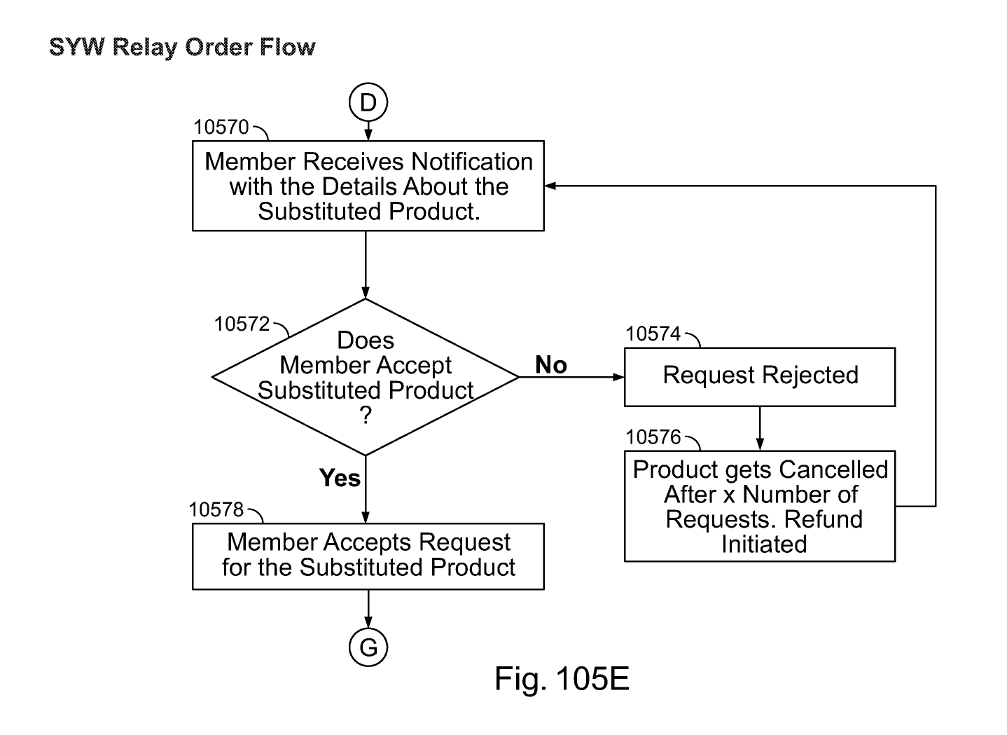

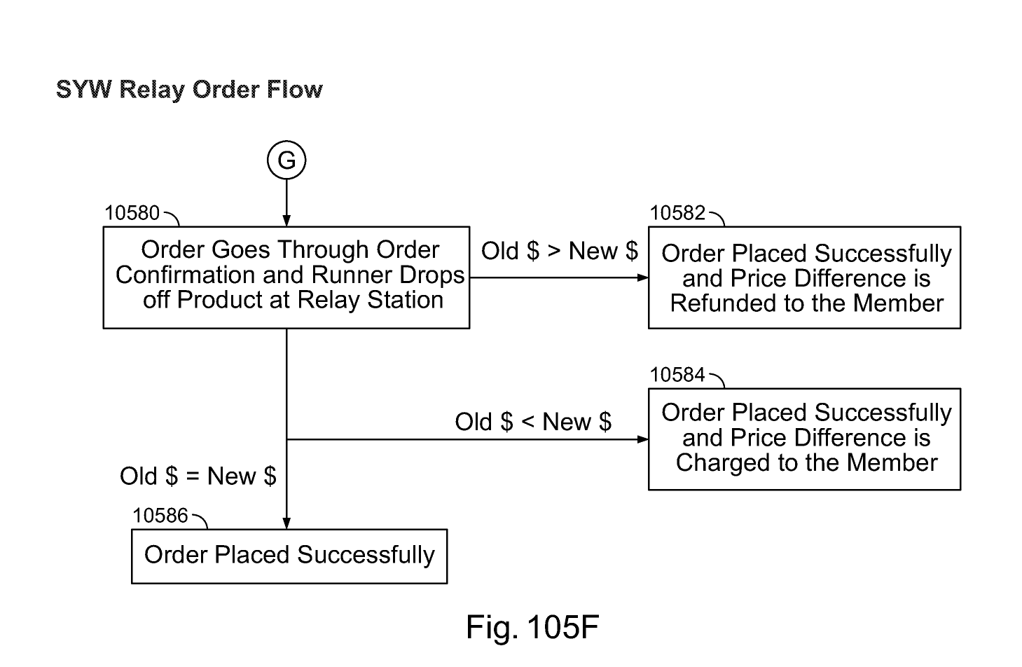

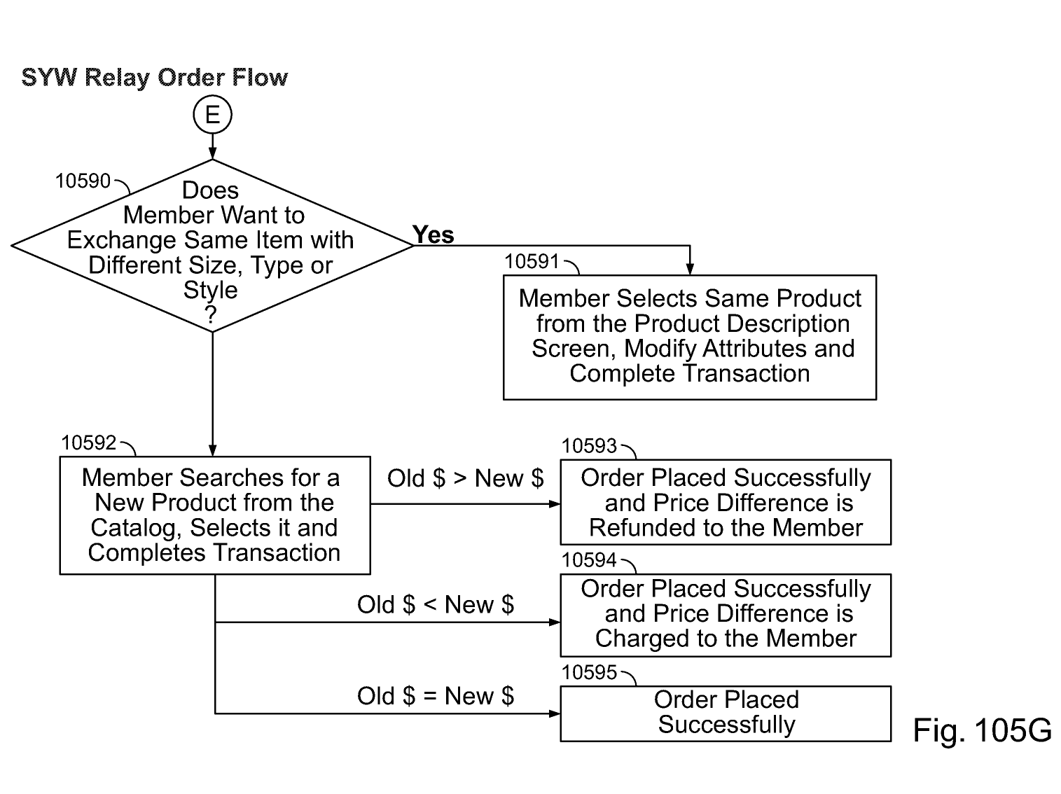

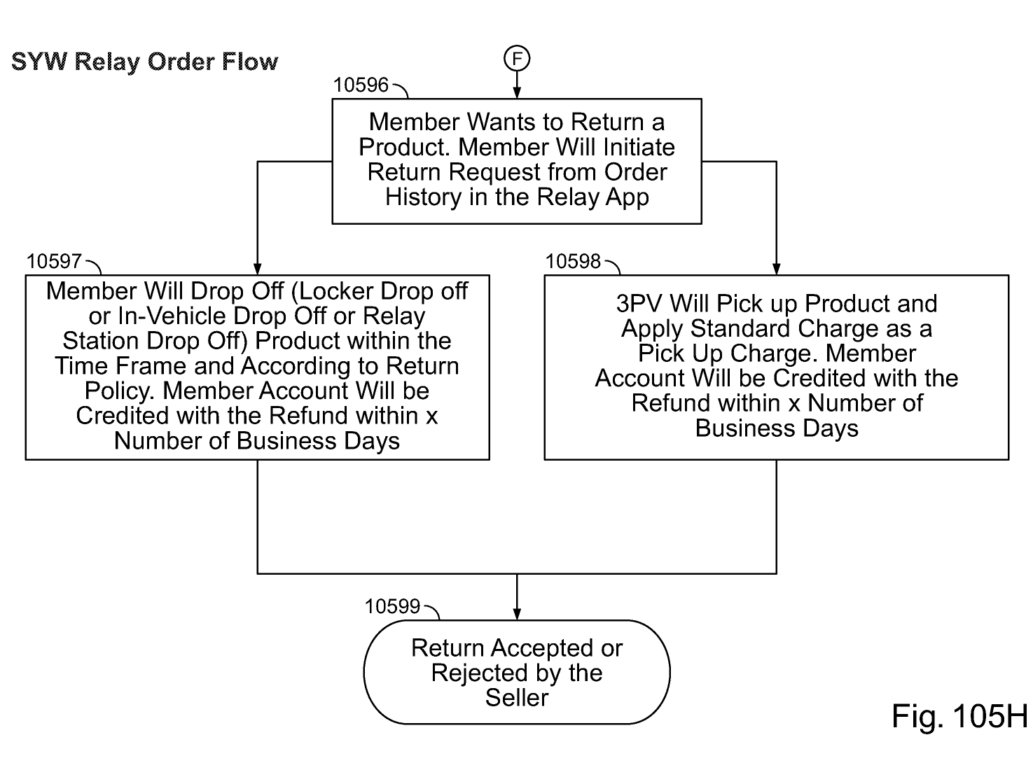

FIGS. 105A-105H are a flowchart 10500 of an exemplary method of operating a system such as, for example, elements of the computer network 100 of FIG. 1, to support crowd-sourced proxy shopping by consumers, in accordance with an example embodiment of the present disclosure. The method of FIGS. 105A-105H begins at block 10502, when a user logs in to a mobile application (e.g., Relay app) on a user communication device such as a device 20 of FIG. 1. Example login screens may be seen in FIGS. 7A, 7B, 7C, discussed above. Once logged in to the mobile application, the user may choose to access information for merchants at a nearby shopping mall, or access information for a previously accessed shopping mall (block 10504). An example device screen containing suitable user interface elements is shown in FIG. 8, discussed above. The user may then select a shopping mall (block 10506), as shown in the example of FIG. 9, previously discussed. The user may then choose (block 10508) to select a store in the selected shopping mall to browse (10510), or to search for a particular product from the set of all products carried by the merchants in the selected shopping mall (block 10512). In either case, the user may end up on a product page for a product of interest (block 10514). The user may then choose to add the product of interest to a shopping cart, and may provide a quantity to be purchased, various attributes of the product of interest (e.g., color, style, size), and how the product is to be delivered to the user (block 10518). Instead, the user may choose to add the product of interest to a list (block 10514), may choose a list to which to add the product of interest (e.g., a “wish list,” a “gift registry,” or other list) (block 10528) or may choose to create a new list and save the information on the product of interest there (block 10526). The user may also choose (block 10514) to share the details of the product of interest with family or friends or one of their social networks (block 10516). If the user chooses to add a product item to their shopping cart (block 10514), they may then choose to proceed towards checkout, by viewing their shopping cart (block 10520), and may make changes to product items, quantities, or product attributes (block 10522). The method of FIGS. 105A-105H may then continue at block 10530 of FIG. 105B.

FIG. 105B begins at block 10530, where the example system of the present disclosure determines whether the current user order has one or more products for delivery. If no products in the order are to be delivered, the method permits user checkout using a debit card, credit card, or any other suitable form of payment (block 10542). The user may then be offered the option to share their feelings about their purchase experience on social media, the system may record that the order for the current user was placed successfully (block 10546), and the user may be sent confirmation of placement of the order. Notice of order placement is then sent to the application running on the communication device of the individual managing the Relay Station (e.g., Relay Anchor app) (block 10548). Control of the system running the current method then passed to block 10550 of FIG. 105C.

If, however, at block 10530, it is determined that one or more products of the current order are products to be delivered, the method of FIG. 105B then determines whether the user has a pickup delivery address saved on the system (block 10532). If at least one saved delivery address is currently available for this user, the user may select a delivery address and time for delivery of the current order (block 10540). The method then permits the user to perform checkout of their order beginning at block 10542, as described above. If, however, it is determined that the user has no pickup delivery address saved on the system (block 10534), the user provides delivery information such as, for example, ZIP code. The user may be notified when the ZIP code provided is more than a certain distance away from the merchant location, and may be offered the chance to enter the ZIP code for an alternate delivery location (block 10538). If the user declines to provide an alternate delivery ZIP code, the system may allow pickup (block 10544), and the process continues at block 10542. If it is determined that delivery is available from the ZIP code provided by the user (block 10534), then the user may enter a new delivery address (block 10536), and the portion of the process shown in FIG. 105B continues at block 10540.

FIG. 105C begins at block 10550, where the user order is dispatched to a one of the runners of the present concept. The assignment/acceptance of the order to/by the user may be based on the availability and proximity of the runner to the merchant location(s) to be shopped for the user, and/or to the proximity of the runner to the Relay Station. The assigned runner then travels to the location of each merchant from which one or more products of the user order are supposedly available (block 10552). If the runner is able to find and purchase the product(s) requested by the user from this merchant, the method of FIGS. 105A-105H then continues at block 10560 of FIG. 105D. If, however, the runner is unable to find the product(s) requested by the user from this merchant (block 10554), the runner may initiate a substitution request (block 10556), and may send to the Relay app of the user via the system of the present disclosure, a substitution request with various details (e.g., photo, price, description, stocking vendor/merchant) of a potential substitute product for consideration by the user (10558). The method of FIGS. 105A-105H then continues at block 10570 of FIG. 105E.

FIG. 105D begins at 10560, where the runner drops off at the Relay Station, the products purchased for the order which they were assigned. If the user order is designated for pickup, the user may be sent a message (e.g., via email, text message, or other suitable means) indicating that the user's order is ready for pickup. The user may then pick up the completed order at the Relay Station (block 10566). If, however, the user order is designated for delivery to the user, the user may be sent a message (e.g., via email, text message, or other suitable means) indicating that the user's order is ready for delivery, and a delivery service may then pick up the user order and deliver it to the address selected by the user (block 10564).

Whether the order is picked up by the user, or delivered to the address selected by the user, at some later time, the user may decide that a product is unsatisfactory, and may desire to return or exchange a received product (block 10568). If the user wishes to exchange one or more products from their order, the process shown in FIGS. 105A-105H proceeds at block 10580 of FIG. 105F. If the user wises to return rather than exchange one or more products from their order, the process shown in FIGS. 105A-105H continues at block 10596 of FIG. 105H.

FIG. 105E begins at block 10570, where the user receives notification of a potential substitute product (e.g., via the Relay app), including information about the product proposed as a substitute for a product in their order that has been found to be unavailable. The notification of a potential substitute product may come in the form of, for example, a chat message from the runner to the user, in which the chat contains the details of the product being proposed as a substitute, or a link to a catalog page that provides product details and characteristics of the proposed substitute product. In accordance with an example of the present disclosure, an element of the system that communicates with the Relay app in the communication device of the user and the Runner app in the communication device of the runner may dynamically generate a product entry in a catalog listing the products normally stocked by the various merchants of the shopping mall selected by the user, and the user may be provided with a link to that product. If the user decides that the proposed substitute product is acceptable (block 10572), the user accepts the request to substitute a product (e.g., via the Relay app), and the runner may then purchase the substitute product as part of fulfilling the order for the user. The process then proceeds to block 10580 of FIG. 105F, described below. If, however, the user decides that the proposed substitute product is not acceptable (block 10572), the request to substitute a product may be rejected by the user (block 10574). In an example system according to the present disclosure, the runner may then search for another substitute product and send another request to substitute a product for the unavailable item from the user order. The user may, for each new proposed substitute product, receive details about the new substitute product proposed by the runner (block 10570). However, if the user rejects a certain number of proposed substitute products for a given product of the user order, the unavailable product may simply be cancelled from the order (block 10576).

FIG. 105F begins at block 10580, where the runner drops off the purchased products for the user order at the collection point (e.g., Relay Station), and the user order is confirmed by the person acting as the “Relay Anchor.” If the order was filled as placed by the user, the order is marked as having been placed successfully (block 10586), and is ready for pickup by the user or delivery to the user. If any substitutions have been made or items cancelled from the user order, the price of the order to the user may have changed from that shown in the shopping cart when the order was placed, and either a refund is made to the user (block 10582), or the difference in the price for the completed order is charged to the user (block 10584). In either case, the user order has been successfully placed, and the system marks it as such.

FIG. 105G begins at block 10590, where the method determines whether the user wishes to exchange a product item of their order for the same product item, but in a different size, style, type, color, or differences in other product attributes or characteristics. If the user wishes to stay with the same product item, the user, for example, be presented with a product entry in a catalog showing the product to be exchanged, and may select the desired product attribute or characteristic (e.g., preferred size, style, color, etc.) and complete the exchange transaction (block 10591). If, however, the user wishes to exchange a product for a different product item, the user may search a product catalog showing the various products available from one or more of the merchants at the shopping mall selected by the user, and may select a replacement or substitute product item in that manner, completing the exchange transaction (block 10592). If the price of the replacement/substitute product item selected by user is the as the product item requested by the user to be exchanged, the order for the exchange is complete, and the system marks the order as successfully placed (block 10595). If, however, the prices of the product being returned for exchange, and the newly selected product are different, the difference in prices is either refunded to the user (block 10593) or charged to the user (block 10594), and the product exchange is then considered by the system to be completed and the order is marked by the system as successfully placed.

FIG. 105H begins at block 10596, following receipt of a user request to return a product item from, for example, a previous product order (block 10568 of FIG. 105D). The user may submit such a request to return a product item using, for example, a mobile application such as the “Relay app” described above, and for which example mobile application screens are illustrated herein and discussed above. In some cases, the user may choose to drop off the product item to be return at, for example, a “drop locker,” or at a collection point such as the “Relay Station” previously described above (block 10597. In other cases, the user may choose to have a service pick up the product item(s) to be returned, and may incur a charge for that service (block 10598). In either case, the credit for the returned items may then be applied to the account of the user (e.g., credit card, debit card, merchant charge account, etc.), subject to the acceptance of the returned product item(s) by the merchant (block 10599).

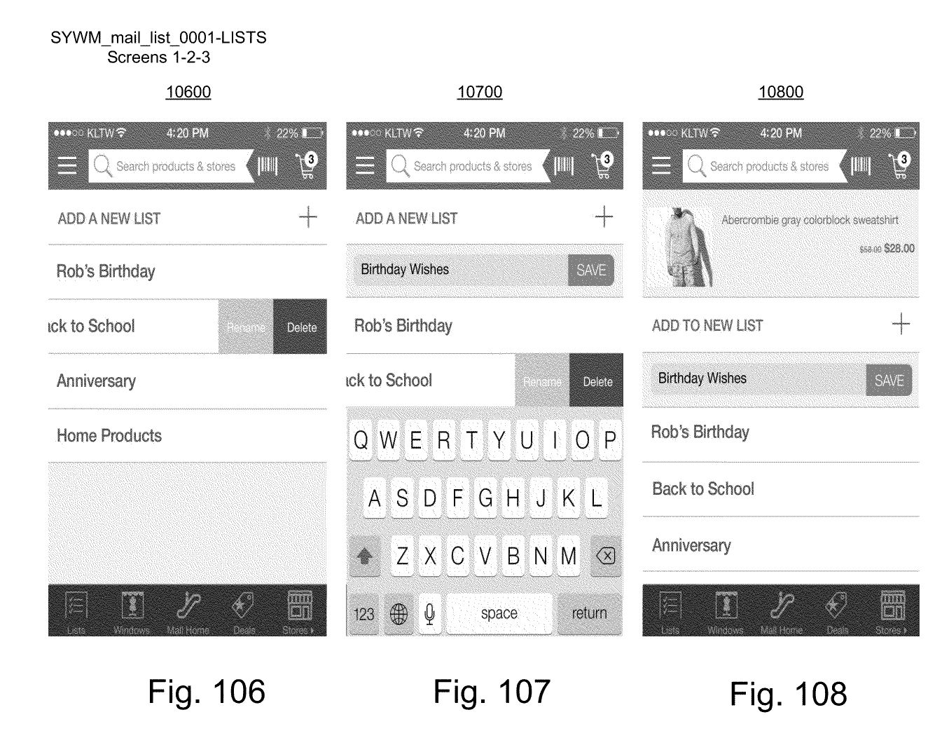

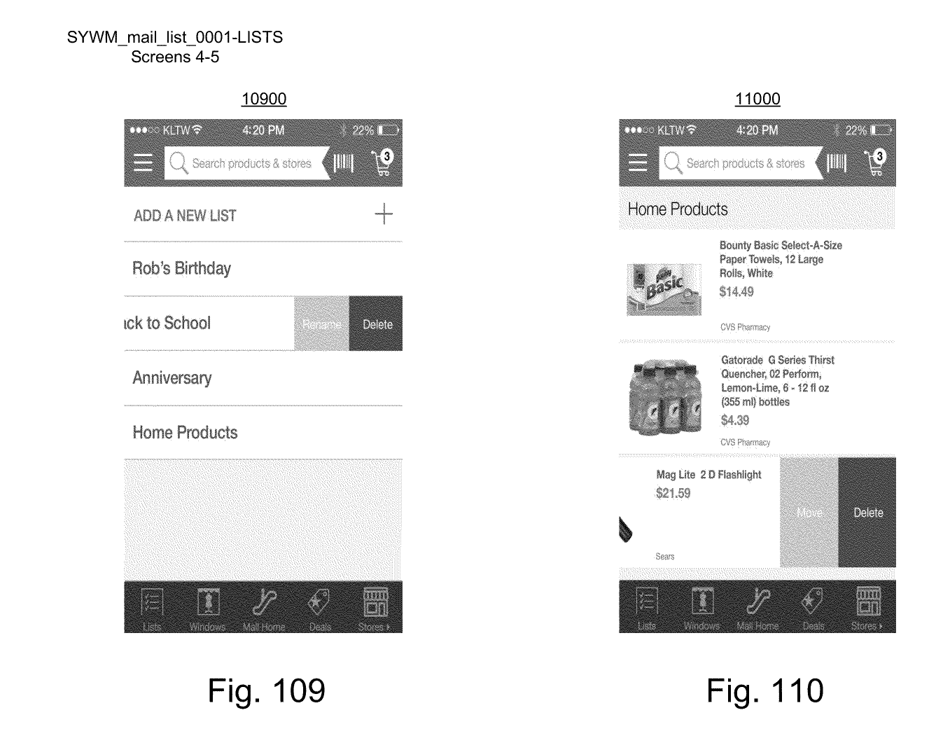

FIGS. 106-110 illustrate example mobile device screens 10600 to 11000 showing the use of “smart lists,” in accordance with an example embodiment of the present disclosure.

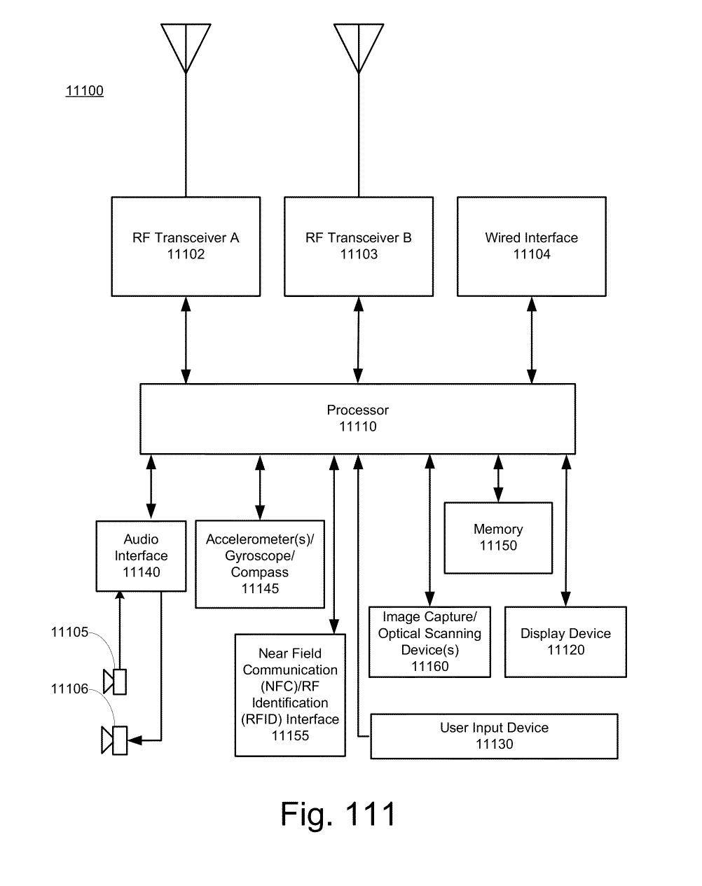

FIG. 111 is a block diagram illustrating a personal electronic device 11100 that may correspond to, for example, the electronic devices 20′, 20′, 20″ shown in FIG. 1, in accordance with an example embodiment of the present disclosure. The personal electronic device 11100 may correspond to electronic user devices such as, by way of example and not limitation, a smart phone, a tablet computer, a cellular phone, a media player, a handheld personal computer, a laptop, a notebook computer, a net book computer, a desktop computer, a television, or any other suitable electronic device having the functionality discussed herein.

As shown in FIG. 111, the personal electronic device 11100 includes a processor 11110, an RF transceiver A 11102, an RF transceiver B 11103, a wired interface 11104, a display device 11120, a user input device 11130, an audio interface 11140, one or more accelerometers, gyroscopes, or compasses 11145, a memory 11150, near field communication (NFC)/radio frequency identification (RFID) interface 11155, and an image capture/optical scanning device 11160. The processor 11110 may be, for example, a suitable microprocessor or microcomputer having sufficient computing power to control the personal electronic device 11100, and is operably coupled to the RF transceiver A 11102, the RF transceiver B 11103, and the wired interface 11104. The RF transceiver A 11102 and RF transceiver B 11103 may comprise any necessary circuitry, logic, and software/firmware for wireless communication using any of, for example, the cellular, Bluetooth, Wi-Fi (e.g., IEEE 802.11 a/b/g/n/ac), Zigbee, WiMAX, Near Field Communication (NFC), radio frequency identifier (RFID), or any other wireless network air interface standard known now or in the future. The wired interface 11104 may comprise any necessary circuitry, logic, and software/firmware for wired communication over any of, for example, an Ethernet, Universal Serial Bus, FireWire (IEEE 1394) or other wired networks known now or in the future.

The processor 11110 is also operably coupled to the memory 11150, which may be used for non-transitory storage of executable program instructions, parameters, and data for management and control of any of the circuitry of the personal electronic device 11100. The processor 11110 is also operably coupled to the display device 11120, which may comprise, for example, one or more LED, OLED, LCD, or other suitable form of visual display capable of presenting text and/or graphics, and may comprise any circuitry, logic, or software/firmware to support, for example, a graphical user interface (GUI). The processor 11110 is operably coupled to the user input device 11130, which may comprise, for example, suitable switches, buttons, or touch sensitive surfaces to enable user control and operation of the personal electronic device 11100, and may comprise any necessary circuitry, logic, and software/firmware to allow the user input device 11130 to perform those functions. In an example embodiment of the present invention, the user input device 11130 may, for example, be include a touch sensitive surface at the viewing side of the display device 11120, enabling a user to use the touch sensitive surface of the display device to enter user inputs and respond to information displayed on the display device 11120.

The processor 11110 is also operably coupled to the audio interface 11140, which comprises any necessary circuitry, logic, and software to interface a microphone 11105 and a speaker 11106 to the processor 11110. In some example embodiments of the present invention, the processor 11110 may be operably coupled to a NFC/RFID interface 11155 that may be used to communicate with, by way of example and not limitation, NFC/RFID-enabled electronic shelf labels (ESLs), credit and identification cards and badges, tags, keychain fobs, and any other devices having NFC and/or RFID communication capability. In addition, the processor 11110 is operably coupled to an image capture/optical scanning device 11160 that may include, by way of example and not limitation, a monochrome or color digital imaging device, a digital camera, an infrared receiver, and/or a scanner capable of detecting light signals example of bar codes (e.g., UPC), two-dimensional codes (e.g., a QR code), images, or other forms of optical information known now or in the future.

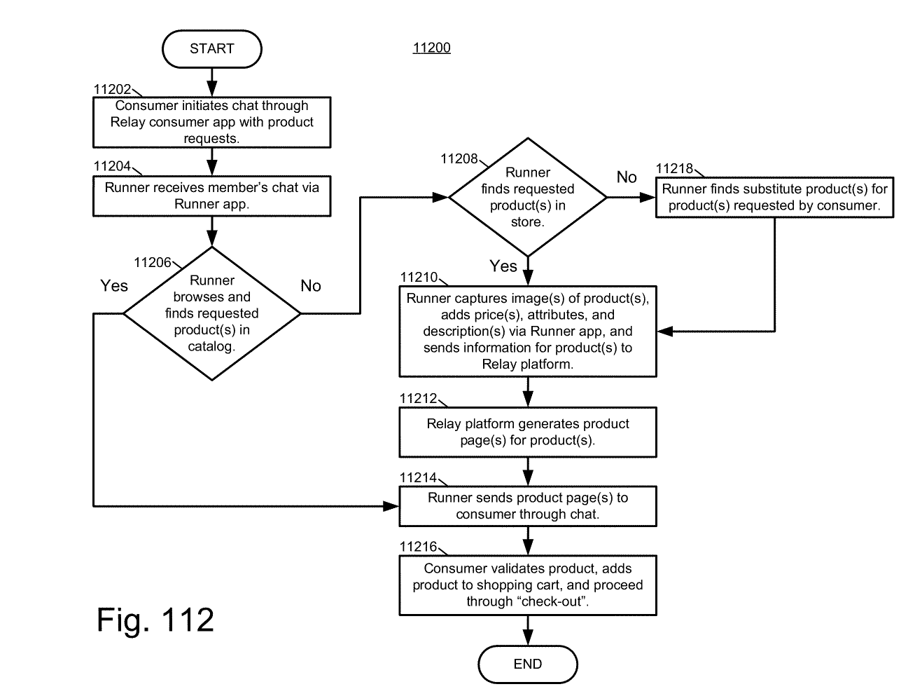

FIG. 112 is a flow diagram 11200 illustrating an example process in which a runner, seeking a product requested by a consumer, cannot locate the requested product and suggests a product substitution, in accordance with an example of the present disclosure. The example illustration of FIG. 112 and the following discussion provide additional detail of the actions that may be involved in a product substitution such as, for example, the actions of the product substitution described above with respect to FIG. 105. The actions described here regarding the example flow diagram of FIG. 112 begin at block 11202, where a consumer (e.g., user, member) initiates communication (e.g., a “chat”) with a runner using, for example, a mobile application such as the Relay app described above. Such a mobile application may be installed on a communication device of the user such as that shown and described herein with respect to FIG. 111, by the user. Example user interface screen of a suitable “Relay app” are shown and described herein. To communicate with the user(s) of the system, each runner may use a communication device similar to or greater than the capabilities of the communication device of the user(s), and a mobile application may be installed on the communication device of the runner(s) such as, for example, the Runner app described above, example user interface screens of which are described herein. The communication device(s) of a plurality of consumer users of the system described herein may communicate with a plurality of runners via a computer system platform configured to support communication between the users and runners, and access to a catalog of product items normally stocked by and sold by a plurality of separate merchants of a shopping mall.

Next, at block 11204, a runner receives the communication (e.g., the “chat”) from the user via the Runner app running on the communication device of the runner. Using the information about the product(s) requested by the user and contained in the communication from the user, the runner may then browse a catalog of product items available from the various merchants of the “shopping mall” selected by the user, to find a merchant that has each product item (block 11206). Such a product catalog contains a product entry for each product normally stocked by each of the various merchants in the “shopping mall,” where the product entry provides information about the product such as, for example, an image or photo of the product item, the price of the product item, a description of the product item, and any attributes, characteristics, or features of the product item, including an identifier that uniquely identifies the product item in the product catalog and is associated with the merchant that carries that product item.

If the runner finds the requested product item(s) in the product catalog of the present system (block 11206), the runner may then make the user aware of that product page of the product catalog, via the communication (e.g., “chat”) capabilities of the system platform of the present disclosure (block 11214), as described below. If the requested product item(s) are not found in the catalog maintained by the present system (block 11206), the runner then searches to find the requested products in the stores of, for example, the various merchants whose products are represented in the product catalog, and any other stores or merchants in the surrounding area that are not participants in the system of the present disclosure and whose product inventory is not represented in the product catalog of the present system (block 11208). The runner may find the product item(s) requested by the user in a merchant store that is a participant in the product catalog of the present disclosure but is not yet listed, or may find the requested product item(s) in another merchant store that is not a participant in the product catalog. Further, the runner may not find the product item(s) requested by the user in any merchant store, but the runner may find one or more substitute products that the user may find acceptable (block 11218). In either case, the runner may then use a mobile application (e.g., the “Runner app”) located on their communication device to capture an image of the requested or substitute product, along with price information for the product and product attributes and characteristics (e.g., style, size, color, and merchant identity) and to send the entire collection of information for the product item(s) to the system platform described above (block 11210). The system platform according to the present disclosure then takes the product information for each of the product item(s), received from the runner via the mobile application (e.g., Runner app) on the communication device of the runner, dynamically generates uniquely identified product entries (e.g., product pages) for each of the product items discovered during the runner search for the products requested by the consumer user, and adds those dynamically generated product entries (e.g., product pages) to the product catalog maintained by the system (block 11212). In an example embodiment of the present disclosure, such a dynamically generated product catalog entry may, for example, be linked to the merchant from which the product item(s) of interest is/are available, and the user from which the request for the product item(s) originated. In a system according to the present disclosure, the system may control access to such dynamically generated product entries, so that only the user for which the corresponding products were searched and the product entries added, may access the product entries in the catalog. The runner may then send information to the user to enable the user that originally placed the product request to then access and review the newly added product information for the product items just located by the runner. The process of FIG. 112 then continues at block 11214.

At block 11214, runner may communicate a link to or information identifying the product page(s) of product item(s) that match or are potential substitutes for the products requested by the user, using the communication capabilities (e.g. “chat”) of the mobile application (e.g., “Relay app”) on the communication device of the user. The user may then use review the dynamically generated product entries in the product catalog, which were identified by the runner, to decide whether the respective product items match what they are looking for, and if found satisfactory and validated by the user, the user may add the product item(s) to their shopping cart; proceed through “check-out” using, for example, a traditional shopping cart model; and purchase the requested and substitute product items for delivery or pickup (block 11216).

The following provides additional details of an example mechanism of providing substitute products in a product order and fulfillment system in accordance with the present disclosure. In an example embodiment of the present disclosure, a consumer/user may login to a mobile application on their communication device (e.g., Relay app) using a unique identifier (e.g. email or other suitable address) and a security token, key, or password. The system platform of the present disclosure (e.g., “Relay platform”) may generate a unique local “session key” that maps the user identifier (e.g., email address) with the “session key,” which is then stored in a database (e.g., a “mysql” database). All further communication between user mobile application (e.g., “Relay app”), the runner mobile application (e.g., “Runner app”), and the system platform of the present disclosure (e.g., “Relay platform”) may, for security purposes, use this unique “session key” to communicate. The runner may log into the Runner app using a unique identifier (e.g., a unique email address) and a security token, key or password. The Relay platform may then create a new local “session key” for this runner. The runner and user will then be treated separately in the present system, each with unique “session keys/identifiers” for the duration they are logged in to the system.

In an example system according to the present disclosure, a user may discover (e.g., via browse/search) the product s/he wants to purchase and use an in-app checkout of the user mobile application (e.g., Relay app) process to place an order. Such order information may then be sent to the system platform (e.g., Relay platform) and a unique order identifier along with unique order item identifier may be created and stored (e.g., in a database such as “mysql”) to track and to manage the user order. Each order product item in the user order will have a unique identifier generated, but the order identifier may be held the same. In this way, a single order may have a number of order item identifiers associated in the database. The system platform (e.g., Relay platform) may then broadcast the newly created order with order details to the Runner app.

In an example system according to the present disclosure, the runner may be alerted by the Runner app about the newly created order, and the runner can review and claim the order for them to process. The runner may then visit the retailer store that carries the product item to procure the product item for the user. If, however, the runner could not find the requested product item, may instead find a similar product that can be suggested to the user. The runner may then initiate a substitution flow, as described above, and suggest one or more substitution product(s). The runner takes a picture of the product, inputs the product item price, provides a description, and sends the info to the system platform (e.g., “Relay platform”).

In an example of the present disclosure, a number of actions may be performed before surfacing the product item(s) to the user. The photo taken by the runner is uploaded and saved in an image repository, and a Universal Resource Locator (URL) for the uploaded image is saved in storage (e.g., a database such as “Mongo”) along with the price and description of the product. The runner then places that information in a document (e.g., a “chat”) with a unique message identifier (e.g., a “chart ID”).

In an example system of the present disclosure, a new product is created and a unique product identifier (e.g. a stock keeping unit (SKU), item number, product code, or other suitable identifier) is allocated for this new product along with a product image, product price, and product description the runner added. This new product information is added to an existing catalog of the products available from merchants. In an example of the present disclosure, such a new product may be flagged as a “runner created product” and may only be visible to and available for selection by the user/consumer for whom the product entry was created. The originally ordered item identifier may be mapped to the product item identifier for the substitution product item for reference purposes.

In an example system of the present disclosure, a user may receive an alert in the mobile application (e.g., Relay app) that a substitute product has been suggested by the runner. The user can review the original product purchased along with the substitute product suggested by runner, review the product details and can accept or reject the substitute product. Access to the substitute and original product information may be enabled using a product view application program interface (API) that uses a unique product identifier (e.g., stock keeping unit (SKU), item number, or other suitable identifier) that was created during a runner substitute product creation process. The user may be asked to approve any difference in price if the suggested (i.e., substitute) product is higher in price that the original product selected by the user, and may receive a refund if the suggested (i.e., substitute) product price is lower. In some examples of the present disclosure, the product entry created in the product catalog will not be permitted to be displayed to any other user than the user for which the substitute product was created. This may be achieved in the following manner.

In an example of the present disclosure, the entire catalog of stores and products may be periodically (e.g., on a daily basis) indexed in a search engine from the catalog database (e.g., the Mongo database mentioned above). The browse and search functionality discussed above may be served from a such a search engine, which may be the entry point for a product purchase flow employed in serving the user during product search, browse and purchase. Runner created products may be flagged separately in the product catalog as soon as the product entry is created by the runner. Such flagged product identifiers (e.g., SKU, product number, etc.) may be skipped and not be included in the periodic search engine indexing of the catalog of stores and products, so that such entries do not display to other users (e.g., customers) and make such product entries available for purchase. In this manner, substitute products are maintained in a one to one relationship with the user/consumer to which the substitute product has been suggested.

In an example of the present disclosure, the runner then fulfills the user order and marks the order for pick-up or delivery. The order history maintained by the system of the present disclosure then shows the new product as approved by the user as the purchased product, and the order history shows the status as picked up or delivered. If the user rejects the substitution product suggested by the runner, the order history shows the item as ‘Rejected’ and the product will not be purchased by the runner for the user order.

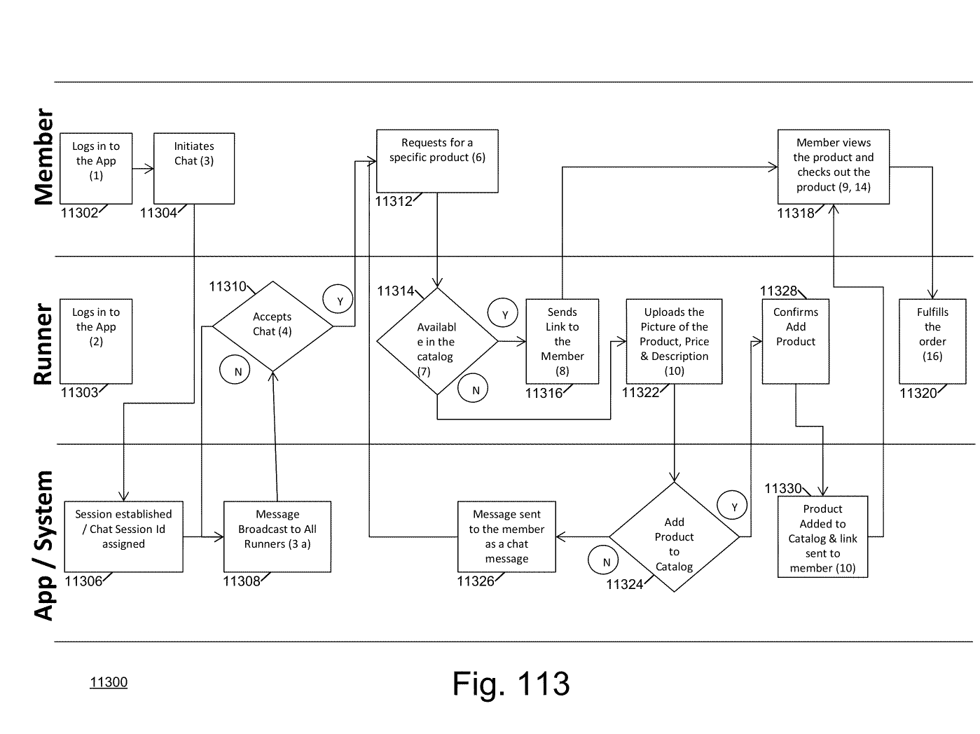

FIG. 113 is a flow diagram 11300 illustrating an example process including the dynamic generation of a product entry for a product suggested by a runner as a substitute for a product requested by a consumer via a messaging (e.g., chat) session, in accordance with an example of the present disclosure. The process example of FIG. 13 begins at block 11302, where the user logs in to the mobile application (e.g., Relay app) using a unique user identifier (user ID) such as, for example, an email identifier and a password or other security item (e.g., token, passphrase, etc.). The system platform then generates a unique session identifier (session ID) that associates the user ID with this session ID. All further communication between the elements of the system (e.g., the user mobile application and the system platform) will use this unique session ID in communications. At some point, the runner logs into the runner mobile application (e.g., Runner app) using a unique runner identifier such as, for example, an email identifier and corresponding password or other security item such as those mentioned above (block 11303). In this manner, the user and runner will be treated separately in the system with unique session IDs for the duration they are logged in to their respective mobile applications.

At some later point in time, the user initiates communication (e.g., a “chat”) with the system (block 11304) by, for example, typing a message in a “chat” window of the user application (e.g., Relay app). This new “chat” is saved in a system database (e.g., the Mongo database described above) along with a message identifier and a chat identifier. The user initiating the chat will be identified using the session ID of that user. The chat message is then broadcast to all of the runners of the system (block 11308). Until the chat message is accepted by a runner, the system may periodically broadcast the pending chat to the runners of the system, and at some later point in time a runner may accept the chat of the user (block 11310), and the chat broadcast to all of the runners will be removed from display by the mobile application(s) (e.g., Runner app) of those runners other than the runner that accepted the user chat. A chat receiver entry may be added for the chat message accepted by the runner, and a runner session ID may be associated with the chat. A unique communication session is then established between the user and the runner that accepted the user chat, the user chat message is saved in the system platform storage (e.g., the Mongo database described above) as part of conversation documents, and each message is assigned a unique message identifier.

In the example of FIG. 13 now being discussed, the chat message of the user may request a specific product, including the name of the product (e.g., a brand name, a model, a designer, a manufacturer); the style; the color; a price or price range; and any other attributes or characteristic of the desired product (block 11312). The runner may then check whether the requested product is available in the product catalog maintained by the system of the present disclosure (block 11314). If the runner finds that the requested product is available, the runner then sends a link for the product entry (e.g., product page) to the user (block 11316), and the user review the product information (block 11318). If, however, the requested product is not available in the product catalog, then the runner searches nearby stores and other product sources for the requested product or any potential substitute products, and uploads a picture, price, and description for each such substitute product for communication to the user in a response chat (block 11322). Such runner-provided product content is then sent to the system platform (e.g., Relay platform) and a number of actions are performed to permit the communication of the information for the substitute product to the user. For example, any photo(s) of the substitute product(s) uploaded by the runner are saved in an image repository (e.g., system platform storage such as a database) using a multipart file upload, and a URL of the uploaded image may be saved in system platform storage (e.g. a database) along with any price and description information for the suggested substitute product. A determination is then made (e.g., by prompting the runner) whether the suggested substitute product is to be added to the product catalog maintained by the system platform (block 11324). If the product is not to be added to the product catalog (block 11324), the information about the substitute product is then used to produce a message document for the user (e.g., a chat), which is assigned a unique message ID (e.g., chat ID), and the message is sent to the user (block 11326). If, however, the system determines that the product found by the runner is to be added to the product catalog (block 11328), a new product catalog entry may be dynamically created for the substitute product and associated with a unique identifier (e.g., SKU, item number, or other suitable unique identifier) allocated to this substitute product along with the product image, price, product description that the runner provided, and this new catalog entry may be added to the existing product catalog of the system platform. A link to the newly added product entry may then be used in a message sent to the user (block 11330). In an example system of the present disclosure, this new product may be flagged as a runner-created product, and may only be accessible to, visible to, and available for purchase by the member for which the product entry was created. The message sent to the user may be created using the runner application (e.g., Runner app) to include the details of the substitute product identifier (e.g., SKU, product number, etc.), the URL for the product photo or image, the product, price, and the product title and/or description. Once the message (e.g., chat) from the runner is received by the user, the user may then view the substitute product image, price, etc. on the screen of their communication device using the installed mobile application (e.g., Relay app) (block 11318). For example, in one example according to the present disclosure, the user may tap the product image received in the chat that is shown on the screen of their communication device, and the mobile application may take the user to a product view for the specific runner-created product entry for the substitute product in the product catalog of the system. The product view API used to display the substitute product entry may use the unique product identifier (e.g., SKU, product number, etc.) that was created during the runner product creation flow, described above. The user may then add the substitute product to their shopping cart from the product page displayed on their mobile communication device, making the substitute product a part of the order of the user, and the user can then purchase the substitute product as a part of their order by simply proceeding through checkout in the normal fashion. It should be noted that in some example embodiments of the present disclosure, the substitute product will not be accessible to anyone but the user for which it was added to the product catalog. Although an embodiment according to the present disclosure may periodically index the entire product catalog containing products for all participating merchants, the product entries created based on product information submitted by runners may be marked or flagged at the time of creation/generation of the product entry in the product catalog. Such marked/flagged products entries may be skipped during the indexing of the product catalog so that such product entries do not display during searches, and are therefore not accessible for purchase by users other than the user for which the product item was suggested. The runner then fulfills the user order, and the customer order history will show product details for all products in the order, including the substitute product added by the runner, because any substitute product(s) are linked to the order and the user that requested and approved them.

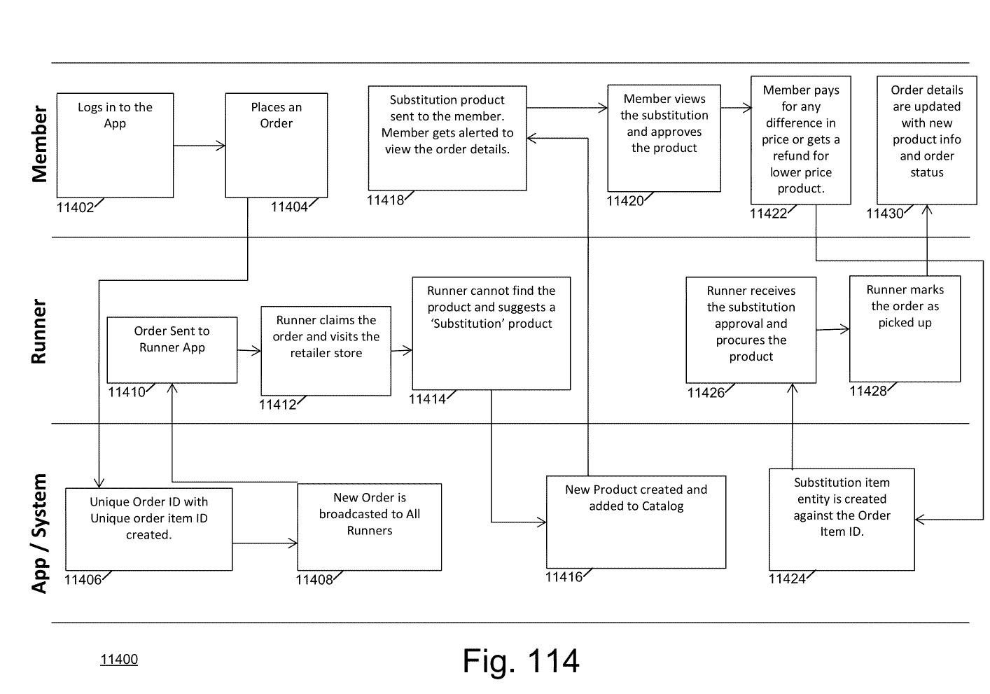

FIG. 114 shows a flow diagram 11400 illustrating an example process including the dynamic generation of a product entry for a product suggested by a runner as a substitute for a product ordered by a user via a mobile application on the communication device of the user, in accordance with an example of the present disclosure. The process example of FIG. 14 begins at block 11402, where the user logs in to the mobile application (e.g., Relay app) using, for example, a unique user identifier (user ID) such as, for example, an email identifier and a password or other security item (e.g., token, passphrase, etc.). Next, the user browses the products offered by the various merchants of a product catalog such as that described herein, makes their product selections, and places an order of one or more product items, using the mobile application on their communication device (block 11404). The system of the present disclosure then assigns a unique order ID for the order, and builds the order using the unique identifiers assigned to each of the product items selected by the user (block 11406). The newly created order is then broadcast to all of the runners currently accessible to the system (block 11408), which is then received by the mobile application on the communication devices of the accessible runners (block 11410). At some point, one of the accessible runners claims (e.g., accepts) the user order, and begins visiting the merchant(s) listed for each of the product items listed on the user order (block 11412).

In the example of FIG. 114, the runner finds that they are unable to locate a particular product item of the user order at the indicated merchant, but is able to locate an alternative product that may be acceptable to the user (block 11414). The runner then submits information about the alternative product to the system, which dynamically creates a new product entry in the product catalog of the present system, in a manner similar to the product substitution process described above with regard to FIG. 113 (block 11416). The system then notifies the user to alert the user to the lack of availability of a product item of their order, and the availability of a newly created product entry for a substitute product for an alternative product item being suggested by the runner (block 11418). The user may then view the details of the alternative or substitute product, and may approve the inclusion of the substitute product in filling their order (block 11420). The total price for the user order may be adjusted, based on any difference in price of the originally ordered product item and the substitute product item, and a refund may be issued or the user may be charged, as needed (block 11422). In an example according to the present disclosure, a substitution item entity may be created against the order item identifier (block 11424). The runner may then receive approval to substitute the alternative product item for the product item originally ordered by the user, and purchases the available substitute product item (block 11426). The runner then marks the user order as having all items picked up (block 11428), and may deliver the completed order to the collection point (e.g., Relay Station) for pickup by, or delivery to the user. A system record of the details of the user order is then updated with the information identifying the substitution of the alternative product and the overall order status (block 11430).

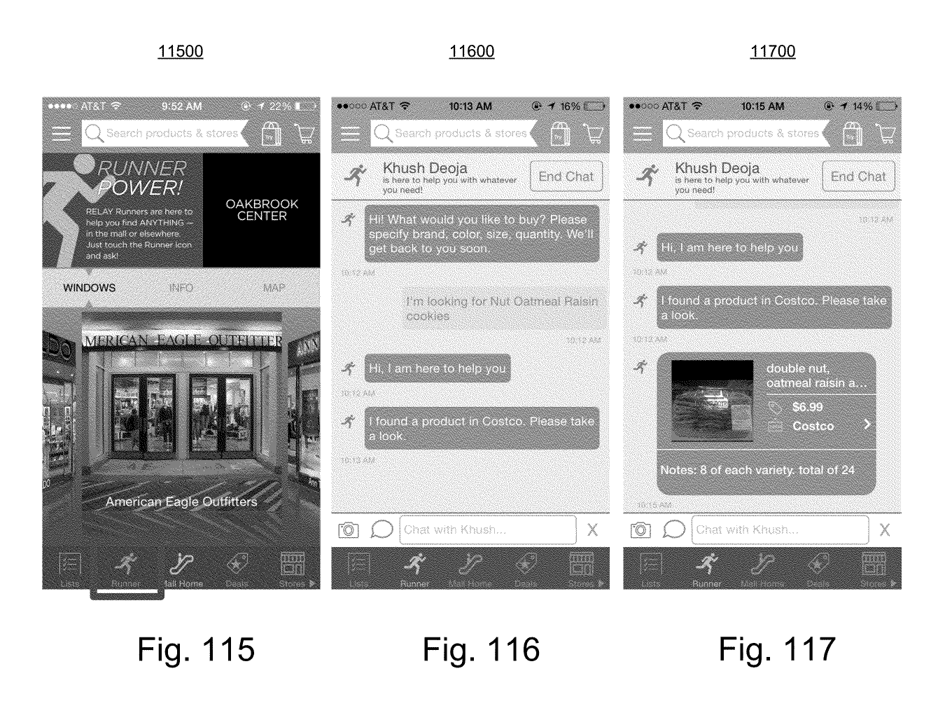

FIG. 115 is an illustration of an example screen 11500 showing a list of merchant stores in the local shopping mall selected by the consumer as displayed by a mobile application on a user communication device, in accordance with an example embodiment of the present disclosure. The example screen 11500 may be displayed on the screen of a user device by a mobile application such as, for example, the “Relay app” described herein. The example of FIG. 11500 shows an image of a store front of one of the merchants participating in the system of the preset disclosure, and a box highlights a tab control that permits the user to request a chat session with a runner, to allow the user to identify a product item that the user would like to find.

FIG. 116 is an illustration of an example screen 11600 showing a chat exchange between the user and a runner that has responded to a request for a chat session, in accordance with an example embodiment of the present disclosure. The example screen 11600 identifies the runner that has responded to the user request, and the sequence of runner and user messages that have been exchanged. The screen 11600 also includes an “End Chat” button to permit the user to terminate the chat session with the runner.

FIG. 117 is an illustration of an example screen 11700 showing a chat exchange between a user and a runner as displayed by a mobile application on a user communication device, in which the runner has suggested a substitute product item for an item requested by the user, in accordance with an example embodiment of the present disclosure. As shown in the illustration of FIG. 117, the runner has located what the runner is suggesting is a similar product that may be of interest to the user. The product suggestion includes an image of the substitute product, the product quantity as packaged, the package price, and a brief description of the suggested substitute product. In an example embodiment of the present disclosure, the display on which user interface screen 11700 is shown may be touch sensitive, and the user may tap the portion of the display containing the product information to indicate their interest in responding to the product suggestion of the runner.

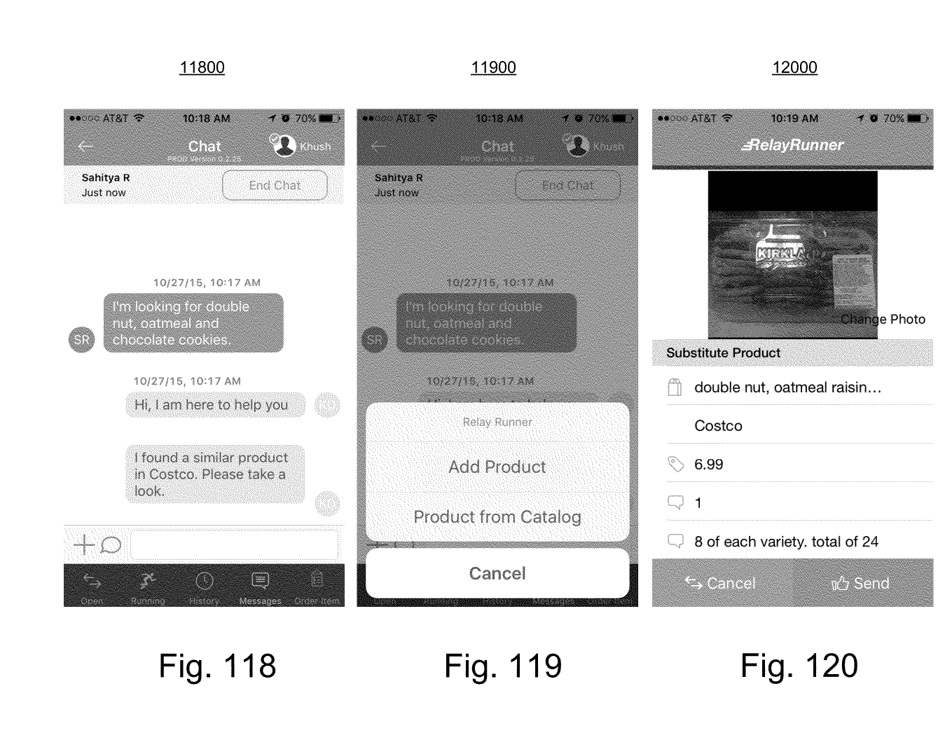

FIG. 118 is an illustration of an example screen 11800 showing a chat exchange between user and a runner as displayed by a mobile application on a runner communication device, in which the runner indicates that they have found a possible substitute product suggestion in a retail merchant, in accordance with an example embodiment of the present disclosure.

FIG. 119 is an illustration of an example screen 11900 showing a pop-up window as might be displayed by a mobile application of a runner communication device, in which the application provides options for adding a product that the runner found in a product catalog, or in a retail store, in accordance with an example embodiment of the present disclosure. The runner may choose to select an “Add Product” button to capture an image of a suitable substitute product captured in a retail store and related details (e.g., price, package quantity, size, color, style, maker, merchant, etc.), or may select a “Product from Catalog” to permit the runner to browse one or more product catalogs (e.g., the product catalog of the present disclosure, or from another suitable online source) to search for a suitable product that meets the user request.

FIG. 120 is an illustration of an example screen 12000 showing the information that may be displayed by a mobile application on a communication device of a runner, for a product item for potential suggestion by the runner as a product requested by a user, in accordance with an example embodiment of the present disclosure. The screen 12000 may be displayed, for example, when the runner using the runner application chooses the “App Product” options shown in FIG. 119. The runner may be walked through a sequence of capturing a photo of the product using an integrated camera of the runner communication device, and may manually enter the textual information describing the product, the product price, and various other attributes or characteristics of the product item to be submitted to the system as a suggestion to a user.

Aspects of the present disclosure may be seen in a method of operating a system supporting crowd-sourced proxy shopping. Such a method may comprise providing an on-line product catalog. The on-line catalog may comprise a plurality of product entries, where each product entry has a unique product identifier and comprises product information representing a product offered for sale by a respective merchant of a plurality of participating merchants. The product information may comprise product characteristics and product pricing information for the plurality of products, and the product information may be displayable using a communication device of each of a first plurality of users. The method may also comprise receiving, from a communication device of a first user of the first plurality of users, a request to provide to the first user, one or more products for purchase by the first user; and sending, to a communication device of each of a second plurality of users, a notification of the request by the first user. The method may further comprise receiving, from the communication device of a second user of the second plurality of users, an indication of acceptance of the request to provide the one or more products for purchase by the first user. The method may also comprise receiving, from the communication device of the second user, product information representing an alternative product not represented by a product entry in the product catalog, the product information for the alternative product submitted by the second user as a substitute product for a particular product of the one or more products for purchase by the first user. The method may comprise dynamically generating a new product entry in the product catalog for the alternative product, the new product entry having a unique product identifier associated with the alternative product and the particular product; and in response to a request by the first user, adding the alternative product to an electronic shopping cart of the first user. The method may comprise processing the product items of the shopping cart as a purchase of the first user for delivery to or pickup by the first user.

In example embodiments of the present disclosure, the new product entry in the product catalog may be accessible only to the first user, and the new product entry in the product catalog may be accessible to all of the first plurality of users. The plurality of participating merchants may be independent of one another, and the product information of each product entry of the product catalog may comprise a product image, a product price, a product title, and a product description. The first user and the second user may be enabled to communicate during fulfillment of the order of the first user; and the product information representing the alternative product may comprise a product image, a product price, a product title, and a product description, and may be captured using a communication device of the second user.

Additional aspects of the present disclosure may be seen in a non-transitory computer-readable medium having stored thereon a plurality of code sections, where each code section comprises a plurality of instructions executable by at least one process, and where execution of the instructions performs the actions of a method of operating a system supporting crowd-sourced proxy shopping, such as the method described above.

Further aspects of the present disclosure may be found in a system supporting crowd-sourced proxy shopping. Such a system may comprise at least one processor configured to communicate with communication devices of a first plurality of users, communication devices of a second plurality of users, and to provide on-line access to a product catalog comprising a plurality of product entries. Each product entry may have a unique product identifier and may comprise product information representing a product offered for sale by a respective merchant of a plurality of participating merchants. The product information may comprise product characteristics and product pricing information for the plurality of products, where the product information may be displayable using a communication device of each of a first plurality of users. The at least one processor may be operable to perform the actions of a method of operating a system supporting crowd-sourced proxy shopping, such as the method described above.

Accordingly, aspects of the disclosure may be realized in hardware, software, firmware or a combination thereof. The present disclosure may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present disclosure may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present disclosure may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present disclosure.

While the disclosure has described certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiments disclosed, but that the present disclosure will include all embodiments falling within the scope of the appended claims.

What is claimed is:

1. A method of operating a system supporting crowd-sourced proxy shopping, the method comprising:
providing an on-line product catalog comprising a plurality of product entries, each product entry having a unique product identifier and comprising product information representing a product offered for sale by a respective merchant of a plurality of participating merchants, the product information comprising product characteristics and product pricing information for the plurality of products, wherein the product information is displayable using a communication device of each of a first plurality of users;
receiving, from a communication device of a first user of the first plurality of users, a request to provide to the first user, one or more products for purchase by the first user;
sending, to a communication device of each of a second plurality of users, a notification of the request by the first user;
receiving, from the communication device of a second user of the second plurality of users, an indication of acceptance of the request to provide the one or more products for purchase by the first user;
receiving, from the communication device of the second user, product information representing an alternative product not represented by a product entry in the product catalog, the product information for the alternative product submitted by the second user as a substitute product for a particular product of the one or more products for purchase by the first user;
dynamically generating a new product entry in the product catalog for the alternative product, the new product entry having a unique product identifier associated with the alternative product and the particular product;
in response to a request by the first user, adding the alternative product to an electronic shopping cart of the first user; and
processing the product items of the shopping cart as a purchase of the first user for delivery to or pickup by the first user.

2. The method according to claim 1, wherein the new product entry in the product catalog is accessible only to the first user.

3. The method according to claim 1, wherein the new product entry in the product catalog is accessible to all of the first plurality of users.

4. The method according to claim 1, wherein the plurality of participating merchants are independent of one another.

5. The method according to claim 1, wherein the product information of each product entry of the product catalog comprises a product image, a product price, a product title, and a product description.

6. The method according to claim 1, wherein the first user and the second user are enabled to communicate during fulfillment of the order of the first user.

7. The method according to claim 1, wherein the product information representing the alternative product comprises a product image, a product price, a product title, and a product description, and is captured using a communication device of the second user.

8. A non-transitory computer-readable medium having stored thereon a plurality of code sections, each code section comprising a plurality of instructions executable by at least one process, wherein execution of the instructions performs the actions of a method of operating a system supporting crowd-sourced proxy shopping, the actions comprising:
providing an on-line product catalog comprising a plurality of product entries, each product entry having a unique product identifier and comprising product information representing a product offered for sale by a respective merchant of a plurality of participating merchants, the product information comprising product characteristics and product pricing information for the plurality of products, wherein the product information is displayable using a communication device of each of a first plurality of users;
receiving, from a communication device of a first user of the first plurality of users, a request to provide to the first user, one or more products for purchase by the first user;
sending, to a communication device of each of a second plurality of users, a notification of the request by the first user;
receiving, from the communication device of a second user of the second plurality of users, an indication of acceptance of the request to provide the one or more products for purchase by the first user;
receiving, from the communication device of the second user, product information representing an alternative product not represented by a product entry in the product catalog, the product information for the alternative product submitted by the second user as a substitute product for a particular product of the one or more products for purchase by the first user;
dynamically generating a new product entry in the product catalog for the alternative product, the new product entry having a unique product identifier associated with the alternative product and the particular product;
in response to a request by the first user, adding the alternative product to an electronic shopping cart of the first user; and
processing the product items of the shopping cart as a purchase of the first user for delivery to or pickup by the first user.

9. The non-transitory computer-readable medium according to claim 8, wherein the new product entry in the product catalog is accessible only to the first user.

10. The non-transitory computer-readable medium according to claim 8, wherein the new product entry in the product catalog is accessible to all of the first plurality of users.

11. The non-transitory computer-readable medium according to claim 8, wherein the plurality of participating merchants are independent of one another.

12. The non-transitory computer-readable medium according to claim 8, wherein the product information of each product entry of the product catalog comprises a product image, a product price, a product title, and a product description.

13. The non-transitory computer-readable medium according to claim 8, wherein the first user and the second user are enabled to communicate during fulfillment of the order of the first user.

14. The non-transitory computer-readable medium according to claim 8, wherein the product information representing the alternative product comprises a product image, a product price, a product title, and a product description, and is captured using a communication device of the second user.

15. A system supporting crowd-sourced proxy shopping, the system comprising:
at least one processor configured to communicate with communication devices of a first plurality of users, communication devices of a second plurality of users, and to provide on-line access to a product catalog comprising a plurality of product entries, each product entry having a unique product identifier and comprising product information representing a product offered for sale by a respective merchant of a plurality of participating merchants, the product information comprising product characteristics and product pricing information for the plurality of products, wherein the product information is displayable using a communication device of each of a first plurality of users, the at least one processor operable to, at least:
receive, from a communication device of a first user of the first plurality of users, a request to provide to the first user, one or more products for purchase by the first user;
send, to a communication device of each of a second plurality of users, a notification of the request by the first user;
receive, from the communication device of a second user of the second plurality of users, an indication of acceptance of the request to provide the one or more products for purchase by the first user;
receive, from the communication device of the second user, product information representing an alternative product not represented by a product entry in the product catalog, the product information for the alternative product submitted by the second user as a substitute product for a particular product of the one or more products for purchase by the first user;
dynamically generate a new product entry in the product catalog for the alternative product, the new product entry having a unique product identifier associated with the alternative product and the particular product;
in response to a request by the first user, add the alternative product to an electronic shopping cart of the first user; and
process the product items of the shopping cart as a purchase of the first user for delivery to or pickup by the first user.

16. The system according to claim 15, wherein the new product entry in the product catalog is accessible only to the first user.

17. The system according to claim 15, wherein the new product entry in the product catalog is accessible to all of the first plurality of users.

18. The system according to claim 15, wherein the plurality of participating merchants are independent of one another.

19. The system according to claim 15, wherein the product information of each product entry of the product catalog comprises a product image, a product price, a product title, and a product description.

20. The system according to claim 15, wherein the first user and the second user are enabled to communicate during fulfillment of the order of the first user.

21. The system according to claim 15, wherein the product information representing the alternative product comprises a product image, a product price, a product title, and a product description, and is captured using a communication device of the second user.
